(19) United States
(12) Patent Application Publication
(10) Pub. No.: US 2026/0149860 A1
(43) Pub. Date: May 28, 2026

(54) INFORMATION PROCESSING DEVICE, INFORMATION PROCESSING METHOD, AND IN-CABIN MONITORING DEVICE

(71) Applicant: Sony Semiconductor Solutions Corporation, Kanagawa (JP)

(72) Inventor: Shoji Seta, Tokyo (JP)

(21) Appl. No.: 19/099,938

(22) PCT Filed: Aug. 16, 2023
(86) PCT No.: PCT/JP2023/029551

§ 371 Date: Jan. 30, 2025

(30) Foreign Application Priority Data
Aug. 31, 2022 (JP) 2022-138576

(51) Int. Cl. H04N 23/52; B60R 1/29; F21V 29/00; G06F 1/20; H04N 23/11; H04N 23/65

(52) U.S. Cl. CPC H04N 23/52; B60R 1/29; F21V 29/00; G06F 1/206; H04N 23/11; H04N 23/651; B60R 2300/103

(57) ABSTRACT

An information processing device according to the present disclosure includes a control unit. The control unit controls operation of at least one of a plurality of light sources or an imaging unit, the light sources emitting light into a car cabin, each of the light sources being included in a module, the imaging unit capturing an image of at least a part of a region to which the light is applied to acquire imaging information. The control unit, when a temperature of the module exceeds a first threshold, controls operation of at least one of the plurality of light sources or the imaging unit to restrict a function of the module.

### FIELD

The present disclosure relates to an information processing device, an information processing method, and an in-cabin monitoring device.

### BACKGROUND

An In-Cabin Monitoring (ICM) system is known as a system of monitoring a status inside a car. The ICM system uses a camera to monitor an in-cabin status by capturing images of the interior of the car day and night. By adopting a camera used in an ICM system, such as an infrared (IR) camera corresponding to an infrared wavelength region, red, green, and blue (RGB)-IR camera corresponding to an infrared wavelength region and a visible light wavelength region, and an indirect Time of Flight (iToF) camera capable of acquiring distance measurement information as three-dimensional information, it is possible to achieve an effective monitoring system in consideration of safety.

### CITATION LIST

### Patent Literature

Patent Literature 1: WO 2016/017087 A

### SUMMARY

### Technical Problem

When installing a camera in a car, there is a need to guarantee operation in a wide temperature range from −40° C. to +85° C. as an operation guarantee standard in a vehicle. For this reason, conventional techniques have a heat sink mechanism including a heat dissipation structure of the module, attached to a hardware device of the ICM system, or use a heat conductive sheet.

On the other hand, performing image processing at a high frame rate or in a High Dynamic Range (HDR), performing Time of Flight (ToF), Laser Imaging Detection and Ranging (LiDAR), or light emission of infrared (IR) light by a Light Emitting Diode (LED) or a Laser Diode (LD) in an RGB-IR camera in the ICM system would increase current consumption. In this case, countermeasures such as the heat sink or the thermal conductive sheet would make it difficult to guarantee the hardware performance of the ICM system within the above-described temperature range of −40° C. to +85° C.

To handle this, an ordinary method is using hardware to achieve heat dissipation by providing an opening in a housing, or providing a fan. However, when a hole is drilled in the housing, it is necessary to consider the influence on electromagnetic compatibility (EMC). In addition, regarding installation of a fan, it is difficult to introduce the fan from the viewpoint of cost increase and a dust problem that would occur with the operation of the fan.

An object of the present disclosure is to provide an information processing device, an information processing method, and an in-cabin monitoring device capable of guaranteeing operation in a temperature range according to an operation guarantee standard in a vehicle without depending on hardware heat dissipation measures.

### Solution to Problem

For solving the problem described above, an information processing device according to one aspect of the present disclosure has a control unit configured to control operation of at least one of a plurality of light sources or an imaging unit, the light sources emitting light into a car cabin, each of the light sources being included in a module, the imaging unit capturing an image of at least a part of a region to which the light is applied to acquire imaging information, wherein the control unit, when a temperature of the module exceeds a first threshold, controls operation of at least one of the plurality of light sources or the imaging unit to restrict a function of the module.

### BRIEF DESCRIPTION OF DRAWINGS

FIG. 1 is a schematic diagram illustrating an example of a relationship between an environmental temperature Ta and a temperature of a camera module in an ICM system.

FIG. 2 is a block diagram illustrating a configuration of an example of a control system applicable to an embodiment of the present disclosure.

FIG. 3 is a schematic diagram illustrating an example of a layout position and a visual field of a sensor device applicable to the embodiment.

FIG. 4 is a block diagram illustrating a configuration of an example of a sensor device applicable to the embodiment of the present disclosure.

FIG. 5A is a diagram illustrating a configuration example of a camera module with four lamps applicable to the embodiment.

FIG. 5B is a diagram illustrating a configuration example of a camera module with two lamps applicable to the embodiment.

FIG. 5C is a diagram illustrating a configuration example of a camera module with one lamp applicable to the embodiment.

FIG. 6 is a schematic diagram for illustrating an irradiation range of projection light and a light receiving range of reflected light of the camera module applicable to the embodiment.

FIG. 7 is a diagram illustrating a principle of an iToF method.

FIG. 8 is a diagram illustrating an exemplary case where projection light from a light emission unit is a rectangular wave modulated by PWM.

FIG. 9 is a block diagram illustrating an example of a configuration of a sensor unit applicable to each embodiment.

FIG. 10 is a circuit diagram illustrating a configuration of an example of a pixel applied to each embodiment.

FIG. 11 is a diagram illustrating an example in which a sensor unit applicable to each embodiment is formed by a stacked CIS having a double-layer structure.

FIG. 12A is a diagram illustrating an example in which a sensor unit applicable to each embodiment is formed by a stacked CIS having a triple-layer structure.

FIG. 12B is a diagram illustrating an example in which a sensor unit applicable to each embodiment is formed by a stacked CIS having a triple-layer structure.

FIG. 13 is a block diagram schematically illustrating a hardware configuration of an example of an information processing device applicable to the embodiment.

FIG. 14 is a block diagram of an example for illustrating functions of an information processing device applicable to the embodiment.

FIG. 15 is a flowchart illustrating an example of processing according to a first example of a first embodiment.

FIG. 16 is a schematic diagram illustrating an example of an irradiation state by light emission control according to the first example of the first embodiment.

FIG. 17A is a schematic diagram for illustrating light emission control in a camera module with two lamps according to the first example of the first embodiment.

FIG. 17B is a schematic diagram illustrating an example of an irradiation state by light emission control in the camera module with two lamps according to the first example of the first embodiment. 10 FIG. 18A is a schematic diagram illustrating an example of a drive signal for driving a light emission unit according to the first example of the first embodiment.

FIG. 18B is a schematic diagram illustrating an example of a drive signal driving a light emission unit according to the first example of the first embodiment.

FIG. 19A is a schematic diagram for illustrating light emission control in a camera module with four lamps according to the first example of the first embodiment.

FIG. 19B is a schematic diagram illustrating an example of an irradiation state by light emission control in the camera module with four lamps according to the first example of the first embodiment.

FIG. 20 is a schematic diagram for illustrating a detection area restriction in a camera module with two lamps according to a second example of the first embodiment.

FIG. 21A is a schematic diagram illustrating an example of a drive signal driving a light emission unit according to the second example of the first embodiment.

FIG. 21B is a schematic diagram illustrating an example of a drive signal driving a light emission unit according to the second example of the first embodiment.

FIG. 22 is a schematic diagram for illustrating light emission control in a camera module with four lamps according to the second example of the first embodiment.

FIG. 23 is a flowchart illustrating an example of processing according to a third example of the first embodiment.

FIG. 24 is a schematic diagram for illustrating light emission control in a camera module with one lamp according to the third example of the first embodiment.

FIG. 25 is a schematic diagram for illustrating light emission control in the camera module with one lamp according to the third example of the first embodiment.

FIG. 26 is a schematic diagram illustrating an example of a package structure of a device including a VCSEL applicable to a fourth example of the first embodiment.

FIG. 27A is a schematic circuit diagram of a package structure of a device including a VCSEL applicable to a fourth example of the first embodiment.

FIG. 27B is a schematic circuit diagram of a package structure of a device including a VCSEL applicable to a fourth example of the first embodiment.

FIG. 28A is a diagram illustrating a configuration example of a camera module with four lamps applicable to a modification of the embodiment.

FIG. 28B is a diagram illustrating a configuration example of a camera module with two lamps applicable to the modification of the embodiment.

FIG. 28C is a diagram illustrating a configuration example of a camera module with one lamp applicable to the modification of the embodiment.

FIG. 29 is a block diagram illustrating a configuration of an example of a sensor unit applicable to the modification of the embodiment in more detail.

FIG. 30 is a schematic diagram illustrating an example of an array of each color filter including an IR filter.

FIG. 31A is a schematic diagram illustrating an example of a drive signal driving a light emission unit according to a first example of the modification of the first embodiment.

FIG. 31B is a schematic diagram illustrating an example of the drive signal driving the light emission unit according to the first example of the modification of the first embodiment.

FIG. 32A is a schematic diagram illustrating an example of a drive signal driving a light emission unit according to a second example of the modification of the first embodiment.

FIG. 32B is a schematic diagram illustrating an example of the drive signal driving the light emission unit according to the second example of the modification of the first embodiment.

FIG. 33 is a flowchart illustrating an example of processing according to a second embodiment.

FIG. 34 is a schematic diagram illustrating an example of frame rate restriction applicable to the second embodiment.

FIG. 35 is a schematic diagram for illustrating that the entire detection area is set as a detection output target in the second embodiment.

FIG. 36 is a flowchart illustrating an example of processing according to a first example of the third embodiment.

FIG. 37 is a flowchart illustrating an example of processing according to a second example of the third embodiment.

FIG. 38 is a flowchart illustrating an example of processing according to a third example of the third embodiment.

FIG. 39 is a flowchart illustrating an example of processing according to a fourth example of the third embodiment.

### DESCRIPTION OF EMBODIMENTS

Embodiments of the present disclosure will be described below in detail with reference to the drawings. In each of the following embodiments, the same parts are denoted by the same reference symbols, and a repetitive description thereof will be omitted.

Hereinafter, embodiments of the present disclosure will be described in the following order.
1. Background of technology of present disclosure
2. Technology applicable to embodiments of present disclosure
2-1. System overview
2-2. Configuration example of sensor device
2-2-1. Configuration example of camera module
2-2-2. iToF
2-3. Configuration example of information processing device
3. First embodiment according to present disclosure
3-1. First example of first embodiment
3-2. Second example of first embodiment
3-3. Third example of first embodiment
3-4. Fourth example of first embodiment
4. Modification of first embodiment according to present disclosure
4-0. Configuration example of sensor device
4-0-1. Configuration example of camera module
4-0-2. Sensor configuration example
4-1. First example of modification of first embodiment
4-2. Second example of modification of first embodiment
4-3. Third example of modification of first embodiment
4-4. Fourth example of modification of first embodiment
5. Second embodiment according to present disclosure
6. Third embodiment according to present disclosure
6-1. First example of third embodiment
6-2. Second example of third embodiment
6-3. Third example of third embodiment
6-4. Fourth example of third embodiment

### 1. Background of Technology of Present Disclosure

Prior to the description of the embodiment according to the present disclosure, the background of the technology of the present disclosure will be schematically described to facilitate understanding. When installing a camera in a car in an In-Cabin Monitoring (ICM) system, there is a need to guarantee operation in a wide temperature range from −40° C. to +85° C. as an operation guarantee standard in a vehicle. In order to comply with this operation guarantee standard, conventional techniques use a heat sink mechanism including a heat dissipation structure of the module, attached to a hardware device of the ICM system, or use a heat conductive sheet.

On the other hand, performing image processing at a high frame rate or in a High Dynamic Range (HDR), performing Time of Flight (ToF), Laser Imaging Detection and Ranging (LiDAR), or light emission of infrared (IR) light by a Light Emitting Diode (LED) or a Laser Diode (LD) in an RGB-IR camera in the ICM system would increase current consumption. In this case, countermeasures such as the heat sink or the thermal conductive sheet would make it difficult to guarantee the hardware performance of the ICM system within the above-described temperature range of −40° C. to +85° C.

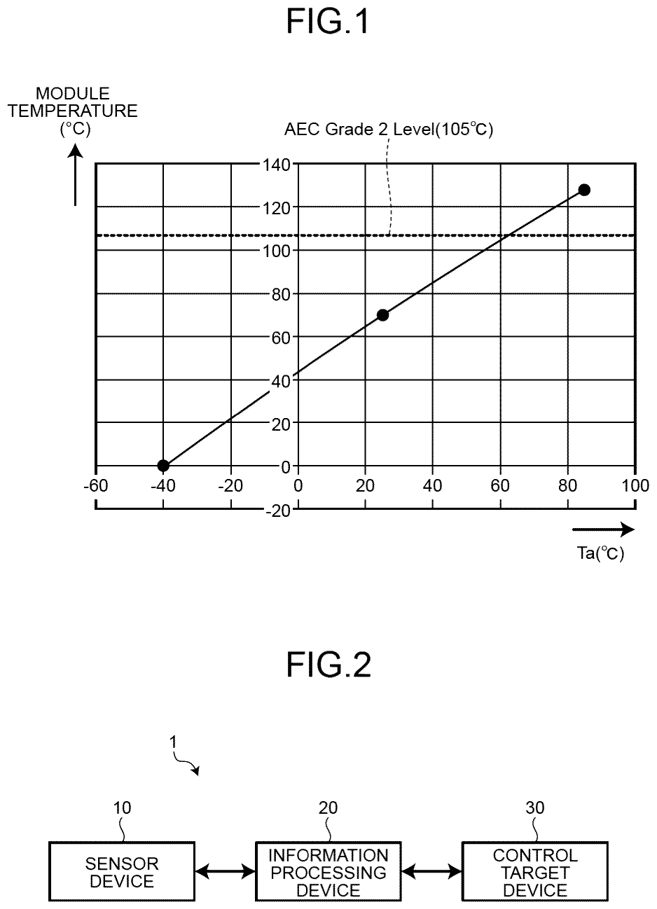

FIG. 1 is a schematic diagram illustrating an example of a relationship between an environmental temperature Ta and a temperature of a camera module in an ICM system. In FIG. 1, the horizontal axis represents the environmental temperature Ta, and the vertical axis represents the module temperature. The environmental temperature Ta indicates the temperature in the car cabin on which the module is mounted.

The module temperature is set to 0° C. at the environmental temperature Ta=−40° C., linearly increases with the increase of the environmental temperature Ta, so as to reach a temperature close to 130° C. at the environmental temperature Ta=+85° C. Meanwhile, in AEC-Q100 standardized by Automotive Electronics Council (AEC) with respect to an integrated circuit among in-vehicle electronic components, the operating temperature range is defined as a range of −40° C. to +105° C. in Grade 2. In the example of FIG. 1, the module temperature exceeds an upper limit of AEC-Q100 Grade 2 in an environment of an environmental temperature Ta=50° C. to 60° C. Accordingly, in this example, the temperature 105° C., which is the upper limit of the component guarantee temperature defined in AEC-Q100 Grade 2, cannot be held under the environment of the environmental temperature Ta=85° C.

As a countermeasure, it is conceivable to perform heat dissipation by hardware so as to suppress the module temperature to a temperature that can be held under an environment of the environmental temperature Ta=85° C. Examples of ordinary methods performed when heat dissipation is implemented by hardware include forming an opening in a housing or providing a fan. However, when a hole is drilled in the housing, it is necessary to consider the influence on electromagnetic compatibility (EMC). In addition, regarding installation of a fan, it is difficult to introduce the fan from the viewpoint of cost increase and a dust problem that would occur with the operation of the fan.

The present disclosure restricts the function of the camera module in accordance with the environmental temperature Ta, thereby suppressing the module temperature of the camera module to a predetermined temperature range. For example, the present disclosure restricts the operation of the portion that implements the function of a restriction target in the camera module in accordance with the environmental temperature Ta, so as to reduce the current consumption of the portion to suppress heat generation.

### 2. Technology Applicable to Embodiments of Present Disclosure

Next, a technology applicable to the embodiments of the present disclosure will be described.

### 2-1. System Overview

FIG. 2 is a block diagram illustrating a configuration of an example of a control system applicable to an embodiment of the present disclosure. In FIG. 2, a control system 1 includes a sensor device 10, an information processing device 20, and a control target device 30. While controlling the sensor device 10, the information processing device 20 also executes predetermined processing using the detection output from the sensor device 10 and controls the control target device 30 based on the processing result. In this manner, the control system 1 applicable to the embodiment is configured as a system (for example, an ICM system) that performs control according to in-cabin monitoring.

The sensor device 10 includes: a light emission unit that emits light to be applied to a target object; and a light reception unit that receives light. The sensor device 10 detects the target object based on, for example, light emitted by a light emission unit and reflected light which is reflected on the target object and received by the light reception unit.

The sensor device 10 may use, for example, an indirect Time of Flight (iToF) method for detecting the target object. In this case, the detection result of the sensor device 10 may be information regarding the target object, acquired as distance measurement information being three-dimensional information. The sensing is not limited thereto, and the sensor device 10 may detect the target object using an infrared (IR) camera corresponding to an infrared wavelength region or a red, green, and blue (RGB)-IR camera corresponding to an infrared wavelength region and a visible light wavelength region. In this case, the detection result by the sensor device 10 may be information regarding the target object, acquired as a gradation image in which each pixel has gradation.

Furthermore, the sensor device 10 may use a direct Time of Flight (dToF) method. Furthermore, the sensor device 10 may be a fusion system combining any two or more of the iToF method, the dToF method, the IR camera, and the RGB-IR camera.

Furthermore, the sensor device 10 includes a housing storing the sensor device 10 or a temperature sensor for detecting an environmental temperature regarding the housing.

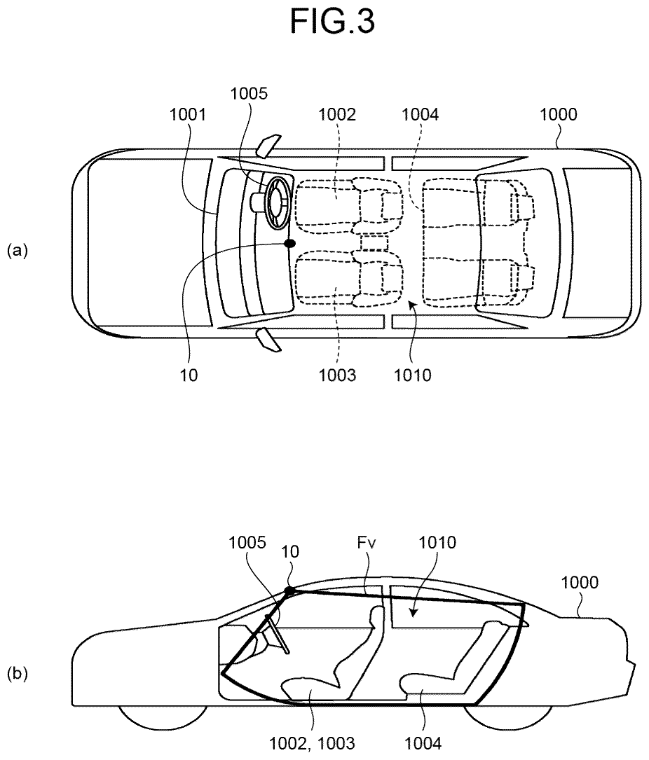

FIG. 3 is a schematic diagram illustrating an example of a layout position and a visual field Fv of the sensor device 10 applicable to the embodiment. In FIG. 3, section (a) illustrates a top view of a vehicle 1000, and section (b) illustrates a side view of the vehicle 1000. The left side in the figure corresponds to a traveling direction (front direction).

In FIG. 3, the vehicle 1000 has a car cabin 1010 which includes a driver's seat 1002, a passenger seat 1003, and a rear seat 1004, and there is provided a windshield 1001 in front of the driver's seat 1002 and the passenger seat 1003. In the example of FIG. 3, as illustrated in section (a), the sensor device 10 is provided substantially at the center in the left-right direction at an upper end of the windshield 1001.

In FIG. 3, a visual field Fv indicates a detection area detectable by the sensor device 10. The sensor device 10 is provided so as to be able to capture substantially the entire car cabin 1010 within the visual field Fv. For example, the sensor device 10 is configured to include the driver's seat 1002, the passenger seat 1003, the rear seat 1004, and a steering wheel 1005 within the visual field Fv.

In the example of FIG. 3, the vehicle 1000 includes only one sensor device 10 in the car cabin 1010, but the number is not limited to this example. For example, the vehicle 1000 may include, in the car cabin 1010, the sensor device 10 in plurality, such as the sensor device 10 having the front seat (the driver's seat 1002 and the passenger seat 1003) in the visual field Fv and the sensor device 10 having the rear seat 1004 in the visual field Fv.

The information processing device 20 includes, for example, a Central Processing Unit (CPU), Read Only Memory (ROM), and Random Access Memory (RAM), and may have a configuration as a computer device that operates according to a program stored in a storage medium such as the ROM. In a case where the control system 1 is used as a vehicle interior system, the information processing device 20 may be an Electronic Control Unit (ECU) that controls at least a part of the vehicle or may be a part of the ECU.

The information processing device 20 executes predetermined processing using the detection output from the sensor device 10, and generates a control signal for controlling the control target device 30 based on the processing result.

The control target device 30 executes a predetermined operation in accordance with the control signal generated by the information processing device 20. The control target device 30 may be, for example, a control system device that controls traveling of the vehicle and the like. Not limited thereto, and the control target device 30 may be an accessory device (such as an audio device) mounted on a vehicle.

For example, the information processing device 20 may perform skeleton estimation on the passenger including the driver as predetermined processing using the detection output from the sensor device 10. The information processing device 20 may determine whether the state of the driver is in a predetermined state (for example, an abnormal state) based on information such as a face position and a hand position of the driver estimated by the skeleton estimation.

For example, based on the result of skeleton estimation, the information processing device 20 may determine the states whether the driving operation is performed correctly, whether the vehicle is driven by hands-on operation, or whether the driver is in a state not dozing off. In a case where it is determined that the driver is in an abnormal state based on the detection result by the sensor device 10, it is conceivable that the information processing device 20 generates a control signal for performing control to decelerate the vehicle. In this case, the control target device 30 may be a control system device that controls traveling of the vehicle or the like or an ECU for controlling the device of the control system, as described above.

Furthermore, the information processing device 20 may perform gesture recognition processing of recognizing a gesture of a passenger including the driver as predetermined processing using the detection output from the sensor device 10. The information processing device 20 may generate the control signal according to the gesture recognized by the gesture recognition processing. In this case, the control target device 30 may be the above-described accessory device or the above-described control system device, and it is also conceivable to allow the control target device 30 to control the traveling of the vehicle in accordance with the recognized gesture.

### 2-2. Configuration Example of Sensor Device

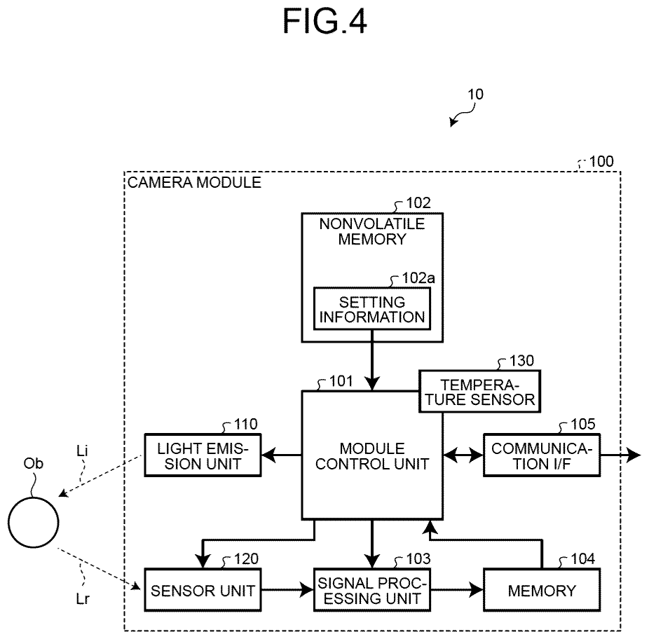

FIG. 4 is a block diagram illustrating a configuration of an example of the sensor device 10 applicable to the embodiment of the present disclosure.

The following description will be given assuming that the sensor device 10 uses an indirect Time of Flight (iToF) method for detecting a target object. Although details will be described below, the iToF method performs distance measurement on a target object Ob based on a phase difference between projection light Li and reflected light Lr obtained by reflecting the projection light Li by the target object Ob.

In FIG. 4, the sensor device 10 includes a module control unit 101, nonvolatile memory 102, a signal processing unit 103, memory 104, a communication I/F 105, a light emission unit 110, and a sensor unit 120. Furthermore, a camera module 100 is constituted with the module control unit 101, the nonvolatile memory 102, the signal processing unit 103, the memory 104, the communication I/F 105, the light emission unit 110, and the sensor unit 120.

The light emission unit 110 includes, for example, a light emitting element that emits light having a wavelength including an infrared region. The light emission unit 110 allows the light emitting element to emit light by a drive signal supplied from the module control unit 101 described below. The light emission unit 110 projects light emitted by the light emitting element as the projection light Li. The light emitting element is implemented by applying a laser diode (LD), for example. More specifically, a Vertical Cavity Surface Emitting LASER (VCSEL), which is a type of laser diode, may be applied as the light emitting element of the light emission unit 110. The VCSEL includes a plurality of light generating elements each corresponding to a channel, and can project a plurality of laser beams generated by each of the plurality of light generating elements in parallel.

Not limited to this, and the light emitting element of the light emission unit 110 may be implemented by applying a Light Emitting Diode (LED). In this case, it is allowable to use an LED array including a plurality of LEDs arranged in a lattice pattern.

The following description will assume that the light emitting element included in the light emission unit 110 is a laser diode. In the following description, unless otherwise specified, “the light emitting element included in the light emission unit 110 emits light” will be described as “the light emission unit 110 emits light” or the like.

In the example of FIG. 4, the camera module 100 (sensor device 10) is illustrated to include one light emission unit 110, but the number is not limited to this example. That is, the camera module 100 applicable to the embodiment may include two or more light emission units 110.

The sensor unit 120 includes, for example, a light receiving element capable of detecting at least light having a wavelength in an infrared region, and a signal processing circuit that outputs a pixel signal corresponding to the light detected by the light receiving element, and images a subject and outputs imaging information. For example, the light receiving element included in the sensor unit 120 may be implemented by applying a photodiode. The sensor unit 120 may further include an optical system including one or more lenses for condensing incident light to be applied onto the light receiving element. Hereinafter, unless otherwise specified, “the light receiving element included in the sensor unit. 120 receives light” will be described as “the sensor unit 120 receives light” or the like.

The signal processing circuit includes an Analog to Digital (AD) conversion circuit that converts a pixel signal output from the light receiving element in an analog system into a signal in a digital system, and the sensor unit 120 outputs a pixel signal corresponding to light received by the light receiving element as pixel data including digital system signals. The pixel data output from the sensor unit 120 is passed to the signal processing unit 103.

Based on the pixel data passed from the sensor unit 120, the signal processing unit 103 generates a distance image as imaging information. The distance image is information having distance information for each pixel, and distance measurement information as three-dimensional information can be acquired based on the distance image. The distance image generated by the signal processing unit 103 is stored in the memory 104.

In this manner, the sensor unit 120 and the signal processing unit 103 function as an imaging unit that images at least a part of a region to which light is applied to acquire imaging information.

The communication I/F 105 controls communication between the camera module 100 (sensor device 10) and the information processing device 20. The communication I/F 105 may perform communication with the information processing device 20 using a serial bus conforming to inter-integrated circuit (I²C), for example. The communication standard used when the communication I/F 105 communicates with the information processing device 20 is not limited to I²C. For example, the communication I/F 105 may communicate with the information processing device 20 using a Mobile Industry Processor Interface (MIPI). Furthermore, the communication I/F 105 is not limited to wired communication, and may communicate with the information processing device 20 by wireless communication.

Based on a clock signal CLK of a predetermined frequency, the module control unit 101 controls a light emission operation in the light emission unit 110, a light reception operation in the sensor unit 120, and a distance image generation operation in the signal processing unit 103. In addition, the module control unit 101 is connected with the nonvolatile memory 102. The nonvolatile memory 102 includes, for example, Electrically Erasable Programmable Read-Only Memory (EEPROM), and stores setting information 102a defining an operation mode of the light emission operation in the light emission unit 110 and the light reception operation in the sensor unit 120.

As will be described below, it is possible, in the camera module 100, to select operation modes of the light emission operation in the light emission unit 110 and the light reception operation in the sensor unit 120 from among predetermined operation modes. The module control unit 101 can control the operations of the light emission unit 110 and the sensor unit 120 in accordance with the selected operation setting information from among pieces of operation setting information stored in the nonvolatile memory 102 as the setting information 102a, thereby enabling the light emission unit 110 and the sensor unit 120 to operate in the operation mode indicated by the selected operation setting information.

More specifically, the module control unit 101 selects operation setting information from the setting information 102a stored in the nonvolatile memory 102 in accordance with an instruction received from the information processing device 20 via the communication I/F 105. The operation setting information includes, for example, information indicating a frequency, a duty, power, and a pattern of a rectangular wave.

Based on the selected operation setting information, the module control unit 101 generates a rectangular wave signal having a frequency, a duty, and a pattern indicated in the operation setting information, for example. The module control unit 101 supplies the generated rectangular wave signal to the sensor unit 120 and the signal processing unit 103.

In addition, the module control unit 101 generates a drive signal having power for driving the light emission unit 110 based on the generated rectangular wave signal and the power indicated in the operation setting information. That is, the module control unit 101 also functions as a device driver that drives the light emission unit 110. The module control unit 101 supplies the generated drive signal to the light emission unit 110.

Furthermore, the camera module 100 applicable to the embodiment includes a temperature sensor 130 capable of detecting a temperature in the camera module 100. In the example of FIG. 4, the temperature sensor 130 is illustrated to be attached to the module control unit 101. However, the location is not limited to this example, and the temperature sensor 130 may be built in the module control unit 101. The module control unit 101 acquires temperature information indicating the temperature detected by the temperature sensor 130 from the temperature sensor 130.

The temperature sensor 130 may be provided at a location other than the module control unit 101 as long as the temperature in the camera module 100 can be detected. In the case of the example of FIG. 4, since the module control unit 101 includes a drive circuit (device driver) for supplying power to the light emission unit 110, the temperature is considered to be higher than other portions of the camera module 100. Therefore, the temperature sensor 130 is preferably provided inside or in contact with the module control unit 101.

### 2-2-1. Configuration Example of Camera Module

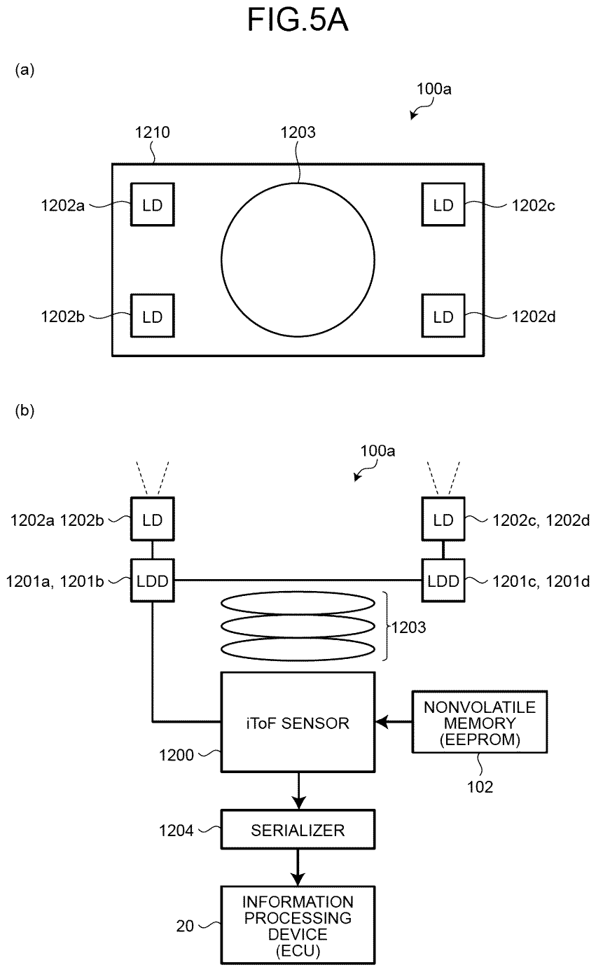

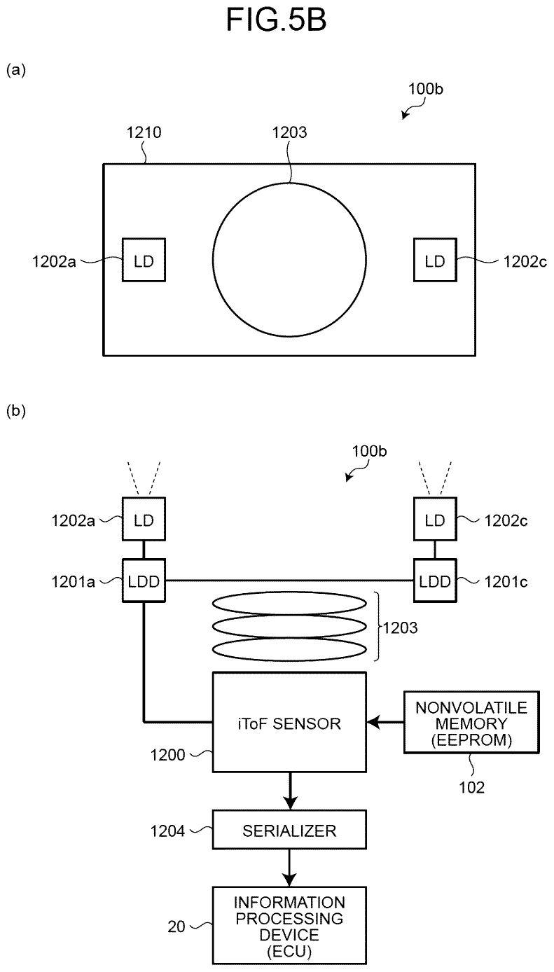

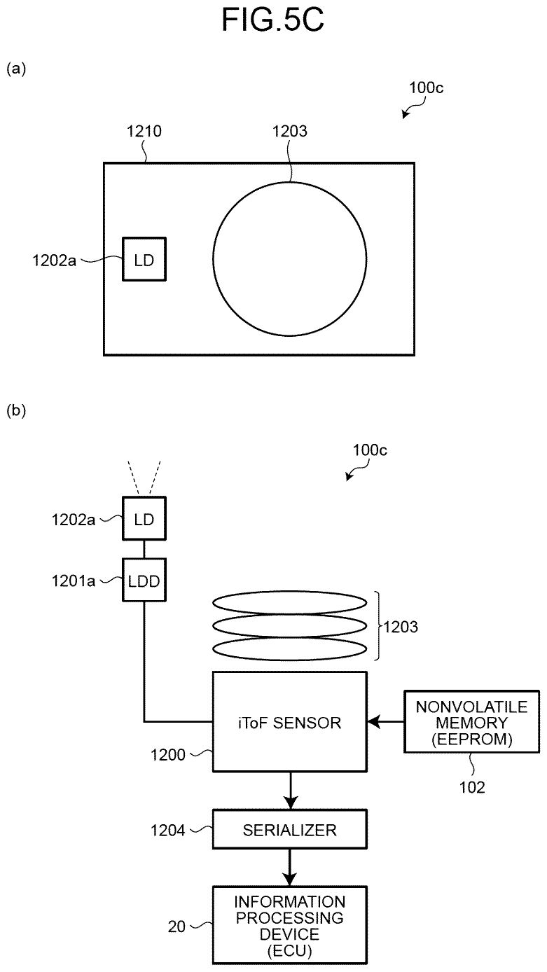

Next, a configuration of the camera module 100 applicable to the embodiment of the present disclosure will be described more specifically with reference to FIGS. 5A to 5C.

FIG. 5A is a diagram illustrating a configuration example of a camera module 100a with four lamps having four light emission units 110, applicable to the embodiment. In FIG. 5A, section (a) is a diagram of the camera module 100a as viewed from the light emitting/light receiving surface side, and section (b) is a block diagram illustrating a configuration example of the camera module 100a.

Note that section (a) of FIG. 5A illustrates a state in which the light emitting/light receiving surface of the camera module 100a is installed in the car cabin 1010 so as to obtain the visual field Fv in the car cabin 1010. That is, the left side of the camera module 100a in the drawing corresponds to the right side seat in the car cabin 1010, while the left side corresponds to the left side seat in the car cabin 1010. The similar applies to section (a) of FIG. 5B and section (a) of FIG. 5C described below.

In section (a) of FIG. 5A, the camera module 100a has a configuration in which a lens 1203 constituting the optical system of the sensor unit 120 is disposed in the central portion of a substrate 1210, while laser diodes (LD) 1202a, 1202b, 1202c, and 1202d included in each of the four light emission units 110 are disposed around the lens 1203, for example. In order to divide the light irradiation range into the driver's seat 1002 side and the passenger seat 1003 side, the four laser diodes 1202a to 1202d are disposed separately on the left and right sides of the lens 1203.

In section (b) of FIG. 5A, the camera module 100a includes laser diode drivers (LDD) 1201a to 1201d that respectively drive the laser diodes 1202a to 1202d. The camera module 100a includes an iToF sensor 1200 and a serializer 1204. The iToF sensor 1200 corresponds to a configuration including the sensor unit 120, the module control unit 101, the signal processing unit 103, the memory 140, and the temperature sensor 130 in FIG. 4.

Furthermore, the serializer 1204 may be included in the communication I/F 105 in FIG. 4, and executes processing of converting a digital signal output from the iToF sensor 1200 into serial data and processing of converting serial data received from the information processing device 20 into a signal format corresponding to the iToF sensor 1200.

The iToF sensor 1200 drives the laser diode drivers 1201a to 1201d according to operation setting information selected from setting information 102a (not illustrated) stored in the nonvolatile memory 102, so as to cause the laser diodes 1202a to 1202d to emit light. The iToF sensor 1200 can select one or more laser diodes to perform light emission from among the laser diodes 1202a to 1202d based on the operation setting information, enabling control of the irradiation range of the projection light Li.

FIG. 5B is a diagram illustrating a configuration example of a camera module 100b with two lamps including two light emission units 110. In FIG. 5B, section (a) is a diagram of the camera module 100b as viewed from the light emitting/light receiving surface side, and section (b) is a block diagram illustrating a configuration example of the camera module 100b.

In section (a) of FIG. 5B, the camera module 100b has a configuration, for example, in which a lens 1203 constituting the optical system is disposed in the central portion of the substrate 1210, while the laser diodes 1202a and 1202c included in each of the two light emission units 110 are disposed in left and right portions in the diagram of the lens 1203. In order to divide the light irradiation range into the driver's seat 1002 side and the passenger seat 1003 side, the two laser diodes 1202a and 1202c are disposed separately on the left and right sides of the lens 1203.

In section (b) of FIG. 5B, the camera module 100b includes the laser diode drivers 1201a and 1201c that respectively drive the laser diodes 1202a and 1202c. In addition, since the configuration of the other portion of the camera module 100b and the serializer 1204 are common to the configuration illustrated in section (b) of FIG. 5A, the description thereof is omitted here.

The iToF sensor 1200 drives the laser diode drivers 1201a and 1201c according to operation setting information selected from setting information 102a (not illustrated) stored in the nonvolatile memory 102, so as to cause the laser diodes 1202a and 1202c to emit light. The iToF sensor 1200 can select one or more laser diodes to perform light emission from among the laser diodes 1202a and 1202c based on the operation setting information, enabling control of the irradiation range of the projection light Li.

FIG. 5C is a diagram illustrating a configuration example of a camera module 100c with one lamp with one light emission unit 110. In FIG. 5C, section (a) is a diagram of the camera module 100c as viewed from the light emitting/light receiving surface side, and section (b) is a block diagram illustrating a configuration example of the camera module 100c.

In section (a) of FIG. 5C, the camera module 100c has a configuration, for example, in which a lens 1203 constituting the optical system is disposed in the central portion of the substrate 1210, while the laser diodes 1202a included in the one light emission unit 110 is disposed on the left side in the diagram of the lens 1203.

In section (b) of FIG. 5C, the camera module 100c includes the laser diode drivers 1201a that drives the laser diode 1202a. In addition, since the configuration of the other portion of the camera module 100b and the serializer 1204 are common to the configuration illustrated in section (b) of FIG. 5A, the description thereof is omitted here.

The iToF sensor 1200 drives the laser diode driver 1201a according to operation setting information selected from setting information 102a (not illustrated) stored in the nonvolatile memory 102, so as to cause the laser diode 1202a to emit light. In this example, the iToF sensor 1200 cannot control the irradiation range.

Although a specific example will be described below, by using a VCSEL as the laser diode 1202a and performing independent light emission control of each of a plurality of light spots included in the VCSEL, it is possible to control the irradiation range of the projection light Li similarly to the example of FIGS. 5A and 5B described above.

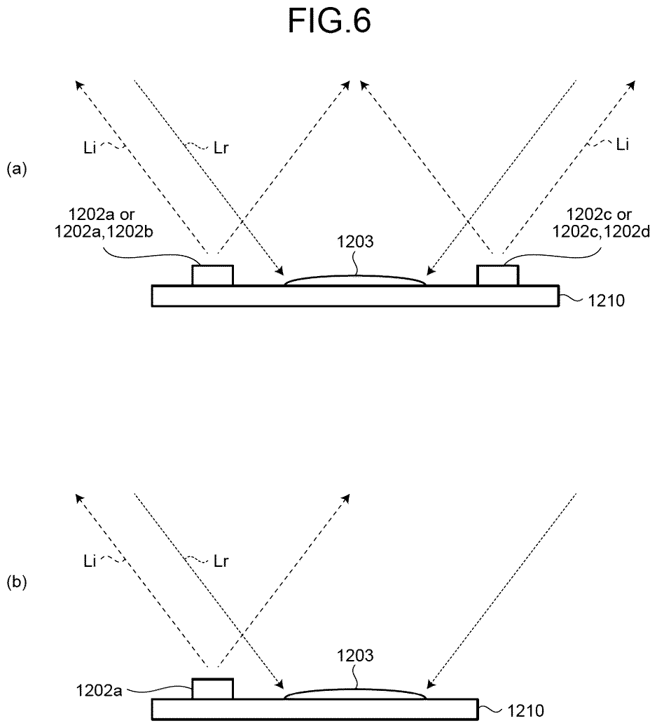

FIG. 6 is a schematic diagram for illustrating an irradiation range of the projection light Li and a light receiving range of the reflected light Lr of the camera module 100 applicable to the embodiment. Note that sections (a) and (b) of FIG. 6 are top views of the light emitting/light receiving surface of the camera module 100 with respect to the views of sections (a) of FIGS. 5A to 5C.

Section (a) in FIG. 6 illustrates an example of the irradiation range and the light receiving range in the case of using four lamps or two lamps respectively illustrated in FIGS. 5A and 5B. In this case, the light receiving range of the lens 1203 (sensor unit 120) can include, for example, substantially the entire region in the car cabin 1010 by the projection light Li of the laser diode 1202a or the laser diodes 1202a and 1202b and the projection light Li of the laser diode 1202c or the laser diodes 1202c and 1202d.

Section (b) in FIG. 6 illustrates an example of the irradiation range and the light receiving range in the case of using one lamp illustrated in FIG. 5C. In this case, the light receiving range of the lens 1203 (sensor unit 120) is limited to, for example, the laser diode 1202a side in the car cabin 1010 by the projection light Li of the laser diode 1202a.

In the following description, the camera modules 100a, 100b, and 100c will be described as the camera module 100 as a representative unless otherwise specified.

### 2-2-2. iToF

Here, the iToF method applicable to the embodiment will be described. First, distance measurement by the iToF method will be schematically described.

In the configuration of FIG. 4, in accordance with an instruction received from the information processing device 20 via the communication I/F 105, the module control unit 101 generates a drive signal for supplying power to drive the light emission unit 110, for example, and supplies the generated drive signal to the light emission unit 110. Here, the module control unit 101 generates a light control signal modulated into a rectangular wave with a predetermined duty by pulse width modulation (PWM). The module control unit 101 generates a drive signal based on the light control signal, and supplies the generated drive signal to the light emission unit 110. At the same time, the module control unit 101 controls the light reception operation of the sensor unit 120 based on an exposure control signal synchronized with a light source control signal.

The light emission unit 110 emits blinking light with a predetermined duty in accordance with the drive signal supplied from the module control unit 101. The light emitted from the light emission unit 110 is projected from the light emission unit 110 as the projection light Li. The projection light Li is reflected by the target object Ob and received by the sensor unit 120 as the reflected light Lr, for example. The sensor unit 120 passes a pixel signal corresponding to the reception of the reflected light Lr to the signal processing unit 103. In practice, the sensor unit 120 receives ambient light in the surroundings in addition to the reflected light Lr, and the pixel signal also includes a component of the ambient light together with a component of the reflected light Lr.

The module control unit 101 causes the sensor unit 120 to execute the light reception operation a plurality of times in different phases. The signal processing unit 103 calculates a distance D to the target object Ob based on a difference between pixel signals due to light reception at different phases. Furthermore, the signal processing unit 103 calculates: first image information obtained by extracting the component of the reflected light Lr based on the difference between the pixel signals; and second image information including the component of the reflected light Lr and the component of the ambient light. Hereinafter, the first image information is referred to as direct reflected light information, and the second image information is referred to as RAW image information.

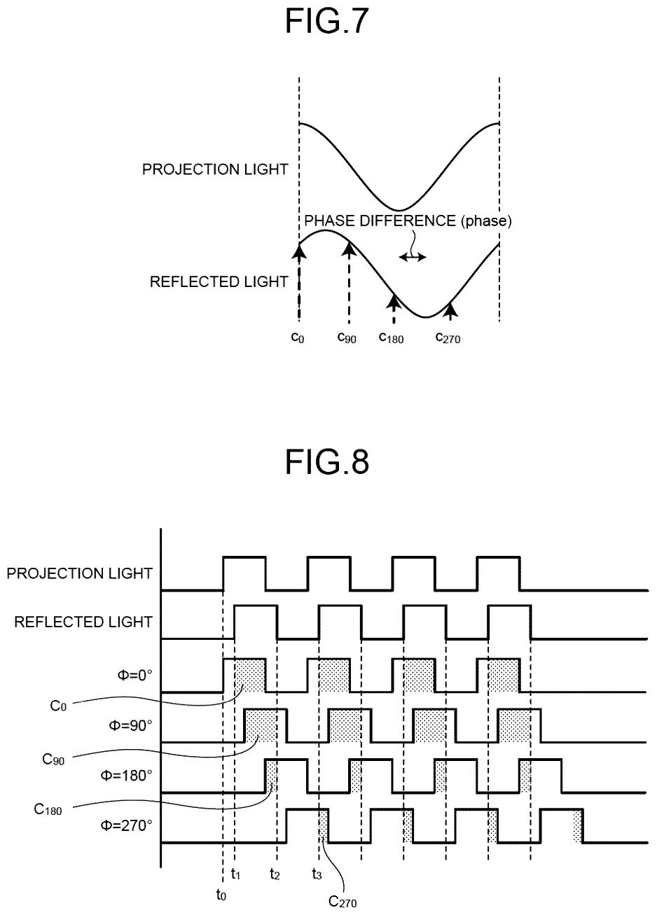

Distance measurement by the iToF method applicable to each embodiment will be described. FIG. 7 is a diagram illustrating a principle of the iToF method. In FIG. 7, light modulated by a sine wave is used as the projection light Li projected from the light emission unit 110. The reflected light Lr is ideally a sine wave having a phase difference (phase) corresponding to the distance D with respect to the projection light Li.

The signal processing unit 103 performs sampling a plurality of times at different phases on the pixel signal that has occurred by reception of the reflected light Lr, and acquires a light amount value indicating the light amount for each sampling. In the example of FIG. 7, light amount values C₀, C₉₀, C₁₈₀, and C₂₇₀ are acquired in individual phases, namely, a phase 0°, a phase 90°, a phase 180°, and a phase 270°, respectively, having a phase difference 90° from each other with respect to the projection light Li. In the iToF method, distance information is calculated based on a difference between light amount values of a set having phase difference 180° among individual phases of 0°, 90°, 180°, and 270°.

A method of calculating distance information in the iToF method will be described more specifically with reference to FIG. 8. FIG. 8 is a diagram illustrating an exemplary case where the projection light Li from the light emission unit 110 is a rectangular wave modulated by PWM. FIG. 8 includes, from the top, an illustration of the projection light Li from the light emission unit 110 and an illustration of the reflected light Lr that has reached the sensor unit 120. As illustrated in the upper part of FIG. 8, the light emission unit 110 periodically blinks at a predetermined duty to project the projection light Li. FIG. 8 further illustrates exposure control

signals at the phase 0° (described as Φ=0′), the phase 90° (described as Φ=) 90°, the phase 180° (described as Φ=180°), and the phase 270° (described as Φ=270° in the sensor unit 120. For example, a period during which the exposure control signal is in a high state is an exposure period during which the sensor unit 120 outputs a valid pixel signal.

In the example of FIG. 8, the projection light Li is projected from the light emission unit 110 at time point to, and the reflected light Lr being reflection of the projection light Li by the measurement object reaches the sensor unit 120 at time point t₁ after the delay corresponding to the distance D from time point to t₀ the measurement object.

On the other hand, in accordance with the exposure control signal supplied from the module control unit 101, the sensor unit 120 starts the exposure period with the phase 0° in synchronization with the time point to of the projection timing of the projection light Li in the light emission unit 110. Similarly, the sensor unit 120 starts the exposure periods with the phase 90°, the phase 180°, and the phase 270° in accordance with the exposure control signal from the signal processing unit 103. Here, the exposure period in each phase follows the duty of the projection light Li. Although the example of FIG. 8 is an exemplary case in which the exposure periods of individual phases are temporally parallel for the sake of explanation, the sensor unit 120 operates, in practice, such that the exposure periods of the individual phases are sequentially designated, and the light amount values C₀, C₉₀, C₁₈₀, and C₂₇₀ of the individual phases are each acquired.

In the example of FIG. 8, the arrival timings of the reflected light Lr are time points t₁, t₂, t₃, . . . , and the light amount value C₀ at the phase 0° is acquired as an integral value of the received light amount from the time point t₀ to the end time point of the exposure period including the time point t₀ at the phase 0°. On the other hand, in the phase 180° in which the phase is different from the phase 0° by 180°, the light amount value C₁₈₀ is acquired as an integral value of the received light amount from the start time point of the exposure period at the phase 180° to the time point t₂ of the falling of the reflected light Lr included in the exposure period.

Also, for the phase C90 and the phase 270° having a phase difference 180° from the phase 90°, the integral value of the received light amount in the period in which the reflected light Lr arrives within each exposure period is acquired as light amount values C₉₀ and C₂₇₀, similarly to the case of the phases 0° and 180° described above.

Among these light amount values C₀, C₉₀, C₁₈₀, and C₂₇₀, as indicated in the following Formulas (1) and (2), a difference I and a difference Q are obtained based on a combination of light amount values having phase difference 180°.

$$I = {C}_{0} - {C}_{180} \qquad ( 1 )$$

$$Q = {C}_{90} - {C}_{270} \qquad ( 2 )$$

Based on these differences I and Q, the phase difference (phase) is calculated by the following Formula (3). In the Formula (3), the phase difference (phase) is defined in a range of (0≤phase<2π).

$$phase = {tan}^{- 1} ( Q / I ) \qquad ( 3 )$$

Distance information Depth is calculated by the following Formula (4) using the phase difference (phase) and a predetermined coefficient (range).

$$Depth = ( phase \times range ) / 2 π \qquad ( 4 )$$

Furthermore, based on the differences I and Q, the component of the reflected light Lr (direct reflected light information) can be extracted from the component of the light received by the sensor unit 120. Direct reflected light information DiRef1 is calculated by the following Formula (5) using the absolute values of the differences I and Q.

$$DiRefl = \vert I \vert + \vert Q \vert \qquad ( 5 )$$

Meanwhile, RAW image information RAW can be calculated as an average value of the light amount values C₀, C₉₀, C₁₈₀, and C₂₇₀ as indicated in the following Formula (6).

$$RAW = ( {C}_{0} + {C}_{90} + {C}_{180} + {C}_{270} ) / 4 \qquad ( 6 )$$

As described above, the sensor unit 120 receives not only the reflected light Lr, being reflection of the projection light Li from the light emission unit 110 on a measurement object 31, that is, the direct reflected light, but also the ambient light to which the projection light Li from the light emission unit 110 does not contribute. Therefore, the amount of light received by the sensor unit 120 is the sum of the amount of direct reflected light and the amount of ambient light. Calculating the above-described Formulas (1) to (3) and (5) will cancel the component of the ambient light, thereby extracting the component of the direct reflected light.

On the other hand, since the RAW image has information being an average value of the light amount values C₀, C₉₀, C₁₈₀, and C₂₇₀ of the individual phases as indicated in the above-described Formula (6), and thus includes the component of the ambient light.

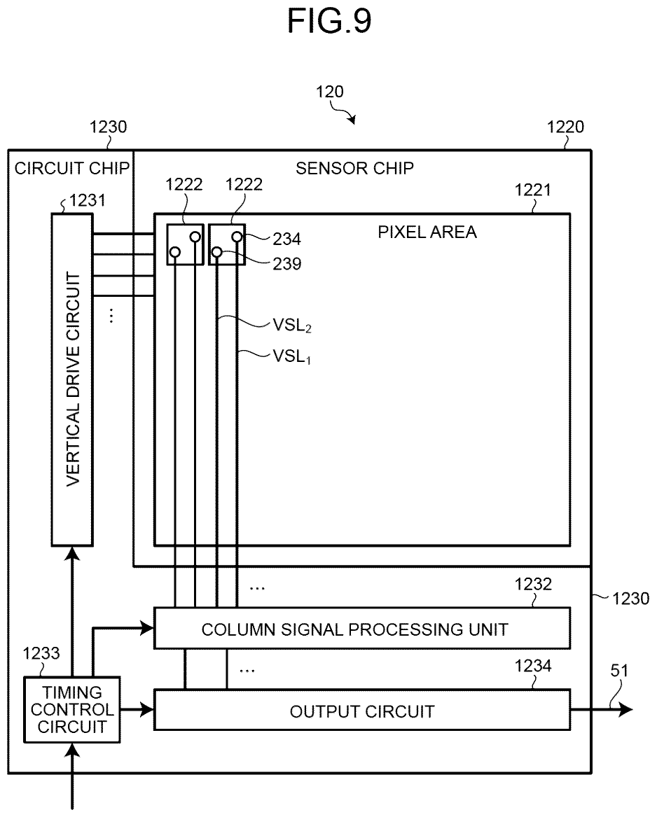

Next, the sensor unit 120 applied to each embodiment will be described with reference to FIGS. 9 to 12.

FIG. 9 is a block diagram illustrating an example of a configuration of the sensor unit 120 applicable to each embodiment. In FIG. 9, the sensor unit 120 has a stacked structure including a sensor chip 1220 and a circuit chip 1230 stacked on the sensor chip 1220. In this stacked structure, the sensor chip 1220 and the circuit chip 1230 are electrically connected to each other through a connection portion (not illustrated) such as a VIA or a Cu—Cu connection. The example of FIG. 9 illustrates a state in which the wiring of the sensor chip 1220 and the wiring of the circuit chip 1230 are connected to each other through the connection portion.

A pixel area 1221 includes a plurality of pixels 1222 arranged in an array on the sensor chip 1220. For example, an image signal of one frame is formed based on pixel signals output from the plurality of pixels 1222 included in the pixel area 1221. Each of the pixels 1222 arranged in the pixel area 1221 can receive infrared light, performs photoelectric conversion based on the received infrared light, and outputs an analog pixel signal, for example. Each of the pixels 1222 included in the pixel area 1221 is connected to two vertical signal lines, namely, vertical signal lines VSL₁ and VSL₂.

The sensor unit 120 further includes a vertical drive circuit 1231, a column signal processing unit 1232, a timing control circuit 1233, and an output circuit 1234 arranged on the circuit chip 1230.

The timing control circuit 1233 controls the drive timing of the vertical drive circuit 1231 in accordance with an element control signal supplied from the outside via a control line 50. Furthermore, the timing control circuit 1233 generates a vertical synchronization signal based on the element control signal. The column signal processing unit 1232 and the output circuit 1124 execute each processing in synchronization with the vertical synchronization signal generated by the timing control circuit 1233.

The vertical signal lines VSL₁ and VSL: are wired in the vertical direction in FIG. 9 for each column of the pixels 1222. Assuming that the total number of columns in the pixel area 1221 is M (M is an integer of 1 or more), a total of 2×M vertical signal lines are wired in the pixel area 1221. Although details will be described below, each of the pixels 1222 includes two taps, namely, tap A (TAP_A) and tap B (TAP_B) that each store charges generated by photoelectric conversion. The vertical signal line VSL; is connected to the tap A of the pixel 1222, while the vertical signal line VSL₂ is connected to the tap B of the pixel 1222.

The vertical signal line VSL: is used to output a pixel signal AIN_{P1} that is an analog pixel signal based on the electric charge of the tap A of the pixel 1222 in the corresponding pixel column. The vertical signal line VSL₂ is used to output a pixel signal AIN_{P2} that is an analog pixel signal based on the charge of the tap B of the pixel 1222 in the corresponding pixel column.

Under the timing control of the timing control circuit 1233, the vertical drive circuit 1231 drives each of the pixels 1222 included in the pixel area 1221 in units of pixel rows and outputs the pixel signals AIN_{P1} and AIN_{P2}. The pixel signals AIN_{P1} and AIN_{P2} output from the respective pixels 1222 are supplied to the column signal processing unit 1232 via the vertical signal lines VSL₁ and VSL₂ of the respective columns.

The column signal processing unit 1232 includes a plurality of Analog to Digital (AD) converters provided for each pixel column corresponding to the pixel column of the pixel area 1221, for example. Each AD converter included in the column signal processing unit 1232 performs AD conversion on the pixel signals AIN_{P1} and AIN_{P2} supplied via the vertical signal lines VSL₁ and VSL₂, and supplies the pixel signals AIN_{P1} and AIN_{P2} converted into digital signals to the output circuit 1234.

The output circuit 1234 performs signal processing such as Correlated Double Sampling (CDS) processing on the pixel signals AIN_{P1} and AIN_{P2} converted into digital signals and output from the column signal processing unit 1232. The output circuit 1234 outputs the pixel signals AIN_{P1} and AIN_{P2}, which have undergone signal processing, to the outside of the sensor unit 120 via an output line 51 as a pixel signal read from a tap A and a pixel signal read from a tap B, respectively.

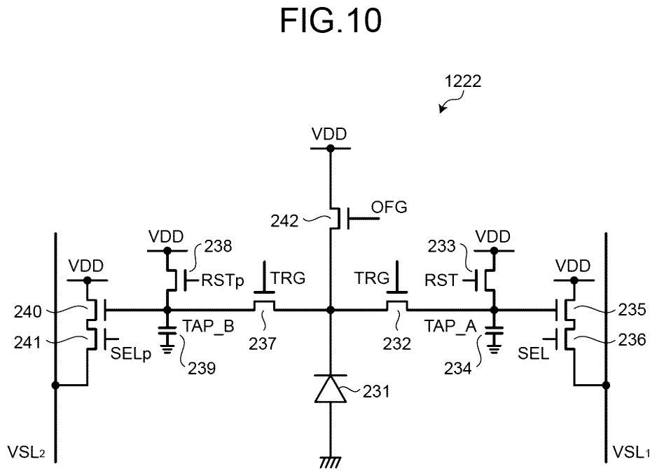

FIG. 10 is a circuit diagram illustrating a configuration of an example of the pixel 1222 applied to each embodiment. The pixel 1222 includes a photodiode 231, two transfer transistors 232 and 237, two reset transistors 233 and 238, two floating diffusion layers 234 and 239, two amplification transistors 235 and 240, and two selection transistors 236 and 241. The floating diffusion layers 234 and 239 correspond to the tap A (denoted as TAP_A) and the tap B (denoted as TAP_B) described above, respectively. The photodiode 231 is a light receiving element

that photoelectrically converts received light to generate a charge. When a surface on which the circuit is disposed in the semiconductor substrate is defined as a front surface, the photodiode 231 is disposed on a back surface of the substrate. The solid-state imaging element like this is referred to as a back-illuminated solid-state imaging element. Instead of the back-illuminated type, it is also possible to use a front-illuminated configuration in which the photodiode 231 is arranged on the front surface.

An overflow transistor 242 is connected between a cathode electrode of the photodiode 231 and a power supply line VDD, and has a function of resetting the photodiode 231. That is, the overflow transistor 242 is turned on in response to the overflow gate signal OFG supplied from the vertical drive circuit 1231, thereby sequentially discharging the charge of the photodiode 231 to the power supply line VDD.

The transfer transistor 232 is connected between the cathode of the photodiode 231 and the floating diffusion layer 234. Furthermore, the transfer transistor 237 is connected between the cathode of the photodiode 231 and the floating diffusion layer 239. The transfer transistors 232 and 237 sequentially transfer the charges generated by the photodiode 231 to the floating diffusion layers 234 and 239, respectively, in accordance with a transfer signal TRG supplied from the vertical drive circuit 1231.

The floating diffusion layers 234 and 239 corresponding to the taps A and B accumulate the charges transferred from the photodiode 231, convert the charges into voltage signals of voltage values corresponding to the accumulated charge amounts, and respectively generate pixel signals AIN_{P1} and AIN_{P2} which are analog pixel signals.

In addition, the two reset transistors 233 and 238 are connected between the power supply line VDD and each of the floating diffusion layers 234 and 239. The reset transistors 233 and 238 are turned on in accordance with reset signals RST and RSTp supplied from the vertical drive circuit 1231, thereby extracting charges from the floating diffusion layers 234 and 239, respectively, and initializing the floating diffusion layers 234 and 239.

The two amplification transistors 235 and 240 are connected between the power supply line VDD and each of the selection transistors 236 and 241. The amplification transistors 235 and 240 each amplify a voltage signal obtained by converting a charge into a voltage in each of the floating diffusion layers 234 and 239.

The selection transistor 236 is connected between the amplification transistor 235 and the vertical signal line VSL₁. In addition, the selection transistor 241 is connected between the amplification transistor 240 and the vertical signal line VSL₂. The selection transistors 236 and 241 are turned on in accordance with the selection signals SEL and SELₚ supplied from the vertical drive circuit 1231, thereby outputting the pixel signals AIN_{P1} and AIN_{P2} amplified by the amplification transistors 235 and 240 to the vertical signal line VSL₁ and the vertical signal line VSL₂, respectively.

The vertical signal line VSL₁ and the vertical signal line VSL₂, connected to the pixel 1222 are connected to an input end of one AD converter included in the column signal processing unit 1232 for each pixel column. The vertical signal line VSL₁ and the vertical signal line VSL₂, supply the pixel signals AIN_{P1} and AIN_{P2} output from the pixels 1222 to the AD converters included in the column signal processing unit 1232 for each pixel column.

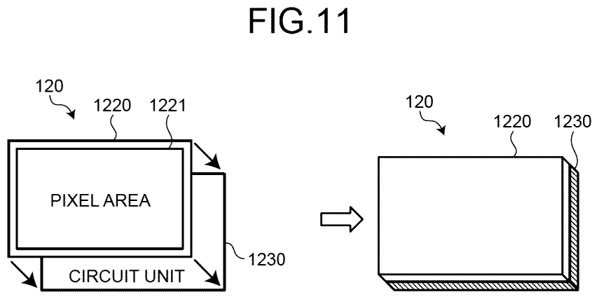

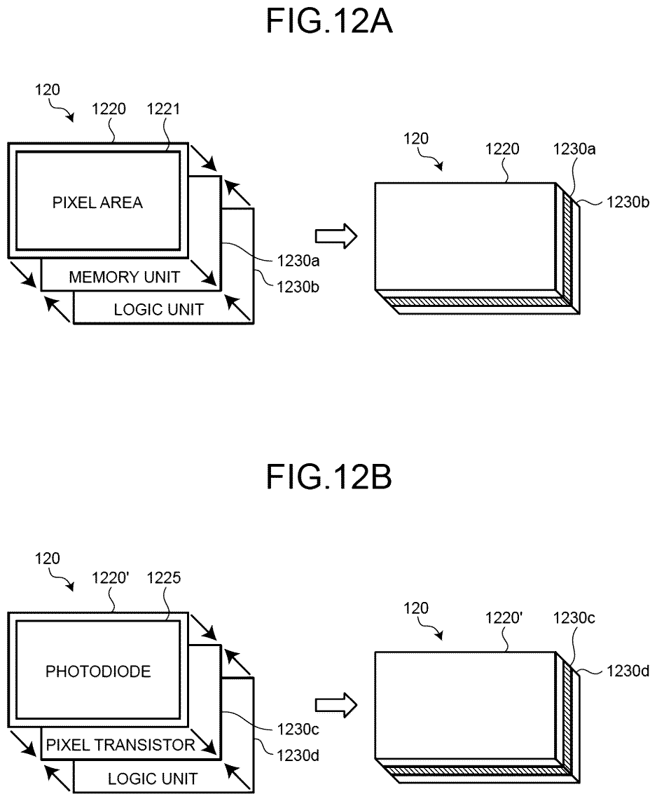

The stacked structure of the sensor unit 120 will be schematically described with reference to FIG. 11 and FIGS. 12A and 12B.

As an example, the sensor unit 120 can be formed by a double-layer structure in which semiconductor chips are stacked in two layers. FIG. 11 is a diagram illustrating an example in which the sensor unit 120 applicable to each embodiment is formed by a stacked Complementary Metal Oxide Semiconductor Image Sensor (CIS) having a double-layer structure. In the structure of FIG. 11, the pixel area 1221 is formed in the semiconductor chip of the first layer which is the sensor chip 1220, while a circuit unit is formed in the semiconductor chip being the second layer which is the circuit chip 1230.

The circuit unit includes, for example, the vertical drive circuit 1231, the column signal processing unit 1232, the timing control circuit 1233, and the output circuit 1234. Note that the sensor chip 1220 may include the pixel area 1221 and the vertical drive circuit 1231, for example. As illustrated on the right side of FIG. 11, the sensor chip 1220 and the circuit chip 1230 are bonded together with electrical contact with each other, so as to form the sensor unit 120 as one solid-state imaging element.

As another example, the sensor unit 120 can be formed in a triple-layer structure in which semiconductor chips are stacked in three layers. FIGS. 12A and 12B are diagrams each illustrating an example in which the sensor unit 120 applicable to each embodiment is formed by a stacked CIS having a triple-layer structure.

In the structure of FIG. 12A, the pixel area 1221 is formed in a semiconductor chip being a first layer, which is the sensor chip 1220. In addition, the above-described circuit chip 1230 is divided into a first circuit chip 1230a formed of a semiconductor chip being a second layer and a second circuit chip 1230b formed of a semiconductor chip being a third layer. As illustrated on the right side of FIG. 12A, the sensor chip 1220, the first circuit chip 1230a, and the second circuit chip 1230b are bonded together with electrical contact with each other, so as to form the sensor unit 120 as one solid-state imaging element.

Furthermore, the sensor unit 120 may be formed in a triple-layer structure as illustrated in FIG. 12B. In FIG. 12B, a light receiving area 1225 including each photodiode 231 is formed in the semiconductor chip of the first layer provided as a sensor chip 1220′. In addition, the circuit chip 1230 described above is formed by being divided into: a first circuit chip 1230c being the semiconductor chip as the second layer on which a pixel transistor is formed; and a second circuit chip 1230d being a third semiconductor chip including a logic unit. As illustrated on the right side of FIG. 12B, the sensor chip 1220′, the first circuit chip 1230c, and the second circuit chip 1230d are bonded together with electrical contact with each other, so as to form the sensor unit 120 as one solid-state imaging element. The structure illustrated in FIG. 12B enables further expansion of the light receiving area of the photodiode 231.

### 2-3. Configuration Example of Information Processing Device

Next, a configuration of the information processing device 20 applicable to the embodiment will be described.

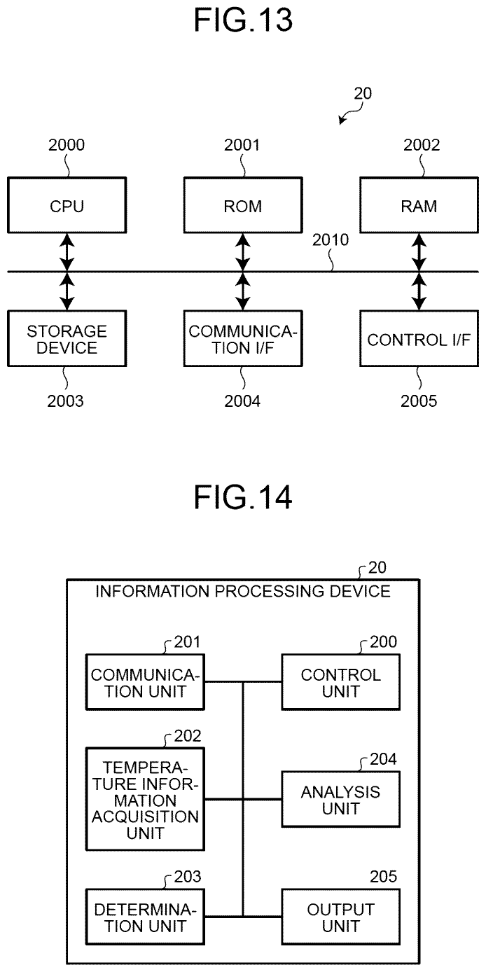

FIG. 13 is a block diagram schematically illustrating a hardware configuration of an example of the information processing device 20 applicable to the embodiment. In FIG. 13, the information processing device 20 includes a CPU 2000, ROM 2001, RAM 2002, a storage device 2003, a communication I/F 2004, and a control I/F 2005, and these units are communicably connected to each other by a bus 2010.

The storage device 2003 is a nonvolatile storage medium such as flash memory or a solid state drive (SSD). The storage device 2003 may be implemented by applying a hard disk drive. The CPU 2000 operates using the RAM 2002 as work memory in accordance with the program stored in the storage device 2003 and the ROM 2001 so as to control the entire operation of the information processing device 20.

The communication interface (communication I/F) 2004 is an interface that controls wired or wireless communication between the information processing device 20 and the sensor device 10. The control I/F 2005 is an interface for controlling wired or wireless communication between the information processing device 20 and the control target device 30. The configuration is not limited thereto, and the information processing device 20 may further communicate with another external device different from the sensor device 10 or the control target device 30 via the communication I/F 2004 or the control I/F 2005.

The information processing device 20 may further include a display device that displays predetermined information to the user, and an input device that receives an operation input by the user.

FIG. 14 is a block diagram of an example for illustrating functions of the information processing device 20 applicable to the embodiment. In FIG. 14, the information processing device 20 includes a control unit 200, a communication unit 201, a temperature information acquisition unit 202, a determination unit 203, an analysis unit 204, and an output unit 205.

The control unit 200, the communication unit 201, the temperature information acquisition unit 202, the determination unit 203, the analysis unit 204, and the output unit 205 are implemented by executing, on the CPU 2000, the information processing program according to the embodiment. Not limited to this, some or all of the control unit 200, the communication unit 201, the temperature information acquisition unit 202, the determination unit 203, the analysis unit 204, and the output unit 205 may be implemented by hardware circuits operating in cooperation with each other.

In the information processing device 20, the CPU 2000 executes the information processing program according to the embodiment to configure each of the above-described units as, for example, a module on a main storage region in the RAM 2002. The information processing program can be acquired from the outside via a network by communication via the communication I/F 2004 or the control I/F 2005, for example, and installed on the information processing device 20. Furthermore, the information processing program may be provided by being stored in a detachable storage medium such as a compact disk (CD), a digital versatile disk (DVD), or a memory device such as a universal serial bus (USB) flash drive.

In FIG. 14, the communication unit 201 controls communication with the sensor device 10. The control unit 200 controls the overall operation of the information processing device 20, and controls the operation of the sensor device 10 via communication with the sensor device 10 by the communication unit 201. For example, the control unit 200 controls the operation of at least one of the light emission unit 110 or the sensor unit 120 included in the sensor device 10 by a control signal generated in a predetermined manner. That is, the control unit 200 functions as a control unit that controls operation of at least one of the plurality of light sources or the imaging unit.

The temperature information acquisition unit 202 acquires temperature information indicating a temperature detected by the temperature sensor 130 included in the sensor device 10, via communication by the communication unit 201. The determination unit 203 uses one or more thresholds to perform threshold determination on the temperature indicated in the temperature information acquired by the temperature information acquisition unit 202. The control unit 200 may control the operation of the sensor device 10 based on the determination result of the determination unit 203.

The analysis unit 204 acquires a distance image stored in, for example, the memory 104 of the sensor device 10 via communication by the communication unit 201, and analyzes the acquired distance image. For example, the analysis unit 204 may execute skeleton estimation based on the distance image and acquire the movement of the target object Ob as a result of the skeleton estimation. For example, when the target object Ob is an occupant of the vehicle 1000, the analysis unit 204 may recognize a gesture of the occupant by skeleton estimation. In addition, for example, when the target object Ob is a driver of the vehicle 1000, the analysis unit 204 may recognize the state of the driver (whether the driver is in a state not dozing, whether the driver takes a correct driving posture, or the like) by skeleton estimation.

The output unit 205 outputs, for example, control information based on the analysis result obtained by the analysis unit 204 to the control target device 30.

### 3. First Embodiment According to Present Disclosure

Next, a first embodiment according to the present disclosure will be described. The first embodiment restricts the function of the camera module 100 in an area with low priority in the detection area of the sensor device 10 when the temperature of the camera module 100 reaches a certain temperature. This makes it possible to raise the upper limit of the temperature guarantee range of the camera module 100 with respect to the environmental temperature Ta (=35° C.).

### 3-1. First Example of First Embodiment

First, a first example of the first embodiment will be described. The first example of the first embodiment is an example of restricting the power of the projection light Li for each area included in the detection area of the sensor device 10, in accordance with the priority of each area, when the temperature of the camera module 100 reaches a certain temperature.

An example of the priority of each area included in the detection area applicable to the first example of the first embodiment will be described. As an example, the detection area including an entire region of the visual field Fv as viewed from the sensor device 10 is horizontally divided into two. In these two areas, an area on the side including the passenger seat 1003 is set as a first area, and an area on the side including the driver's seat 1002 is set as a second area. An area including the head or the head, or an area including the chest, of the driver seated on the driver's seat 1002 in the second area is defined as a third area. In this case, the third area is set to have the highest priority, and the first area is set to have the lowest priority. The second area is set to have an intermediate priority between the priority of the third area and the priority of the first rear.

That is, the priority order of each area is as in the following Formula (7).

$$Third area > Second area > First area \qquad ( 7 )$$

Division is not limited thereto, and the detection area including the entire visual field Fv viewed from the sensor device 10 may be divided into two in the vertical direction. In this case, the priority may be set by defining an area including the head or including the head and the chest of the car driver seated on the driver's seat 1002 and the occupant seated on the passenger seat 1003, as the second area, defining other areas as the first area, and defining a specific area within the second area, the specific area being an area including the head or including the head and the chest of the driver seated on the driver's seat 1002, as the third area.

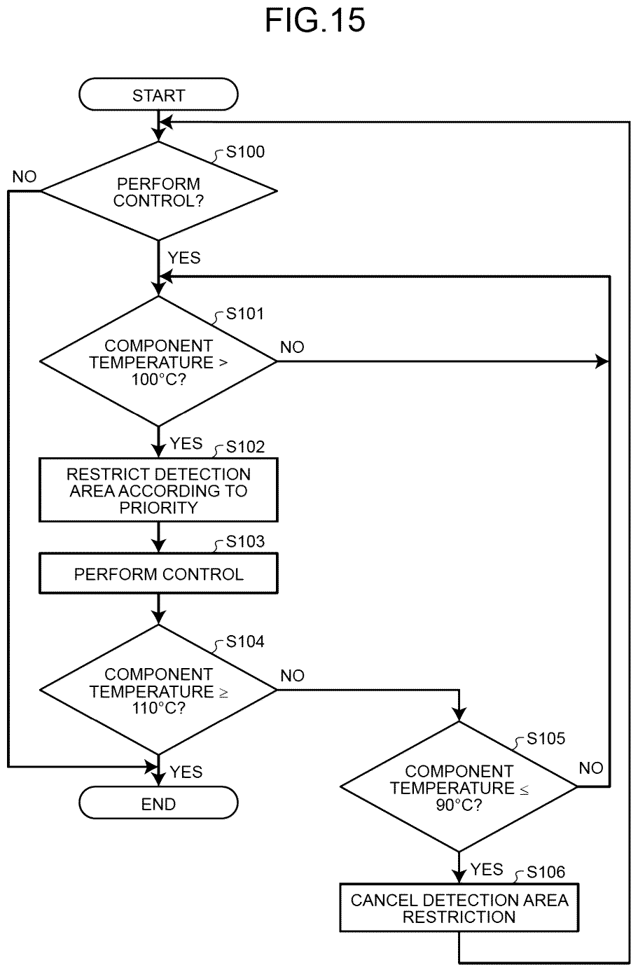

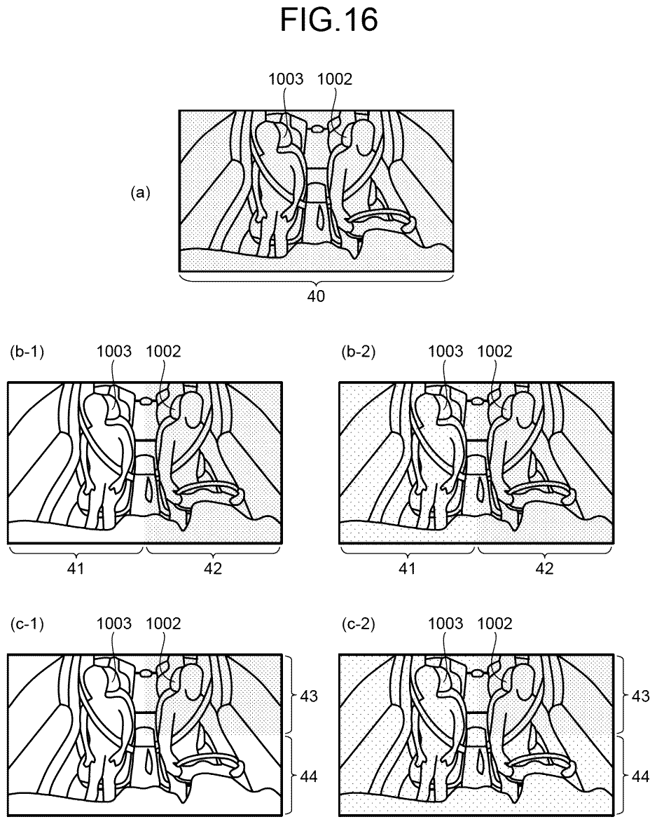

The control according to the first example of the first embodiment will be described with reference to FIGS. 15 and 16. FIG. 15 is a flowchart illustrating an example of processing according to the first example of the first embodiment. FIG. 16 is a schematic diagram illustrating an example of an irradiation state by light emission control according to the first example of the first embodiment. In FIG. 16 and similar drawings to be described below, the intensity of the irradiation light is expressed by the thickness of shading.

Here, the camera module 100 is represented by the camera module 100a with four lamps having four light emission units 110 illustrated in FIG. 5A. When the vehicle 1000 is a left-hand drive car, the laser diodes 1202a and 1202b in the camera module 100a irradiate the driver's seat. 1002 side, and the laser diodes 1202c and 1202d irradiate the passenger seat 1003 side. In addition, the laser diode 1202a irradiates an upper side of the driver's seat 1002, specifically, the chest and the head of the driver seated in the driver's seat 1002, for example.

In addition, in the camera module 100, the temperature detected by the temperature sensor 130 is assumed to be a component temperature, namely, a temperature of the component in the camera module 100. For example, with the temperature sensor 130 installed at a portion having the highest temperature in the camera module 100, the temperature detected by the temperature sensor 130 can be regarded as a representative value of the component temperature of each component in the camera module 100. The portion having the highest temperature in the camera module 100 is determined by applying the module control unit 101 including a device driver that applies drive power to the light emission unit 110.

Furthermore, the upper limit of the operating temperature range of the component temperature (module temperature) is assumed to be +105° C. defined as AEC-Q100 Grade 2.

As a precondition for the processing of the flowchart of FIG. 15, it is assumed that all of the four light emission units 110 of the camera module 100 emit light, and the entire detection area indicated as a region 40 in section (a) of FIG. 16 is set as an irradiation range of the projection light Li.

In step S100, the control unit 200 in the information processing device 20 determines whether to perform detection area control. For example, the control unit 200 may determine whether to perform control in accordance with a user operation on the information processing device 20. Not limited to this, and the control unit 200 may determine whether to perform control based on a predetermined state (such as power supply turn-on) of the information processing device 20.

When having determined not to perform the control of the detection area (step S100, “No”), the control unit 200 ends a series of processing of the flowchart of FIG. 15. In contrast, when having determined to perform the control of the detection area (step S100, “Yes”), the control unit 200 proceeds to the processing of step S101.

In step S101, the determination unit 203 in the information processing device 20 determines whether the component temperature in the camera module 100 exceeds a first threshold (100° C. in this example) based on the temperature information acquired by the temperature information acquisition unit 202. Note that the first threshold is based on 105° C. which is the upper limit of the operating temperature range defined as AEC-0100 Grade 2, and is not limited to 100° C. as long as the threshold is a value being 105° C. or less and exceeding a third threshold (for example, 90° C.) to be described below.

When the determination unit 203 has determined that the component temperature the first threshold or less (step S101, “No”), the control unit 200 returns to the processing of step S101. In contrast, when the determination unit 203 has determined that the component temperature exceeds the first threshold (step S101, “Yes”), the control unit 200 proceeds to the processing of step S102.

In step S102, the control unit 200 sets the detection area by the sensor device 10 to be restricted in accordance with the priority set for each area in the detection area. For example, the control unit 200 generates a control signal that restricts a detection function for an area set to have a lower priority.

More specifically, the control unit 200 generates a control signal of controlling the sensor device 10 so as to stop light emission (set the power to zero (0)) of light emission unit 110 corresponding to the first area (the area including passenger seat 1003) or decrease the power of light emission by the light emission unit 110. By stopping light emission of the light emission unit 110 or decreasing the power of light emission, the laser diode driver (control unit 200) that supplies drive power to the light emission unit 110 will suppress current consumption, leading to suppression of heat generation. In addition, controlling the sensor device 10 by such a control signal will weaken the projection light Li applied to the area, restricting the detection function on the area.

Sections (b-1) and (b-2) in FIG. 16 each schematically illustrate the state of the irradiation light by the light emission control of the light emission unit 110 in step S102.

Section (b-1) in FIG. 16 illustrates an example of suppressing light emission of the light emission unit 110 (for example, laser diodes 1202c and 1202d) corresponding to the first area with low priority. In this case, the control unit 200 may stop the supply of the drive power to the light emission unit 110. In section (b-1), light of the light emission unit 110 is not to be applied to a region 41 corresponding to the first area. On the other hand, light emitted from the light emission unit 110 with power equivalent to the power for the region 40 in section (a), for example, is to be applied to a region 42 corresponding to the second area (the area including driver's seat 1002).

Section (b-2) in FIG. 16 illustrates an example in which the power of light emission by the light emission unit 110 corresponding to the first area having a low priority is decreased. In this case, the control unit 200 may supply, for example, drive power lower than the drive power supplied to the light emission unit 110 corresponding to the second area (for example, the laser diodes 1202a and 1202b) to the light emission unit 110. In section (b-2), light from the light emission unit 110 is applied to the region 41 corresponding to the first area with lower power than to the region 42 corresponding to the second area.

In each example of the sections (b-1) and (b-2) of FIG. 16, current consumption of the laser diode driver (control unit 200) that supplies drive power to the light emission unit 110 is suppressed, leading to suppression of heat generation. In addition, the irradiation amount of light by the light emission unit 110 with respect to the region 41 is decreased as compared with the irradiation amount with respect to the region 42, and the detection area by the sensor device 10 is restricted.

In the next step S103, the control unit 200 transmits the control signal generated in step S102 to the sensor device 10. The sensor device 10 receives the control signal transmitted from the information processing device 20 by the communication I/F 105 and passes the control signal to the module control unit 101. The module control unit 101 generates a drive signal according to the transmitted control signal and drives the light emission unit 110.

In next step S104, the determination unit 203 in the information processing device 20 determines whether the component temperature in the camera module 100 exceeds a second threshold (110° C. in this example) based on the temperature information acquired by the temperature information acquisition unit 202. Note that the second threshold is used to perform judgment to stop operation of the camera module 100 based on 105° C., which is the upper limit of the operating temperature range defined as AEC-Q100 Grade 2, and is not limited to 110° C.

When the determination unit 203 has determined that the component temperature is the second threshold or more (step S104, “Yes”), the control unit 200 stops the operation of the camera module 100, for example, and ends the series of processing of the flowchart of FIG. 15. In contrast, when the determination unit 203 has determined that the component temperature is less than the second threshold (step S104, “No”), the control unit 200 proceeds to the processing of step S105.

In step S105, the determination unit 203 determines whether the component temperature in the camera module 100 is a third threshold (90° C. in this example) or less based on the temperature information acquired by the temperature information acquisition unit 202. Note that the third threshold is a threshold for judging whether the temperature of the camera module 100 is within an appropriate temperature range based on 105° C. which is the upper limit of the operating temperature range defined as AEC-Q100 Grade 2, and is not limited to 90° C. as long as the third threshold is a value less than the first threshold.

In step S105, when the determination unit 203 has determined that the component temperature is the third threshold or less (step S105, “Yes”), the control unit 200 proceeds to the processing of step S106. In step S106, the control unit 200 cancels the restriction of the detection area set in step S102. For example, in a case where the irradiation of the region 41 with light is restricted as in the above-described section (b-1) or (b-2) in FIG. 16, the control unit 200 cancels this restriction and returns to the state illustrated in section (a) in FIG. 16.

After the processing of step S106, the control unit 200 returns to the processing of step S100.

In contrast, when the determination unit 203 has determined that the component temperature exceeds the third threshold (step S105, “No”), the control unit 200 returns to the processing of step S101. In a case where the processing returns from step S105 to step S101 and the determination unit 203 has determined that the component temperature exceeds the first threshold, the control unit 200 tightens the restriction on the detection area in stages in the next steps S102 and S103.

Processing in steps S101 to S103 after step S105 will be described more specifically with reference to FIG. 16.

An exemplary case where the restriction of the detection area is implemented by stopping light emission by the light emission unit 110 will be described. In step S105 immediately before returning to the processing of step S101, it is assumed that the component temperature exceeds the third threshold in a state where the light emission of the light emission unit 110 corresponding to the region 41 is stopped as illustrated in section (b-1) of FIG. 16, and the processing returns from step S105 to step S101.

In this case, for example, not only in the first area but also in the second area, the control unit 200 generates a control signal for controlling the sensor device 10 to suppress light emission of the light emission unit 110 corresponding to regions other than the third area (area including the head of driver or area including head and chest of the driver). By controlling the sensor device 10 by such a control signal, for example, light emission by the laser diodes 1202b to 1202d in the light emission unit 110 is stopped, and only the laser diode 1202a having the highest priority third area as an irradiation target is allowed to emit light.

Section (c-1) in FIG. 16 illustrates an example in which only the light emission unit 110 (for example, laser diode 1202a) corresponding to the third area is allowed to emit light, while other light emission units 110 (for example, laser diodes 1202b to 1202d) are not allowed to emit light. In this case, the control unit 200 may stop the supply of the drive power to the other light emission units 110. On the other hand, light emitted from the light emission unit 110 with power equivalent to the power for the region 40 in section (a), for example, is to be applied to a region 43 corresponding to the third area.

The similar applies to a case where the restriction of the detection area is implemented by decreasing the power of light emission by the corresponding light emission unit 110.

Section (c-2) in FIG. 16 illustrates an example in which the power of light emission by light emission unit 110 corresponding to the areas other than the third area is decreased. In this case, drive power lower than the drive power to be supplied to the light emission unit (for example, the laser diode 1202a) corresponding to the third area may be supplied to the other light emission units 110 (for example, the laser diodes 1202b to 1202d). In section (c-2), the region 44 corresponding to the area other than the third area is irradiated with light from the light emission unit 110 with lower power than the region 43 corresponding to the third area.

That is, the current consumption by the laser diode driver (control unit 200), which has been suppressed by the processing in steps S101 to S103 immediately before the processing is returned from step S105 to step S101, is further suppressed by the processing in and after step S105, leading to further suppression of the heat generation. At the same time, the detection area restricted in the immediately preceding process is further restricted.

In this manner, in the first example of the first embodiment, the detection function of the sensor device 10 is restricted in accordance with the temperature of the camera module 100. At this time, in the first example of the first embodiment, the detection function is restricted by controlling the drive power for driving the light emission unit 110. This suppresses the current consumption of the laser diode driver (control unit 200) that supplies drive power to the light emission unit 110, leading to suppression of the heat generation. Therefore, with application of the first example of the first embodiment, it is possible to guarantee the operation of the vehicle 1000 in the temperature range according to the operation guarantee standard without depending on the hardware heat dissipation measures.

The above has been described assuming that the component used for the camera module 100 conforms to AEC-Q100 Grade 2. However, in a case where a component having a higher Grade can be used as the component, the first to third thresholds described above can be set to higher temperatures.

### Specific Example of First Example of First Embodiment

Next, a first example of the first embodiment will be described using more specific examples.

Although the example of the camera module 100a with four lamps having the four light emission units 110 has been described above, the first example of the first embodiment is also applicable to the camera module 100b with two lamps (refer to FIG. 5B) having the two light emission units 110.

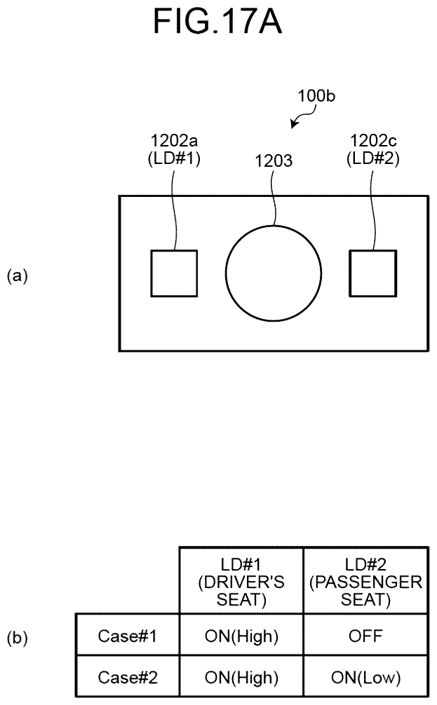

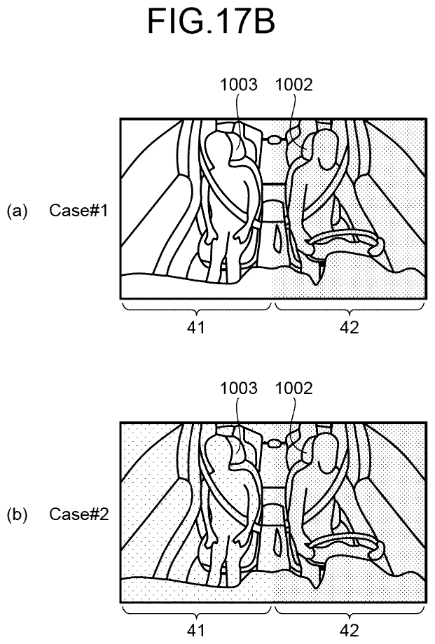

Light emission control in the camera module 100b with two lamps according to the first example of the first embodiment will be described with reference to FIGS. 17A and 17B. FIG. 17A is a schematic diagram for illustrating light emission control in the camera module 100b with two lamps according to the first example of the first embodiment. FIG. 17B is a schematic diagram illustrating an example of an irradiation state by light emission control in the camera module 100b with two lamps according to the first example of the first embodiment.

In FIG. 17A, section (a) is a diagram equivalent to section (a) in FIG. 5B, and illustrates an example of the arrangement of each light emission unit 110 (laser diodes 1202a and 1202c) and the lens 1203 in the camera module 100b.

In the example of FIG. 17A, the laser diode 1202a that irradiates the detection area including the side of the driver's seat 1002 is used for the light emission unit LD #1 while the laser diode 1202c that irradiates the detection area including the side of the passenger seat 1003 is used for the light emission unit LD #2.

In FIG. 17A, section (b) illustrates an example of control related to the detection area restriction in the camera module 100b. In section (b) and a similar diagram to be described below, “High” indicates that the light emission unit 110 is driven with normal drive power (drive power setting: High), and “Low” indicates that the light emission unit 110 is driven with drive power lower than “High” (drive power setting: Low). In addition, “OFF” indicates that the driving of the light emission unit is stopped with the drive power zero (0) for the light emission unit 110.

The drive power Low is preferably set to a value that allows the sensor unit 120 to detect the reflected light Lr of the projection light Li. As an example, in a case where the drive power High is 4 W (watts), it is conceivable to set the drive power Low to about 70% to 80% (for example, 3 W-3.5 W) with respect to the power High.

In section (b) of FIG. 17A, Case #1 is an example in which the light emission is stopped in accordance with the priority, in which the light emission unit LD #1 whose irradiation target is the driver's seat 1002 side is driven with the drive power High, while the light emission unit DL #2 whose irradiation target is the passenger seat 1003 side is stopped (OFF). As a result, in Case #1, the current consumption of the laser diode driver (control unit 200) is suppressed, leading to suppression of the heat generation. At the same time, in Case #1, as schematically illustrated in section (a) of FIG. 17B, light emitted from light emission units LD #1 and LD #2 is applied to the region 42 including the driver's seat 1002, and is not applied to the region 41 including the passenger's seat.

On the other hand, Case #2 is an example in which the power of light emission is controlled in accordance with the priority, and the light emission unit LD #1 is driven by the drive power High while the light emission unit LD #2 is driven by the drive power Low, individually. As a result, in Case #2, the current consumption of the laser diode driver (control unit 200) is suppressed, leading to suppression of the heat generation. At the same time, in Case #2, as schematically illustrated in section (b) of FIG. 17B, the light emitted from the light emission units LD #1 and LD #2 is emitted to the regions 41 and 42, respectively, but the light emitted to the region 41 is weaker than the light emitted to the region 42.

In the camera module 100b with two lamps, the control unit 200 may allow the drive pattern of each of the light emission units LD #1 and LD #2 to transition from the normal state (driven by the drive power High of each of the light emission units LD #1 and LD #2) to Case #1 in accordance with the temperature. The operation is not limited thereto, and the control unit 200 may allow the drive pattern of each of the light emission units LD #1 and LD #2 to transition from the normal state to Case #2 and further to Case #1 in accordance with the temperature.

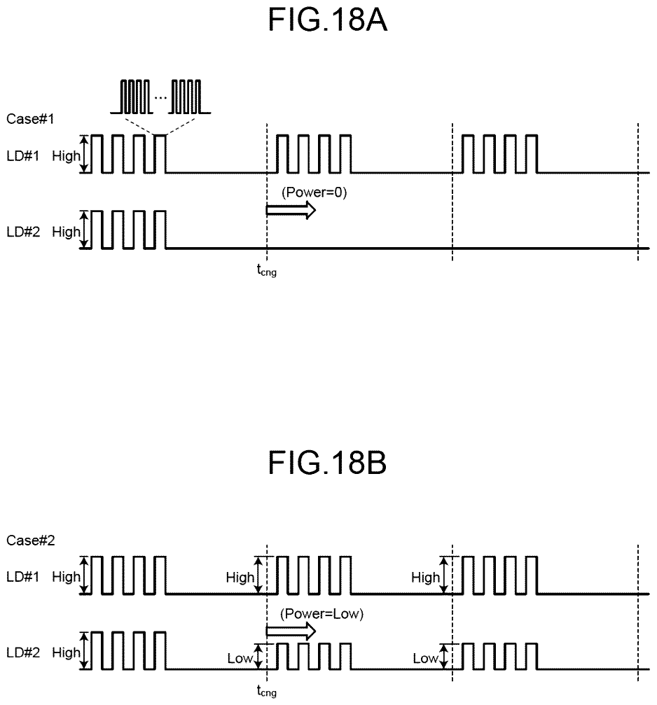

FIGS. 18A and 18B are schematic diagrams each illustrating an example of a drive signal for driving the light emission unit 110 according to the first example of the first embodiment. In FIGS. 18A and 18B, time is indicated in the horizontal direction, and drive power is indicated in the vertical direction.

FIG. 18A corresponds to Case #1 in section (b) in FIG. 17A, and illustrates an example of a drive signal in a case where light emission is stopped in accordance with priority. FIG. 18A assumes that one distance measurement is performed and one distance image is acquired for each light emission by a drive signal in four consecutive light emission periods of the light emission unit 110.

Here, in FIG. 18A (and FIG. 18B), one light emission period includes a plurality of pulses of the projection light Li illustrated using FIG. 8, for example. The duty of the plurality of pulses is 50% at the maximum, for example.

That is, the cycle of the pulse of the projection light Li in FIG. 8 is set to a relatively high rate of several 10 megahertz (MHz) to several 100 MHz. Therefore, in the sensor unit 120, the charge accumulated in the two floating diffusion layers 234 and 239 (refer to FIG. 10) in the pixel 1222 by one pulse of the projection light Li is relatively small. Therefore, the sensor device 10 stores a sufficient amount of charge in the floating diffusion layers 234 and 239 by repeating the emission of the projection light Li several thousand times to several tens of thousands of times in one distance measurement.

It is assumed that the detection area is restricted at time t_{cng} by the processing of steps S101 to S103 in the flowchart of FIG. 15 described above. In this case, at the time t_{cng}, the control unit 200 switches the drive power supplied to the light emission unit LD #2 from the drive power High to zero (0) (Power=0). In contrast, the control unit 200 drives the light emission unit LD #1 with the drive power High even after the time tang.

FIG. 18B corresponds to Case #2 in section (b) in FIG. 17A, and illustrates an example of a drive signal in a case where drive power is controlled in accordance with priority. The meaning of each part in the drawings is similar to the case of FIG. 18A described above, and thus the description thereof will be omitted here.

It is assumed that the detection area is restricted at time t_{cng} by the processing of steps S101 to S103 in the flowchart of FIG. 15 described above. In this case, the control unit 200 switches the drive power supplied to the light emission unit LD #2 from the drive power High to the drive power Low at the time t_{cng}. In contrast, the control unit 200 drives the light emission unit LD #1 with the drive power High even after the time t_{cng}.

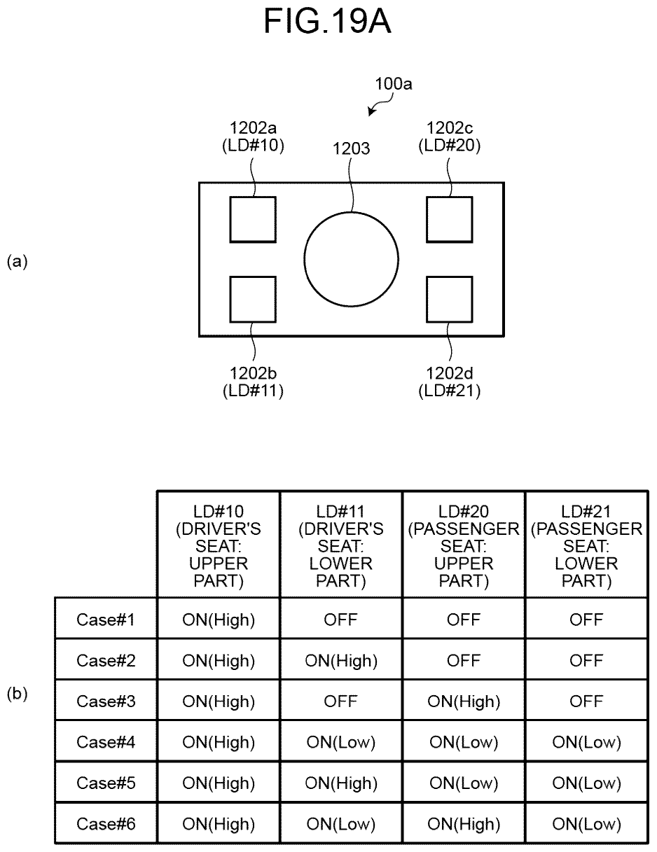

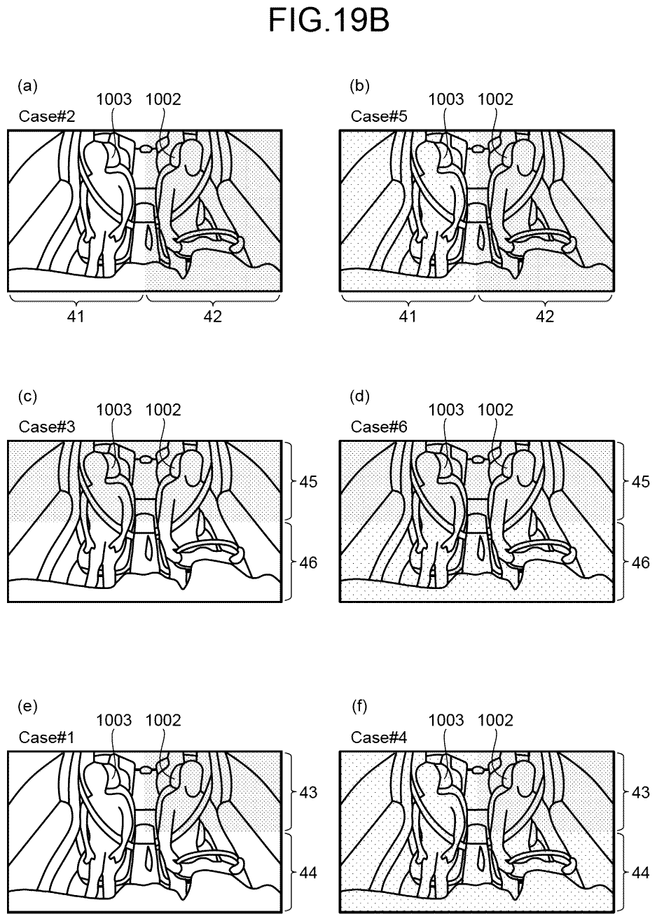

Light emission control in the camera module 100a with four lamps according to the first example of the first embodiment will be described with reference to FIGS. 19A and 19B. FIG. 19A is a schematic diagram for illustrating light emission control in the camera module 100a with four lamps according to the first example of the first embodiment. FIG. 19B is a schematic diagram illustrating an example of an irradiation state by light emission control in the camera module 100a with four lamps according to the first example of the first embodiment.

In FIG. 19A, section (a) is a diagram equivalent to section (a) in FIG. 5A, and illustrates an example of the arrangement of each light emission unit 110 (laser diodes 1202a and 1202d) and the lens 1203 in the camera module 100a.

In the example of FIG. 19A, the laser diode 1202a that irradiates the detection area including the driver's seat 1002 is used for the light emission unit LD #10 while the laser diode 1202b that irradiates the lower side of the detection area is used for the light emission unit LD #11. In addition, the laser diode 1202c that irradiates the detection area including the passenger seat 1003 is used for the light emission unit LD #20 while the laser diode 1202d that irradiates the lower side of the detection area is used for the light emission unit LD #21.

In FIG. 19A, section (b) illustrates an example of control related to the detection area restriction in the camera module 100a.

In Case #1, the light emission unit LD #10 whose irradiation target is the upper side of the driver's seat 1002 is driven at drive power High, and driving of other light emission units LD #11, LD #20, and LD #21 is stopped. In Case #2, two light emission units LD #10 and LD #11 whose irradiation target is the driver's seat 1002 side is driven at drive power High, and driving of other light emission units LD #20 and LD #21 is stopped. In Case #3, two light emission units LD #10 and LD #20 whose irradiation target is upper portions of the driver's seat 1002 and the passenger seat 1003 is driven at drive power High, and driving of other light emission units LD #11 and LD #21 is stopped.

In Case #4, the light emission unit LD #10 whose irradiation target is the upper side of the driver's seat 1002 is driven at drive power High, and the other light emission units LD #11, LD #20, and LD #21 is driven at the drive power Low. In Case #5, two light emission units LD #10 and LD #11 whose irradiation target is the driver's seat 1002 side is driven at drive power High, and the other light emission units LD #20 and LD #21 is driven at drive power Low. In Case #6, two light emission units LD #10 and LD #20 whose irradiation target is upper portions of the driver's seat 1002 and the passenger seat 1003 is driven at drive power High, and the other light emission units LD #11 and LD #21 are driven at drive power Low.

FIG. 19B is a schematic diagram for illustrating a detection area restriction in a camera module 100a with four lamps according to the first example of the first embodiment.

In FIG. 19B, sections (a) and (b) illustrate examples of detection area restrictions of Case #2 and Case #5 in section (a) in FIG. 19A, respectively. In Case #2 and Case #5, as illustrated in the figure, the detection area of the camera module 100a is divided into regions 41 and 42 arranged in the horizontal direction. In the example of Case #2 in section (a), light emitted from light emission units LD #10 to LD #21 is applied to the region 42 including the driver's seat 1002, and is not applied to the region 41 including the passenger seat 1003. In the example of Case #5 in section (b), the light emitted from the light emission units LD #10 to LD #21 is applied to the regions 41 and 42, respectively, but the light applied to the region 41 is weaker than the light applied to the region 42.

In FIG. 19B, sections (c) and (d) illustrate examples of detection area restrictions of Case #3 and Case #6 in section (a) in FIG. 19A, respectively. In Case #3 and Case #6, as illustrated in the figure, the detection area of the camera module 100a is divided into regions 45 and 46 arranged in the vertical direction. In the example of Case #3 in section (c), light from light emission units LD #10 to LD #21 is applied to the region 45 including the upper portion of the driver's seat 1002 and the passenger seat 1003, and is not applied to the region 46 including the lower portion thereof. In the example of Case #6 in section (d), the light emitted from the light emission units LD #10 to LD #21 is applied to the regions 45 and 46, respectively, but the light applied to the region 46 is weaker than the light applied to the region 45.

In FIG. 19B, sections (e) and (f) illustrate examples of detection area restrictions of Case #1 and Case #4 in section (a) in FIG. 19A, respectively. In Case #1 and Case #4, as illustrated in the drawing, the detection area of the camera module 100a is divided into the region 43 including the upper portion of the driver's seat 1002 and the other region 44 among two areas obtained by dividing the detection area in the horizontal and vertical directions. In the example of Case #1 in section (e), light from light emission units LD #10 to LD #21 is applied to the region 43 including the upper portion of the driver's seat 1002, and is not applied to the other region 44. In the example of Case #4 in section (f), the light emitted from the light emission units LD #10 to LD #21 is applied to the regions 43 and 44, respectively, but the light applied to the region 44 is weaker than the light applied to the region 43.

In the case of using the camera module 100a with four lamps, the control unit 200 may perform transition control, for each application, of the drive patterns of the light emission units LD #10 to LD #21 in accordance with the normal state and the patterns of the Cases #1 to #6 in accordance with the temperature.

Each case of Case #1 to Case #6 includes control of stopping light emission of the light emission unit 110 or decreasing the power of light emission, and the laser diode driver (control unit 200) that supplies drive power to the light emission unit 110 will suppress current consumption, leading to suppression of heat generation.

### 3-2. Second Example of First Embodiment

Next, a second example of the first embodiment will be described. The second example of the first embodiment is an example in which the detection area restriction in steps S102 and S103 in the flowchart of FIG. 15 is performed by controlling the light emission time by the light emission unit 110. Controlling the light emission time of the light emission unit 110 can suppress the current consumption of the laser diode driver (control unit 200) that supplies drive power to the light emission unit 110, enabling suppression of heat generation.

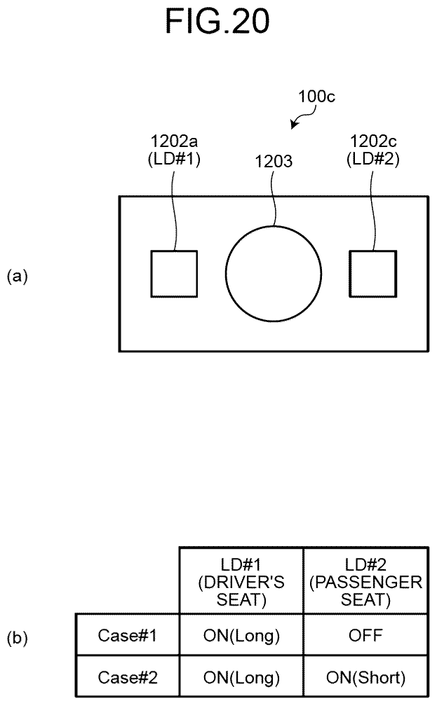

FIG. 20 is a schematic diagram for illustrating a detection area restriction in a camera module 100b with two lamps according to the second example of the first embodiment. In FIG. 20, section (a) is a diagram equivalent to section (a) in FIG. 5B, and illustrates an example of the arrangement of each light emission unit 110 (laser diodes 1202a and 1202c) and the lens 1203 in the camera module 100b.

In FIG. 20, section (b) illustrates an example of control related to the detection area restriction in the camera module 100b. In section (b) and a similar diagram to be described below, “Long” indicates that the light emission unit 110 is driven in a normal light emission time (light emission time: Long), and “Short” indicates that the light emission unit 110 is driven in a light emission time (light emission time: Short) shorter than “Long”. In addition, “OFF” indicates that the driving of the light emission unit is stopped with the drive power zero (0) for the light emission unit 110.

In section (b) of FIG. 20, Case #1 is an example in which the light emission is stopped in accordance with the priority, in which the light emission unit LD #1 whose irradiation target is the driver's seat 1002 side is driven with the light emission time Long, while the light emission unit DL #2 whose irradiation target is the passenger seat 1003 side is stopped (OFF). As a result, in Case #1, the current consumption of the laser diode driver (control unit 200) is suppressed, leading to suppression of the heat generation.

On the other hand, the Case #2 is an example in which the power of light emission is controlled in accordance with the priority, and the light emission unit LD #1 is driven with the light emission time Long and the light emission unit LD #2 is driven with the light emission time Short, individually. As a result, in Case #2, the current consumption of the laser diode driver (control unit 200) is suppressed, leading to suppression of the heat generation.

In the camera module 100b with two lamps, the control unit 200 may allow the drive pattern of each of the light emission units LD #1 and LD #2 to transition from the normal state (driven with the light emission time Long in each of the light emission units LD #1 and LD #2) to Case #1 in accordance with the temperature. The operation is not limited thereto, and the control unit 200 may allow the drive pattern of each of the light emission units LD #1 and LD #2 to transition from the normal state to Case #2 and further to Case #1 in accordance with the temperature.

The irradiation states of Case #1 and Case #2 by the light emission control in the camera module 100b with two lamps according to the second example of the first embodiment are similar to the examples illustrated in the sections (a) and (b) of FIG. 17B, and thus the description thereof is omitted here.

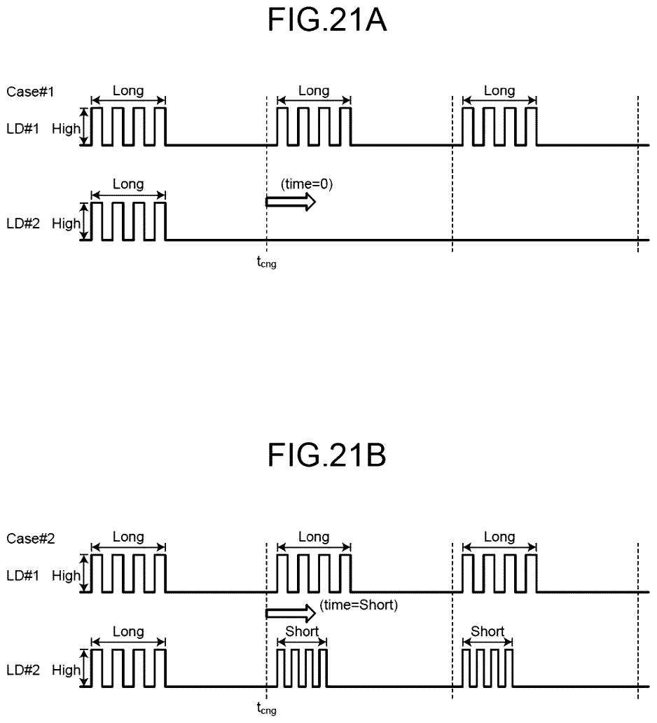

FIGS. 21A and 21B are schematic diagrams each illustrating an example of a drive signal driving the light emission unit 110 according to the second example of the first embodiment. In FIGS. 21A and 21B, time is indicated in the horizontal direction, and drive power is indicated in the vertical direction.

In addition, here, for the sake of explanation, it is assumed that the light emission time Long is 300 microseconds (μs) and the light emission time Short is 200 μs. In addition, similarly to FIGS. 18A and 18B described above, in FIGS. 21A and 21B, one light emission period includes a plurality of pulses, specifically, several thousand pulses to several tens of thousands of pulses.

FIG. 21A corresponds to Case #1 in section (b) in FIG. 20A, and illustrates an example of a drive signal in a case where light emission is stopped in accordance with the priority, that is, the light emission time is set to zero (0). In FIG. 21A, it is assumed that one distance measurement is performed and one distance image is acquired for each light emission in four consecutive light emission periods of the light emission unit 110.

It is assumed that the detection area is restricted at time t_{cng} by the processing of steps S101 to S103 in the flowchart of FIG. 15 described above. In this case, the control unit 200 sets the light emission time of the light emission unit LD #2 to zero (0) (time=0) at the time t_{cng}. In contrast, the control unit 200 drives the light emission unit LD #1 with the light emission time Long even after the time t_{cng}.

FIG. 21B corresponds to Case #2 in section (b) in FIG. 20A, and illustrates an example of a drive signal in a case where drive power is controlled in accordance with priority. The meaning of each part in the drawings is similar to the case of FIG. 21A described above, and thus the description thereof will be omitted here.

It is assumed that the detection area is restricted at time t_{cng} by the processing of steps S101 to S103 in the flowchart of FIG. 15 described above. In this case, the control unit 200 switches the light emission time of the light emission unit LD #2 from the light emission time Long to the light emission time Short at the time t_{cng}. In contrast, the control unit 200 drives the light emission unit LD #1 with the light emission time Long even after the time t_{cng}.

Here, the pulse cycle of the projection light Li included in one light emission period is assumed to be the same in the light emission time Long and the light emission time Short. In this case, the number of pulses included in one light emission period of the light emission time Short is smaller than the number of pulses included in one light emission period of the light emission time Long. Therefore, reducing the light emission time of the light emission unit 110 can suppress the current consumption of the laser diode driver (control unit 200) that supplies drive power to the light emission unit 110, leading to suppression of heat generation.

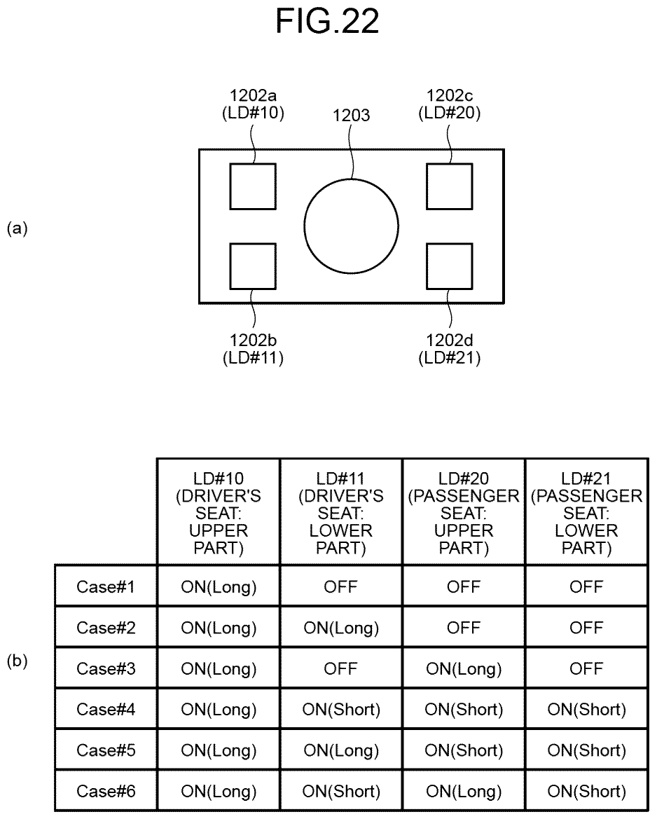

Light emission control in the camera module 100a with four lamps according to the second example of the first embodiment will be described with reference to FIG. 22.

In FIG. 22, section (a) is a diagram equivalent to section (a) of FIG. 5A and section (a) of FIG. 19A, and illustrates an example of the arrangement of each light emission unit 110 (laser diodes 1202a and 1202d) and the lens 1203 in the camera module 100a.

In FIG. 22, section (b) illustrates an example of control related to the detection area restriction in the camera module 100a.

In Case #1, the light emission unit LD #10 whose irradiation target is the upper side of the driver's seat 1002 is driven with light emission time Long, and driving of other light emission units LD #11, LD #20, and LD #21 is stopped. In Case #2, two light emission units LD #10 and LD #11 whose irradiation target is the driver's seat 1002 side is driven with light emission time Long, and driving of other light emission units LD #20 and LD #21 is stopped with light emission time zero (0). In Case #3, two light emission units LD #10 and LD #20 whose irradiation target is the upper side of the driver's seat 1002 and the passenger seat 1003 is driven with light emission time Long, and driving of other light emission units LD #11 and LD #21 is stopped with light emission time zero (0).

In Case #4, the light emission unit LD #10 whose irradiation target is the upper side of the driver's seat 1002 is driven with light emission time Long, and the other light emission units LD #11, LD #20, and LD #21 are driven with the light emission time Short. In Case #5, two light emission units LD #10 and LD #11 whose irradiation target is the driver's seat 1002 side is driven with light emission time Long, and the other light emission units LD #20 and LD #21 are driven with the light emission time Short. In Case #6, two light emission units LD #10 and LD #20 whose irradiation target is the upper side of the driver's seat 1002 and the passenger seat 1003 is driven with light emission time Long, and the other light emission units LD #11 and LD #21 are driven with the light emission time Short.

In the case of using the camera module 100a with four lamps, the control unit 200 may perform transition control, for each application, of the drive patterns of the light emission units LD #10 to LD #21 in accordance with the normal state and the patterns of the Cases #1 to #6 in accordance with the temperature.

The irradiation states of Case #1 to Case #6 by the light emission control in the camera module 100a with four lamps according to the second example of the first embodiment are similar to the examples illustrated in the sections (a) to (f) of FIG. 19B, and thus the description thereof is omitted here.

Each case of Case #1 to Case #6 includes control of driving the light emission unit 110 with the light emission time Short, and the laser diode driver (control unit 200) that supplies drive power to the light emission unit 110 will suppress current consumption, leading to suppression of heat generation.

### 3-3. Third Example of First Embodiment

Next, a third example of the first embodiment will be described. The third example of the first embodiment is an example of restricting the detection area in the camera module 100c with one lamp with one light emission unit 110 so as to suppress heat generation. Here, in the third example of the first embodiment, the detection area restriction is implemented by controlling the light reception operation by the sensor unit 120.

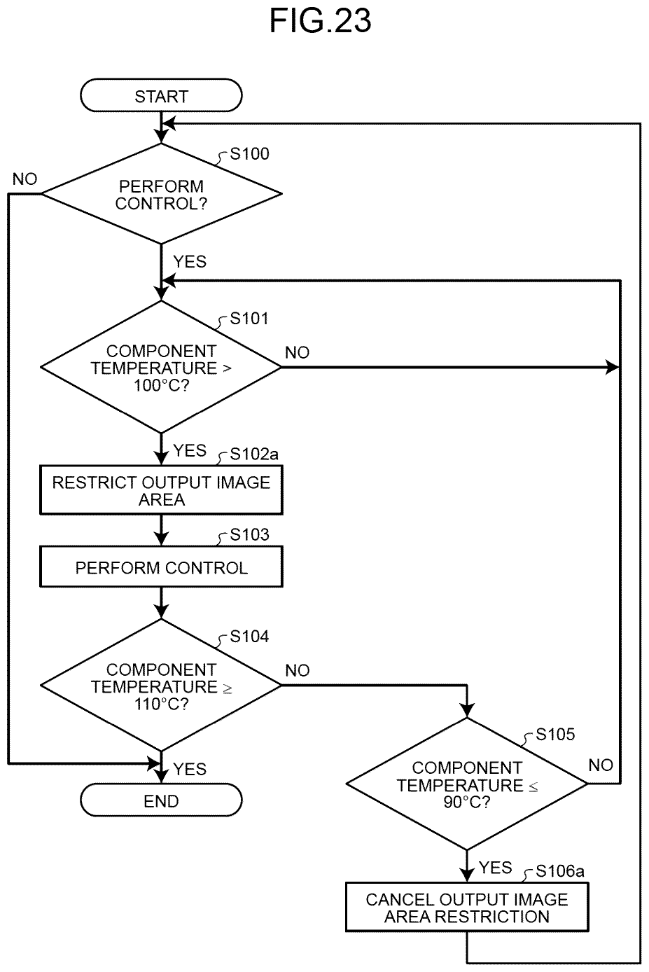

FIG. 23 is a flowchart illustrating an example of processing according to a third example of the first embodiment. The following will appropriately omit detailed description of processing corresponding to the processing of the flowchart of FIG. 15 described above.

As a precondition for the processing of the flowchart of FIG. 23, it is assumed that the sensor unit 120 of the camera module 100c performs the light reception operation in the image area by all the pixels 1222 included in the effective pixel region in the pixel area 1221, and outputs a distance image.

In step S100, the control unit 200 in the information processing device 20 determines whether to control the light reception operation. When having determined not to perform the control of the light reception operation (step S100, “No”), the control unit 200 ends a series of processing of the flowchart of FIG. 23. In contrast, when having determined to perform the control of the light reception operation (step S100, “Yes”), the control unit 200 proceeds to the processing of step S101.

In step S101, the determination unit 203 in the information processing device 20 determines whether the component temperature in the camera module 100 exceeds a first threshold (100° C. in this example) based on the temperature information acquired by the temperature information acquisition unit 202.

When the determination unit 203 has determined that the component temperature the first threshold or less (step S101, “No”), the control unit 200 returns to the processing of step S101. In contrast, when the determination unit 203 has determined that the component temperature exceeds the first threshold (step S101, “Yes”), the control unit 200 proceeds to the processing of step S102a.

In step S102a, the control unit 200 restricts the light reception operation of the sensor device 10. For example, in step S102a, the control unit 200 restricts the light reception operation by setting the output image area in which the sensor unit 120 outputs the image data to be restricted in accordance with the priority set for each area in the image area. That is, the control unit 200 generates a control signal that restricts the light reception operation in the image area corresponding to the area set to have a lower priority among entire image areas of the sensor unit 120.

For example, the control unit 200 may restrict the light reception operation of the sensor unit 120 by stopping the output of the sensor unit 120 in the image area corresponding to the first area (the area including the passenger seat 1003). This restriction can be implemented, for example, by combining, in the configuration illustrated in FIG. 9, the control for each pixel row by the vertical drive circuit 1231 and the control for each column by the column signal processing unit 1232 or the output circuit 1234 to control the light reception operation by each pixel 1222 in the image area. As an example, the control unit 200 combines these controls to generate a control signal that performs a light reception operation in a predetermined rectangular region in the entire image area of the sensor unit 120 and stops the light reception operation in other regions.

Not limited to this, the control unit 200 may perform only the output control of the sensor unit 120 as the control of the light reception operation, output only the image data by the pixel signal of the rectangular region, without outputting the image data of other regions. Furthermore, the control unit 200 may allow the sensor unit 120 to perform a normal operation, and may suppress image processing on the image area in the processing in the signal processing unit 103. Furthermore, the control of the sensor unit 120 and the control of the signal processing unit 103 may be combined with each other.

By restricting the light reception operation in a partial area of the image area of the sensor unit 120, it is possible to suppress the current consumption in the sensor chip 1220, leading to suppression of heat generation. Furthermore, by controlling the sensor device 10 by such a control signal, the detection function by the sensor unit 120 is restricted.

In the next step S103, the control unit 200 transmits the control signal generated in step S102a to the sensor device 10. The sensor device 10 receives the control signal transmitted from the information processing device 20 by the communication I/F 105 and passes the control signal to the module control unit 101. The module control unit 101 controls the light reception operation of the sensor unit 120 in accordance with the transmitted control signal.

In the next step S104, based on the temperature information acquired by the temperature information acquisition unit 202, the determination unit 203 in the information processing device 20 determines whether the component temperature in the camera module 100c exceeds a second threshold (110° C. in this example).

When the determination unit 203 has determined that the component temperature is the second threshold or more (step S104, “Yes”), the control unit 200 stops the operation of the camera module 100c, for example, and ends the series of processing of the flowchart of FIG. 23. In contrast, when the determination unit 203 has determined that the component temperature is less than the second threshold (step S104, “No”), the control unit 200 proceeds to the processing of step S105.

In step S105, the determination unit 203 determines whether the component temperature in the camera module 100c is a third threshold (90° C. in this example) or less based on the temperature information acquired by the temperature information acquisition unit 202.

In step S105, when the determination unit 203 has determined that the component temperature is the third threshold or less (step S105, “Yes”), the control unit 200 proceeds to the processing of step S106a. In step S106a, the control unit 200 cancels the restriction of the light reception operation set in step S102a, and resumes the light reception operation by the pixels 1222 in the entire image areas in the sensor unit 120.

After the processing of step S106, the control unit 200 returns to the processing of step S100.

In contrast, when the determination unit 203 has determined that the component temperature exceeds the third threshold (step S105, “No”), the control unit 200 returns to the processing of step S101. In a case where the processing returns from step S105 to step S101 and the determination unit 203 has determined that the component temperature exceeds the first threshold, the control unit 200 tightens the restriction on the detection area in stages in the next steps S102 and S103 (specific examples will be described below).

With this operation, the current consumption in the sensor unit 120, which has been suppressed by the processing in steps S101 to S103 immediately before the processing is returned from step S105 to step S101, is further suppressed by the processing in and after step S105, leading to further suppression of the heat generation. At the same time, the image area restricted in the immediately preceding process is further restricted.

In this manner, in the third example of the first embodiment, the detection function of the sensor device 10 is restricted in accordance with the temperature of the camera module 100. At this time, in the third example of the first embodiment, restriction of the detection function is implemented by controlling the image area output from the sensor unit 120. This suppresses the current consumption of the sensor unit 120, leading to suppression of heat generation. Therefore, with application of the third example of the first embodiment, it is possible to guarantee the operation of the vehicle 1000 in the temperature range according to the operation guarantee standard without depending on the hardware heat dissipation measures.

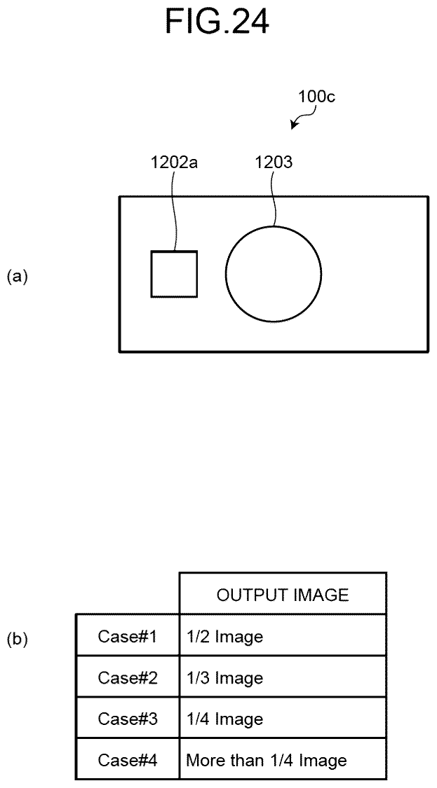

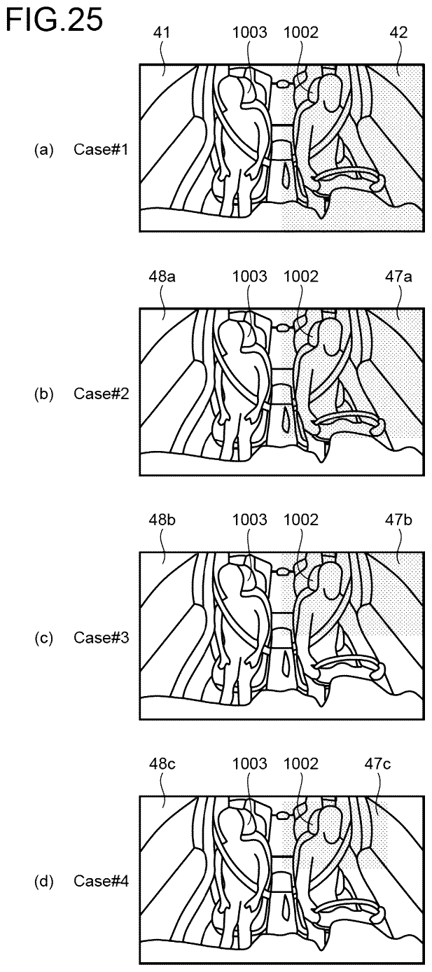

Output image area control in the camera module 100c with one lamp according to the third example of the first embodiment will be described with reference to FIGS. 24 and 25. FIG. 24 is a schematic diagram for illustrating light emission control in the camera module 100c with one lamp according to the third example of the first embodiment. Furthermore, FIG. 25 is a schematic diagram illustrating an example of image area control in the camera module 100c with one lamp according to the third example of the first embodiment.

In FIG. 24, section (a) is a diagram equivalent to section (a) in FIG. 5C, and illustrates an example of the arrangement of the light emission unit 110 (laser diode 1202a) and the lens 1203 in the camera module 100c.

In FIG. 24, section (b) illustrates an example of the output image area control related to the light reception operation restriction in the camera module 100c. In section (b), the Case #1 restricts the output image area to ½ of the entire image area. For example, as illustrated in section (a) of FIG. 25, the output image area in Case #1 is an area corresponding to the region 42 including the driver's seat 1002 in the image out of the regions 41 and 42 obtained by dividing the entire image area into two in the horizontal direction. On the other hand, image data is not output in the region 41 including the passenger seat 1003 in the image.

Case #2 restricts the output image area to ⅓ of the entire image area. For example, as illustrated in section (b) of FIG. 25, the output image area in Case #2 is an area including the driver's seat 1002 in the image, and is an area corresponding to a region 47a having an area equivalent to ⅓ of the entire image area. On the other hand, image data is not output in a region 48a other than the region 47a within the entire image area.

Case #3 restricts the output image area to ¼ of the entire image area. For example, as illustrated in section (c) of FIG. 25, the output image area in Case #3 is an area including the head and chest of the driver seated on the driver's seat 1002 in the image, and is an area corresponding to a region 47b having an area equivalent to ¼ of the entire image area. On the other hand, image data is not output in a region 48b other than the region 47b within the entire image area.

Case #4 restricts the output image area to an area smaller than ¼ of the entire image area. For example, as illustrated in section (d) of FIG. 25, the output image area in Case #4 is an area including the head of the driver seated on the driver's seat 1002 in the image, and is an area corresponding to a region 47c smaller than the above-described region 47b. On the other hand, image data is not output in a region 48c other than the region 47c within the entire image area.

### 3-4. Fourth Example of First Embodiment

Next, a fourth example of the first embodiment will be described. The fourth example of the first embodiment is an example in which the detection area is restricted and the amount of heat generation is suppressed in the camera module 100c with one lamp with one light emission unit 110, similarly to the above-described third example. Here, in the fourth example of the first embodiment, the detection area restriction is implemented by controlling the light emission operation by the light emission unit 110.

In the fourth example of the first embodiment, a VCSEL is used as one light emission unit 110 included in the camera module 100c, and turn-on of a plurality of light spots included in the VCSEL is independently controlled.

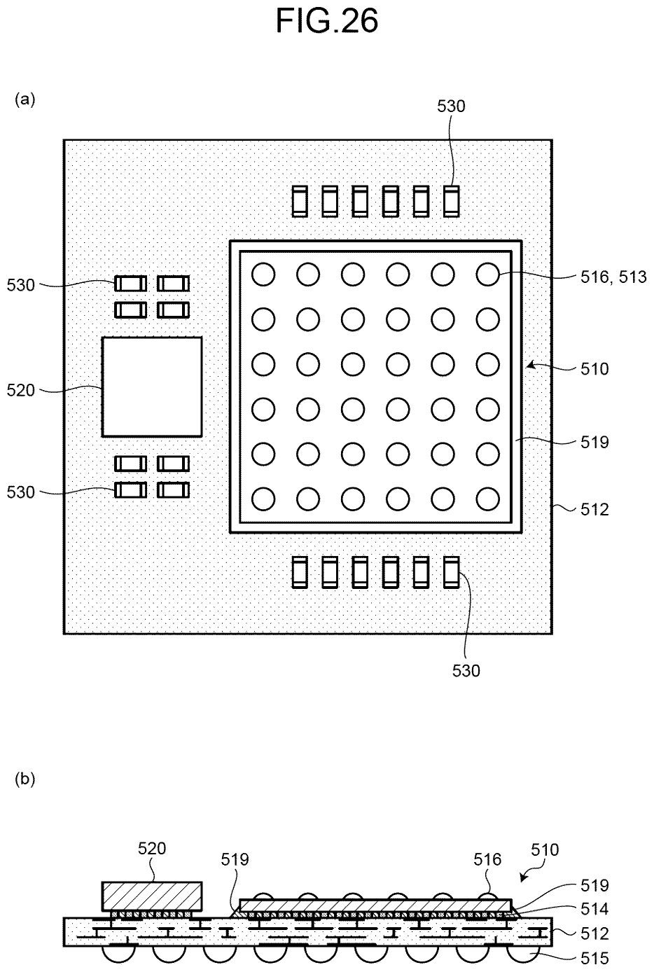

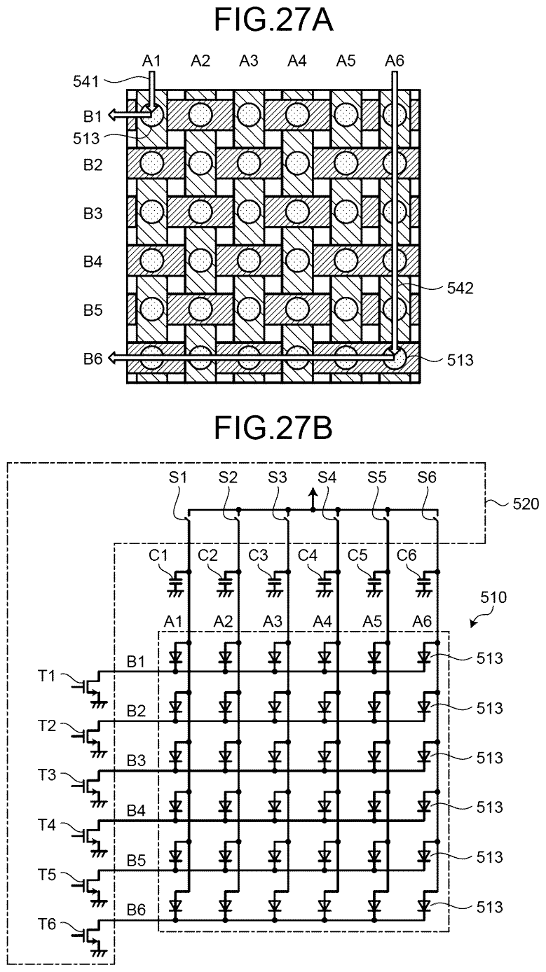

A configuration of the VCSEL applicable to the fourth example of the first embodiment will be described with reference to FIG. 26 as well as FIGS. 27A and 27B. FIG. 26 is a schematic diagram illustrating an example of a package structure of a device including a VCSEL applicable to a fourth example of the first embodiment. FIGS. 27A and 27B are schematic circuit diagrams of a package structure of a device including a VCSEL applicable to a fourth example of the first embodiment.

Here, the camera module including the VCSEL is implemented by applying the configuration of the camera module 100c with one lamp with one light emission unit 110 described with reference to FIG. 5C. That is, the laser diode 1202a illustrated in FIG. 5C corresponds to a VCSEL 510 illustrated in FIG. 26. The laser diode driver 1201a illustrated in FIG. 5C corresponds to a laser diode driver (LDD) 520 illustrated in FIG. 26.

In FIG. 26, the LDD 520 and the VCSEL 510 are arranged to face each other on one package as illustrated in a section (a) of FIG. 26. There is provided a capacitor element 530 disposed around the VCSEL 510. The VCSEL 510 has a configuration in which light emitting elements 513 that emit laser light are arranged in a lattice pattern (matrix pattern) on a substrate 512. The drawing illustrates an example in which a total of 36 light emitting elements 513 of six vertical and six horizontal light emitting elements are arranged in a matrix.

In addition, the entire upper surface of each light emitting element 513 is covered with a semi-insulating substrate (not illustrated). The light emitting surface of the VCSEL 510 has microlenses arranged in a matrix on the upper surface corresponding to the arrangement of each light emitting element 513, thereby constituting a microlens array (hereinafter referred to as MLA) 516 as a whole. This configuration makes it possible to expand the light emission area and widen an irradiation direction range of the VCSEL 510 by the action of the lens.

The MLA 516 transmits the laser light emitted from each light emitting element 513 and scans the target object Ob as the projection light Li via a scanning mechanism (not illustrated). The periphery of the VCSEL 510 is sealed by an underfill 519. The underfill 519 is a generic term for liquid curable resins used for sealing an integrated circuit.

Each light emitting element 513 disposed immediately below the MLA 516 of the VCSEL 510 is electrically connected to the substrate 512 by a connection electrode 514 as illustrated in the cross-sectional view of section (b) in FIG. 26. For example, the substrate 512 includes a wiring layer, and the light emitting element 513 is electrically connected to an external terminal 515 by the wiring layer.

Next, a circuit configuration of the light emitting element 513 which is a light spot in the VCSEL 510 will be described more specifically with reference to FIGS. 27A and 27B. The LDD 520 is disposed at a position facing the VCSEL 510. As illustrated in FIG. 3 to be described below, drive elements T1 to T6 built in the LDD 520 are electrically connected to the cathode of the light emitting element 513. On/off operations of the drive elements T1 to TE energize the corresponding light emitting element 513, enabling emission of laser light.

As illustrated in FIG. 27B, the anodes of the six light emitting elements 513 arranged in the vertical direction and having coordinates B1 to B6 are electrically connected in parallel. Similarly, as illustrated in FIGS. 27A and 27B, the cathodes of the six light emitting elements 513 arranged in the lateral direction and having coordinates A1 to A6 are electrically connected in parallel.

The anodes of the six light emitting elements 513 arranged in the longitudinal direction at the coordinates B1 to B6 are connected to one ends of switches S1 to S6 and the anodes of the capacitors C1 to C6, respectively, arranged at the coordinates A1 to A6. The cathodes of the capacitors C1 to C6 are connected to the ground. However, when nonpolar capacitor elements are used as the capacitors C1 to C6, the polarities such as anode or cathode are irrelevant. The other ends of the switches S1 to S6 are connected to a power supply circuit.

Here, the switches S1 to S6 are not limited to mechanical switches or a-contacts, and represent elements having an opening/closing function of a circuit including an electronic switch such as a transistor or a MOS FET. Each of the capacitors C1 to C6 does not correspond to one physical capacitor element 530, but means each functionality.

Therefore, the capacitors C1 to C6 may be formed of a plurality of capacitor elements 530, or may be formed to exhibit a predetermined functionality by combining the capacitor elements 530 having mutually different frequency characteristics. In addition, the shapes of the capacitor elements 530 are not limited to the shapes illustrated in FIG. 26, and capacitor elements of any shape can be included. The similar applies to the following embodiments, and thus detailed description in each embodiment will be omitted.

As described above, the cathodes of the six light emitting elements 513 arranged in the lateral direction are electrically connected in parallel and connected to drains of the driving elements (For example, a MOS FET) T1 to T6 built in the LDD 520. Sources of the drive elements T1 to T6 are connected to the ground.

Next, a sequence example of light emission of the light emitting element 513 of the VCSEL 510 will be described using the light emitting element 513 connected to the coordinates A1 and B1 with reference to FIGS. 27A and 27B.
(1) First, the switch S1 is turned on to charge the capacitor C1.
(2) Next, the drive element T1 is turned on.
(3) This allows the current to flow through the light emitting element 513 connected to the coordinates A1 and B1 to emit light.
(4) The drive element T1 is turned OFF. This stops current flow through the light emitting element 513, so as to stop light emission. In this case, the current takes a path of the coordinate A1, the light emitting element 513, and the coordinate B1 as indicated by an arrow 541 in FIG. 3A. Performing (2) to (4) on the desired light emitting element 513 in a state where the above-described (1) has been performed will enable individual light emission control.

In the configuration of FIG. 27B, since the capacitors C1 to C6 are provided for each drive circuit of the VCSEL 510, light emission of the light emitting element 513 is performed by electric charges stored in the capacitors C1 to C6, current supply from a power supply, or both. The capacitors C1 to C6 can reduce the output impedance of the power supply circuit and can instantaneously supply an inrush current necessary for light emission of the light emitting element 513. In addition, the light emitting elements 513 emit light sequentially in time division, making it possible to charge the battery before the next discharge after the previous discharge. This can shorten the rise/fall time of the drive waveform of the VCSEL 510, and improve a waveform distortion. In addition, it is possible to absorb noise entering the power supply system from the outside and spike noise generated when the circuit operates at a high speed, leading to improvement of the waveform and prevention of malfunction.

Next, the light emitting element 513 connected to the coordinates A6 and B6 will be described as an example.
(1) First, the switch S6 is turned on to charge the capacitor C6.
(2) Next, the drive element T6 is turned on.
(3) This allows the current to flow through the light emitting element 513 connected to the coordinates A6 and B6 to emit light.
(4) The drive element T6 is turned OFF. This stops current flow through the light emitting element 513, so as to stop light emission. In this case, the current takes a path of the coordinate A6, the light emitting element 513, and the coordinate B6 as indicated by an arrow 542 in FIG. 27A.

In this manner, the VCSEL 510 illustrated in FIG. 26 and FIGS. 27A and 27B enables individual light emission control of each light emitting element 513. Therefore, for example, by controlling each of the light emitting elements 513 including two regions obtained by dividing the light emitting surface of the VCSEL 510 into two in the horizontal direction for each region, it is possible to restrict the detection area as described with reference to FIGS. 17A and 17B or FIG. 20.

Similarly, for example, by controlling each of the light emitting elements 513 included in four regions obtained by dividing the light emitting surface of the VCSEL 510 into two in each of the horizontal direction and the vertical direction for each region, it is possible to perform detection area restriction as described with reference to FIGS. 19A and 19B or FIG. 22.

### 4. Modification of First Embodiment According to Present Disclosure

Next, a modification of the first embodiment of the present disclosure will be described. The first embodiment described above adopts the iToF sensor 1200 as a sensor that detects the reflected light Lr. In contrast, a modification of the first embodiment is an example of adopting an RGBIR sensor or an IR sensor using a sensor to detect the reflected light Lr.

The RGBIR sensor is a sensor having a filter that selectively transmits, for example, light in a red (R) wavelength region, light in a green (G) wavelength region, light in a blue (B) wavelength region, and light in an infrared (IR) wavelength region, and capable of detecting light in a visible light wavelength region and light in an infrared wavelength region. The IR sensor is, for example, a sensor that has a filter that selectively transmits light in an infrared (IR) wavelength region and is capable of detecting light in an infrared wavelength region.

### 4-0. Configuration Example of Sensor Device

A configuration of a sensor device 10 according to a modification of the first embodiment will be described.

### 4-0-1. Configuration Example of Camera Module

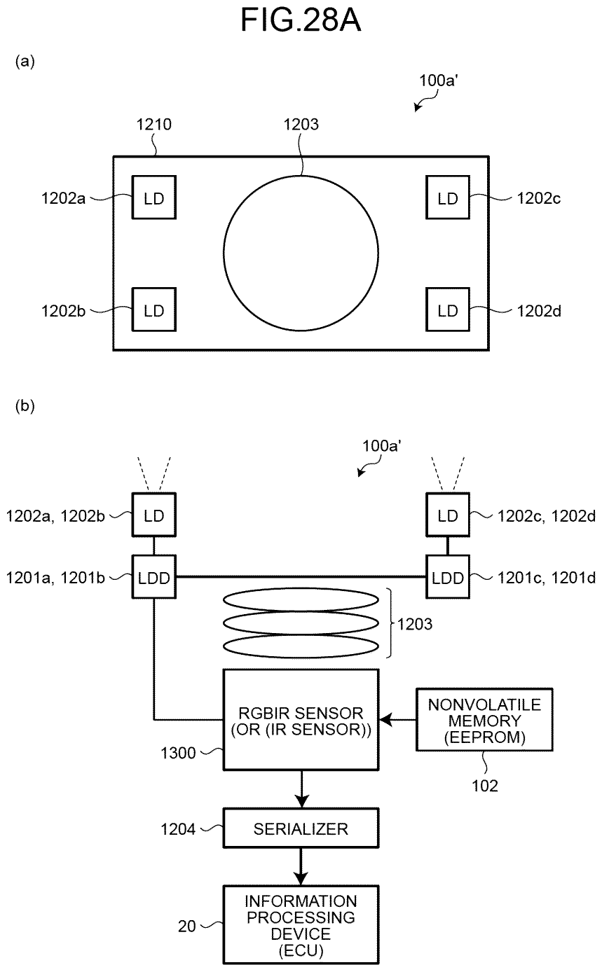

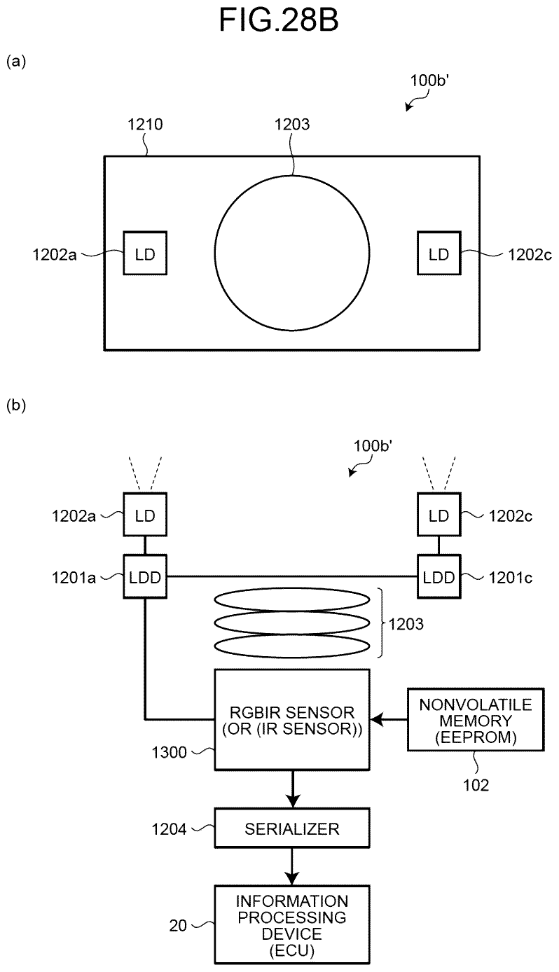

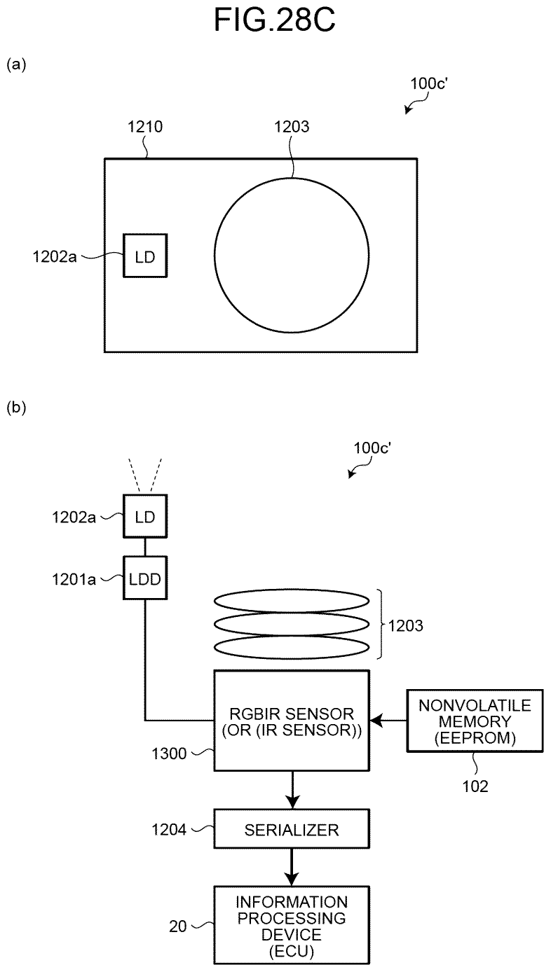

First, the configuration of the camera module 100 applicable to the modification of the first embodiment will be described more specifically with reference to FIGS. 28A to 28B.

FIG. 28A is a diagram illustrating a configuration example of a camera module 100a′ with four lamps having four light emission units 110 applicable to the modification of the embodiment. In FIG. 28A, section (a) is a diagram of the camera module 100a′ as viewed from the light emitting/light receiving surface side, and section (b) is a block diagram illustrating a configuration example of the camera module 100a′.

The configuration of the camera module 100a′ illustrated in section (a) of FIG. 28A when viewed from the light emitting/light receiving surface is similar to the configuration described using section (a) of FIG. 5A, and thus the description thereof is omitted here.

The camera module 100a′ illustrated in section (b) of FIG. 28A has a configuration in which the iToF sensor 1200 is replaced with an RGBIR sensor 1300, in contrast to the configuration of the camera module 100a described using section (b) of FIG. 5A. Not limited thereto, and an IR sensor may be used instead of the RGBIR sensor 1300. The RGBIR sensor 1300 corresponds to a configuration including: a sensor unit 120a (described below) that outputs a pixel signal corresponding to at least light in an infrared wavelength region; a module control unit 101 in FIG. 4; a signal processing unit 103; memory 140; and a temperature sensor 130.

Since the configuration of the camera module 100a described with reference to section (b) in FIG. 5A is applicable to the configuration other than the RGBIR sensor 1300 of the camera module 100a′, the description thereof is omitted here.

FIG. 28B is a diagram illustrating a configuration example of a camera module 100b′ with two lamps having two light emission units 110 applicable to a modification of the embodiment. In FIG. 28B, section (a) is a diagram of the camera module 100b′ as viewed from the light emitting/light receiving surface side, and section (b) is a block diagram illustrating a configuration example of the camera module 100b′.

The configuration of the camera module 100b′ illustrated in section (a) of FIG. 28B when viewed from the light emitting/light receiving surface is similar to the configuration described using section (a) of FIG. 5A, and thus the description thereof is omitted here.

The camera module 100b′ illustrated in section (b) of FIG. 28B has a configuration in which the iToF sensor 1200 is replaced with the RGBIR sensor 1300, in contrast to the configuration of the camera module 100b′ described using section (b) of FIG. 5B. Not limited thereto, and an IR sensor may be used instead of the RGBIR sensor 1300. Since the configuration of the camera module 100b described with reference to section (b) in FIG. 5B is applicable to the configuration other than the RGBIR sensor 1300 of the camera module 100b′, the description thereof is omitted here.

FIG. 28C is a diagram illustrating a configuration example of a camera module 100c′ with one lamp with one light emission unit 110 applicable to the modification of the embodiment. In FIG. 28C, section (a) is a diagram of the camera module 100c′ as viewed from the light emitting/light receiving surface side, and section (b) is a block diagram illustrating a configuration example of the camera module 100c′.

The configuration of the camera module 100c′ illustrated in section (a) of FIG. 28C when viewed from the light emitting/light receiving surface is similar to the configuration described using section (a) of FIG. 5C, and thus the description thereof is omitted here.

The camera module 100c′ illustrated in section (b) of FIG. 28C has a configuration in which the iToF sensor 1200 is replaced with the RGBIR sensor 1300, in contrast to the configuration of the camera module 100c′ described using section (b) of FIG. 5C. Not limited thereto, and an IR sensor may be used instead of the RGBIR sensor 1300. Since the configuration of the camera module 100c described with reference to section (b) in FIG. 5C is applicable to the configuration other than the RGBIR sensor 1300 of the camera module 100c′, the description thereof is omitted here.

### 4-0-2. Sensor Configuration Example

Next, a configuration example of the sensor unit 120a applicable to the modification of the first embodiment will be described.

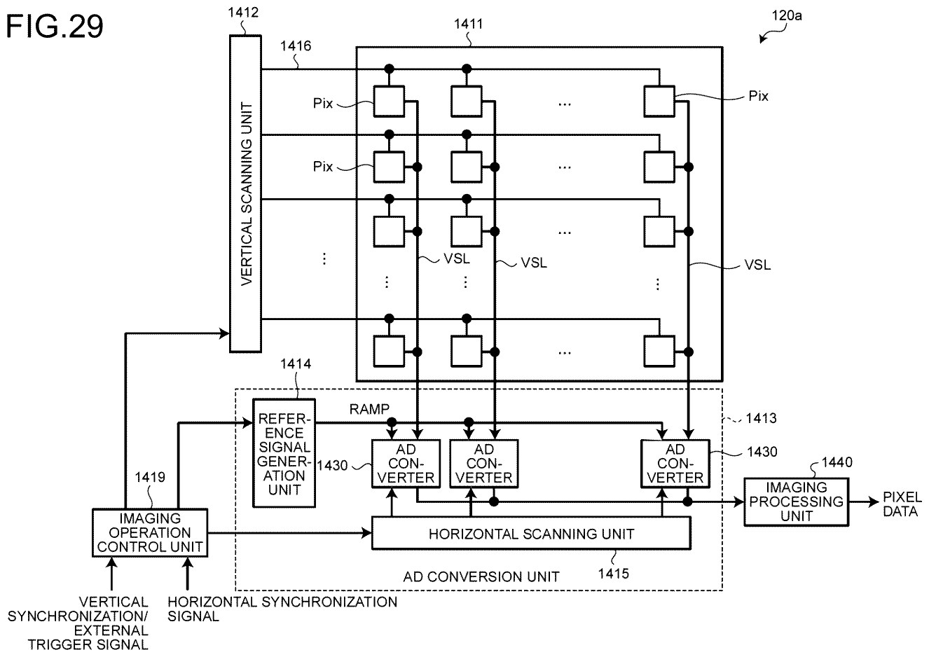

FIG. 29 is a block diagram illustrating a configuration of an example of the sensor unit 120a applicable to the modification of the embodiment in more detail. In FIG. 29, the sensor unit 120a includes a pixel array unit 1411, a vertical scanning unit 1412, an Analog to Digital (AD) conversion unit 1413, a pixel signal line 1416, a vertical signal line 1417, an imaging operation control unit 1419, and an imaging processing unit 1440.

The pixel array unit 1411 includes a plurality of pixels Pix each having a photoelectric conversion element that performs photoelectric conversion on a received beam of light. The photoelectric conversion element can be implemented by using a photodiode. In the pixel array unit 1411, the plurality of pixels Pix is arranged in a two-dimensional lattice pattern in the horizontal direction (row direction) and the vertical direction (column direction). In the pixel array unit 1411, the arrangement of the pixels Pix in the row direction is referred to as a line. The pixel signals read from a predetermined number of lines in the pixel array unit 1411 will form a one-frame image (image data). For example, in a case where a one-frame image is formed with 3000 pixels×2000 lines, the pixel array unit 1411 includes at least 2000 lines, each including at least 3000 pixels Pix.

Furthermore, in the pixel array unit 1411, a rectangular region including the pixels Pix that output effective pixel signals for forming image data is referred to as an effective pixel region. The one-frame image is formed based on the pixel signals of the pixel Pix in the effective pixel region.

Furthermore, regarding the connection to the pixel array unit 1411, the pixel signal line 1416 is connected for each row of each pixel Pix while the vertical signal line 1417 is connected for each column of each pixel Pix.

An end of the pixel signal line 1416, the end being an end not connected to the pixel array unit 1411, is connected to the vertical scanning unit 1412. The vertical scanning unit 1412 transmits a control signal such as a drive pulse at the time of reading a pixel signal from the pixel Pix to the pixel array unit 1411 via the pixel signal line 1416 under the control of the imaging operation control unit 1419 described below. An end of the vertical signal line 1417, the end being an end not connected to the pixel array unit 1411, is connected to the AD conversion unit 1413. The pixel signal read from the pixel is transmitted to the AD conversion unit 1413 via the vertical signal line 1417.

Reading control of a pixel signal from a pixel will be schematically described. Reading of the pixel signal from the pixel is performed by transferring charges accumulated in the photoelectric conversion element by exposure to a Floating Diffusion (FD) layer and converting the transferred charges into a voltage in the floating diffusion layer. The voltage obtained by converting the charge in the floating diffusion layer is output to the vertical signal line 1417 via an amplifier.

More specifically, the connection between the photoelectric conversion element and the floating diffusion layer in the pixel Pix, during exposure, is turned off (open), and charges generated in accordance with light incident by photoelectric conversion are accumulated in the photoelectric conversion element. After completion of exposure, the floating diffusion layer and the vertical signal line 1417 are connected in accordance with a selection signal supplied via the pixel signal line 1416. Furthermore, the floating diffusion layer is connected to a supply line of a power supply voltage VDD or a black level voltage for a short period of time in accordance with a reset pulse supplied via the pixel signal line 1416, so as to reset the floating diffusion layer. A voltage (referred to as a voltage P) of a reset level of the floating diffusion layer is output to the vertical signal line 1417. Thereafter, the connection between the photoelectric conversion element and the floating diffusion layer is turned on (closed) by a transfer pulse supplied via the pixel signal line 1416, allowing the charge accumulated in the photoelectric conversion element to be transferred to the floating diffusion layer. A voltage (referred to as a voltage Q) corresponding to the charge amount of the floating diffusion layer is output to the vertical signal line 1417.

The AD conversion unit 1413 includes an AD converter 1430 provided for each vertical signal line 1417, a reference signal generation unit 1414, and a horizontal scanning unit 1415. The AD converter 1430 is a column AD converter that performs AD conversion processing on each column of the pixel array unit 1411. The AD converter 1430 performs AD conversion processing on the pixel signal supplied from the pixel Pix via the vertical signal line 1417, and generates two digital values (values respectively corresponding to the voltage P and the voltage Q) for Correlated Double Sampling (CDS) processing for noise reduction.

The AD converter 1430 supplies the generated two digital values to the imaging processing unit 112. The imaging processing unit 112 performs CDS processing based on the two digital values supplied from the AD converter 1430, and generates a pixel signal (pixel data) by a digital signal. The pixel data generated by the imaging processing unit 112 is output to the outside of the sensor unit 120a. Pixel data for one frame output from the imaging processing unit 112 is supplied to the output control unit 113 and the image compressor 125, for example, as image data.

Based on the ADC control signal input from the imaging operation control unit 1419, the reference signal generation unit 1414 generates a ramp signal PAMP used by each AD converter 1430 to convert a pixel signal into two digital values. The ramp signal RAMP is a signal whose level (voltage value) decreases at a constant slope with respect to time, or a signal whose level decreases stepwise. The reference signal generation unit 1414 supplies the generated ramp signal RAMP to each AD converter 1430. The reference signal generation unit 1414 includes, for example, a Digital-to-Analog (DA) conversion circuit or the like.

Under the control of the imaging operation control unit 1419, the horizontal scanning unit 1415 performs selective scanning of selecting each AD converter 1430 in a predetermined order, thereby sequentially outputting each digital value temporarily held by each AD converter 1430 to the imaging processing unit 112. The horizontal scanning unit 1415 includes, for example, a shift register, an address decoder, and the like.

The imaging operation control unit 1419 performs drive control of the vertical scanning unit 1412, the AD conversion unit 1413, the reference signal generation unit 1414, the horizontal scanning unit 1415, and the like. The imaging operation control unit 1419 generates various drive signals to be references for operations of the vertical scanning unit 1412, the AD conversion unit 1413, the reference signal generation unit 1414, and the horizontal scanning unit 1415. The imaging operation control unit 1419 generates a control signal for the vertical scanning unit 1412 to supply to each pixel Pix via the pixel signal line 1416 based on a vertical synchronization signal or an external trigger signal supplied from the outside (for example, a sensor control unit 121) and a horizontal synchronization signal. The imaging operation control unit 1419 supplies the generated control signal to the vertical scanning unit 1412.

Based on the control signal supplied from the imaging operation control unit 1419, the vertical scanning unit 1412 supplies various signals including the drive pulse to the pixel signal line 1416 of the selected pixel row of the pixel array unit 1411 to each pixel Pix for each line, so as to allow each pixel Pix to output the pixel signal to the vertical signal line 1417. The vertical scanning unit 1412 includes, for example, a shift register, an address decoder, and the like.

The sensor unit 120a configured as described above includes a column AD type Complementary Metal Oxide Semiconductor (CMOS) image sensor in which the AD converter 1430 is disposed for each column.

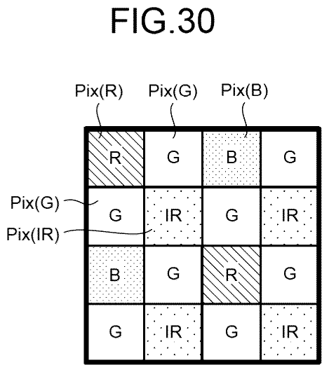

FIG. 30 is a schematic diagram illustrating an example of an array (referred to as an RGBIR array) of each color filter including an IR filter. In this example, 16 pixels of 4 pixels×4 pixels are set as a unit of the array. Two pixels Pix (R) and two pixels Pix (B), eight pixels Pix (G), and four pixels Pix (IR) each having an IR filter are included in the array, with the pixels Pix arranged so as not to allow the pixels Pix having filters that transmit light in the same wavelength band to be adjacent to each other.

In a case where an IR sensor is used instead of the RGBIR sensor 1300, for example, an IR filter is applied to all the pixels Pix.

### 4-1. First Example of Modification of First Embodiment

First, a first example of the modification of the first embodiment will be described. The first example of the modification of the first embodiment corresponds to the first example of the first embodiment described above and is an example of restricting the power of the projection light Li for each area included in the detection area of the sensor device 10, in accordance with the priority of each area, when the temperature of the camera module 100 reaches a certain temperature.

The flow of the light emission control processing in the first example of the modification of the first embodiment is the same as the flow described with reference to the flowchart of FIG. 15 in the first example of the first embodiment, and thus the description thereof will be omitted here. In addition, the light emission control and the irradiation state by each light emission unit 110 are the same as those described with reference to FIGS. 17A and 17B in the case of using the camera module 100b′ with two lamps and FIGS. 19A and 19B in the case of using the camera module 100a′ with four lamps in the first example of the first embodiment, and thus the description thereof is omitted here.

Hereinafter, a case of the camera module 100b′ with two lamps will be described as an example.

In the first example of the modification of the first embodiment, a drive signal driving each light emission unit 110 is different from that of the first example of the first embodiment described above.

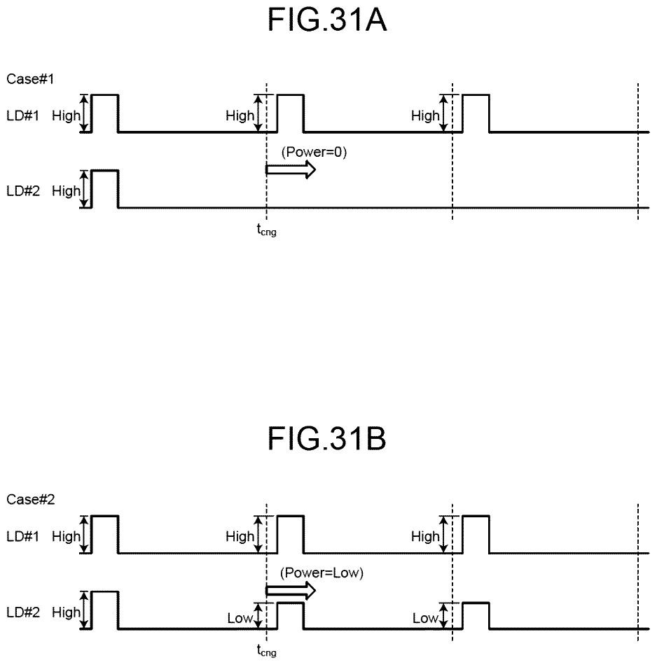

FIGS. 31A and 31B are schematic diagrams each illustrating an example of the drive signal driving the light emission unit 110 according to the first example of the modification of the first embodiment. In FIGS. 31A and 31B, time is indicated in the horizontal direction, and drive power is indicated in the vertical direction.

FIG. 31A corresponds to Case #1 in section (b) in FIG. 17A in the first example of the first embodiment, and illustrates an example of a drive signal in a case where light emission is stopped in accordance with the priority. In FIG. 31A, the light emission unit 110 emits light with a duty of 100%, for example, in one light emission period, and one session of imaging is performed to acquire one captured image for each light emission by a drive signal in one light emission period.

It is assumed that the detection area is restricted at time tog by the processing of steps S101 to S103 in the flowchart of FIG. 15 described above. In this case, at the time t_{cng}, the control unit 200 switches the drive power supplied to the light emission unit LD #2 having a detection area including the passenger seat 1003 side as the irradiation target, from the drive power High to zero (0) (Power=0). In contrast, the control unit 200 drives the light emission unit LD #1 whose irradiation target is the detection area including the driver's seat 1002 side at the drive power High even after time t_{cng}.

FIG. 31B corresponds to Case #2 in section (b) in FIG. 17A in the first example of the first embodiment, and illustrates an example of a drive signal in a case of controlling the drive power in accordance with priority. The meaning of each part in the drawings is similar to the case of FIG. 31A described above, and thus the description thereof will be omitted here.

It is assumed that the detection area is restricted at time t_{cng} by the processing of steps S101 to S103 in the flowchart of FIG. 15 described above. In this case, the control unit 200 switches the drive power supplied to the light emission unit LD #2 from the drive power High to the drive power Low at the time t_{cng}. In contrast, the control unit 200 drives the light emission unit LD #1 with the drive power High even after the time t_{cng}.

In this manner, in the first example of the modification of the first embodiment, similarly to the first example of the first embodiment, the drive power for driving the light emission unit 110 is controlled in accordance with the temperature of the camera module 100. This suppresses the current consumption of the laser diode driver (control unit 200) that supplies drive power to the light emission unit 110, enabling suppression of heat generation.

### 4-2. Second Example of Modification of First Embodiment

Next, a second example of the modification of the first embodiment will be described. The second example of the modification of the first embodiment is an example in which the detection area restriction in steps S102 and S103 in the flowchart of FIG. 15 is performed by controlling the light emission time by the light emission unit 110.

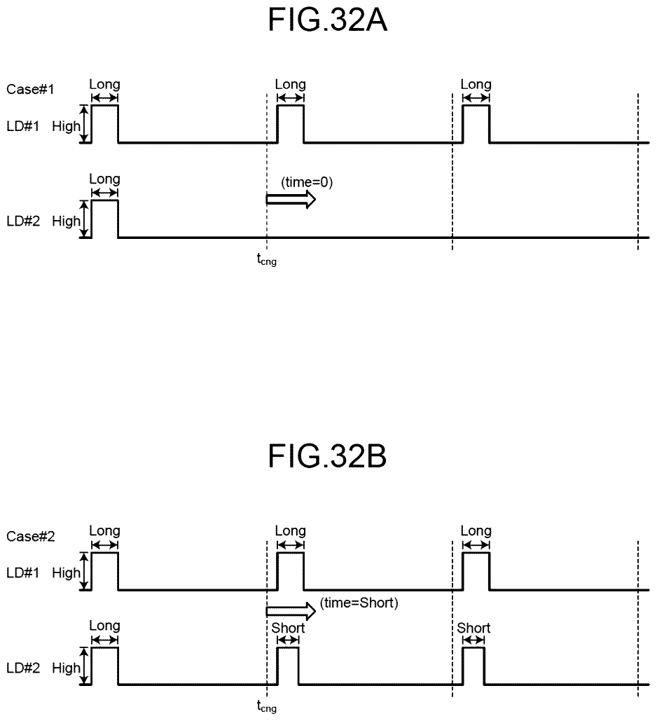

FIGS. 32A and 32B are schematic diagrams each illustrating an example of the drive signal driving the light emission unit 110 according to the second example of the modification of the first embodiment. In FIGS. 32A and 32B, time is indicated in the horizontal direction, and drive power is indicated in the vertical direction. In addition, here, for the sake of explanation, it is assumed that the light emission time Long is 300 microseconds (μs) and the light emission time Short is 200 μs.

FIG. 32A corresponds to Case #1 in section (b) in FIG. 20A in the second example of the first embodiment, and illustrates an example of a drive signal in a case where light emission is stopped in accordance with the priority, that is, the light emission time is set to zero (0). In FIG. 32A, the light emission unit 110 emits light with a duty of 100% in one light emission period, and one session of imaging is performed to acquire one captured image for each light emission by a drive signal in one light emission period.

It is assumed that the detection area is restricted at time t_{cng} by the processing of steps S101 to S103 in the flowchart of FIG. 15 described above. In this case, the control unit 200 sets the light emission time of the light emission unit LD #2 to zero (0) (time=0) at the time t_{cng}. In contrast, the control unit 200 drives the light emission unit LD #1 with the light emission time Long even after the time t_{cng}.

FIG. 32B corresponds to Case #2 in section (b) in FIG. 20A, and illustrates an example of a drive signal in a case where drive power is controlled in accordance with priority. The meaning of each part in the drawings is similar to the case of FIG. 32A described above, and thus the description thereof will be omitted here.

It is assumed that the detection area is restricted at time t_{cng} by the processing of steps S101 to S103 in the flowchart of FIG. 15 described above. In this case, the control unit 200 switches the light emission time of the light emission unit LD #2 from the light emission time Long to the light emission time Short at the time t_{cng}. In contrast, the control unit 200 drives the light emission unit LD #1 with the drive power High even after the time t_{cng}.

In this manner, in the second example of the modification of the first embodiment, the light emission time of the light emission unit 110 is controlled in accordance with the temperature of the camera module 100, similarly to the second example of the first embodiment. This suppresses the current consumption of the laser diode driver (control unit 200) that supplies drive power to the light emission unit 110, enabling suppression of heat generation.

In the above description, the light emission time Long is 300 μs and the light emission time Short is 200 μs, but the time length is not limited to these examples. That is, the lengths of the light emission times Long and Short are appropriately set in accordance with the application. As an example, depending on the application, the light emission time Long may be 3 milliseconds (ms), the light emission time Short may be 2 ms.

In addition, the light emission timing illustrated in FIGS. 31A, 31B, 32 A, and 32B is set to a head portion of the frame period of the image data output from the sensor unit 120a, but the timing is not limited to this example. For example, the light emission timing may be a central portion or a rear end portion of the frame period, or light may be emitted a plurality of times during one frame period depending on the application.

Furthermore, in the above description, a laser diode is used as the light emitting element of the light emission unit 110, but the element is not limited to this example. For example, a Light Emitting Diode (LED) may be used as the light emitting element of the light emission unit 110, or another light emitting element capable of emitting light in an equivalent wavelength region may be used.

### 4-3. Third Example of Modification of First Embodiment

Next, a third example of the modification of the first embodiment will be described. Similarly to the above-described third example of the modification of the first embodiment, the third example of the modification of the first embodiment is an example in which the light reception operation of the sensor unit 120 is controlled to restrict the detection area so as to suppress heat generation in the camera module 100c′ with one lamp with one light emission unit 110. Since the flow of processing in the third example of the modification of the first embodiment is similar to the flow of processing according to the flowchart of FIG. 23 according to the third example of the first embodiment, the description thereof will be omitted here.

Also in this case, similarly to the third example of the first embodiment described above, in step S102a in the flowchart of FIG. 23, the output image area in which the sensor unit 120 outputs the image data is set to be restricted in accordance with the priority set for each area in the image area, thereby restricting the light reception operation.

For example, the control unit 200 may restrict the light reception operation of the sensor unit 120 by stopping the output of the sensor unit 120a in the image area corresponding to the first area (the area including the passenger seat 1003). This restriction can be implemented, for example, by combining, in the configuration illustrated in FIG. 29, the control for each pixel row by the vertical scanning unit 1412 and the control for each column by the AD conversion unit 1413 to control the light reception operation by each pixel Pix in the image area.

Not limited to this, the control unit 200 may perform only the output control of the sensor unit 120a as the control of the light reception operation, output only the image data by the pixel signal of a predetermined rectangular region, without outputting the image data of other regions. Furthermore, the control unit 200 may allow the sensor unit 120a to perform a normal operation, and may suppress image processing on the image area in the processing in the signal processing unit 103. Furthermore, the control of the sensor unit 120a and the control of the signal processing unit 103 may be combined with each other.

By restricting the light reception operation in a partial area of the image area of the sensor unit 120a, it is possible to suppress the current consumption in the sensor chip 1220, leading to suppression of heat generation. Furthermore, by controlling the sensor device 10 by such a control signal, the detection function by the sensor unit 120a is restricted.

### 4-4. Fourth Example of Modification of First Embodiment

Next, a fourth example of the modification of the first embodiment will be described. The fourth example of the modification of the first embodiment is an example in which the detection area is restricted and the amount of heat generation is suppressed in the camera module 100c′ with one lamp with one light emission unit 110, similarly to the above-described third example of the modification of the first embodiment. Here, in the fourth example of the modification of the first embodiment, the detection area restriction is implemented by controlling the light emission operation by the light emission unit 110.

In the fourth example of the modification of the first embodiment, a VCSEL is used as one light emission unit 110 included in the camera module 100c, and turn-on of a plurality of light spots included in the VCSEL is independently controlled. Since the control of the light emission unit 110 according to the fourth example of the modification of the first embodiment is similar to that of the fourth example of the first embodiment described above, the description thereof will be omitted here.

### 5. Second Embodiment According to Present Disclosure

Next, a second embodiment according to the present disclosure will be described. The second embodiment is an example in which the frame rate of the sensor operation of the sensor unit 120 is restricted in accordance with the temperature of the camera module.

Here, for example, the information processing device 20 can execute processing such as skeleton estimation, gesture recognition, gaze tracking, and face authentication using the detection output from the sensor device 10. The frame rate required for the detection output from the sensor device 10 may be different in each processing. In the second embodiment, the information processing device 20 may stop the processing that requires the detection output at the restricted frame rate in accordance with the restriction of the frame rate described above.

The second embodiment is applicable to any of the configurations of the camera modules 100a, 100b, and 100c using the iToF sensor 1200 described with reference to FIGS. 5A to 5C, and the camera modules 100a′, 100b′, and 100c′ using the RGBIR sensor 1300 described with reference to FIGS. 28A to 28C.

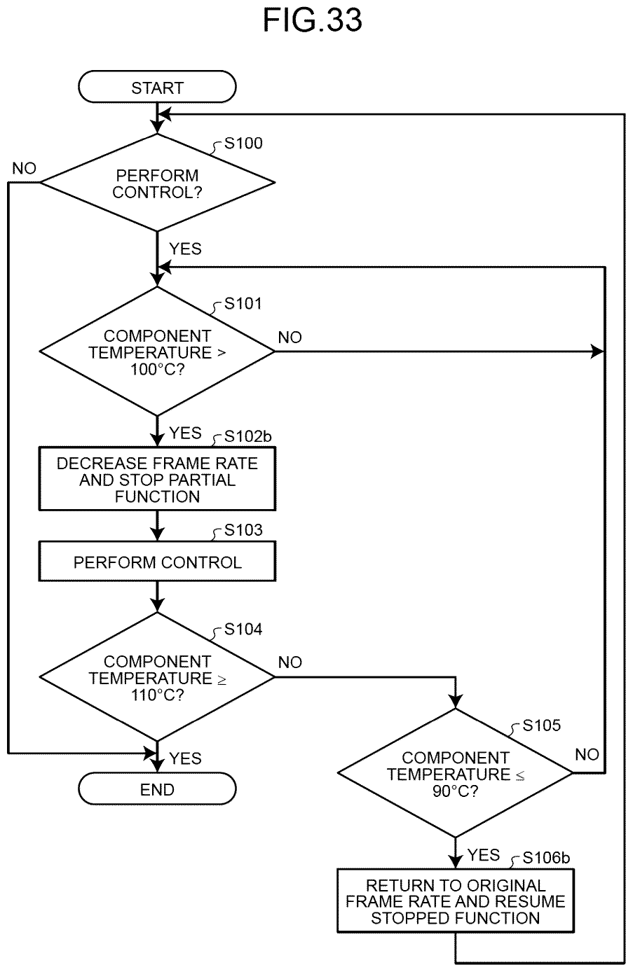

FIG. 33 is a flowchart illustrating an example of processing according to a second embodiment. The following will appropriately omit detailed description of processing corresponding to the processing of the flowchart of FIG. 15 described above.

As a precondition for the processing of the flowchart of FIG. 33, it is assumed that the sensor unit 120 of the camera module 100 performs the light reception operation in the image area by all the pixels 1222 included in the effective pixel region in the pixel area 1221, and outputs a distance image. In addition, it is assumed that the information processing device 20 has executed all of a plurality of types of processing using the detection output from the sensor device 10.

In step S100, the control unit 200 in the information processing device 20 determines whether to control the light reception operation. When having determined not to perform the control of the light reception operation (step S100, “No”), the control unit 200 ends a series of processing of the flowchart of FIG. 33.

In contrast, when having determined to perform the control of the light reception operation (step S100, “Yes”), the control unit 200 proceeds to the processing of step S101.

In step S101, the determination unit 203 in the information processing device 20 determines whether the component temperature in the camera module 100 exceeds a first threshold (100° C. in this example) based on the temperature information acquired by the temperature information acquisition unit 202.

When the determination unit 203 has determined that the component temperature the first threshold or less (step S101, “No”), the control unit 200 returns to the processing of step S101. In contrast, when the determination unit 203 has determined that the component temperature exceeds the first threshold (step S101, “Yes”), the control unit 200 proceeds to the processing of step S102b.

In step S102b, the control unit 200 restricts the frame rate of the detection output from the sensor unit 120 in the light reception operation of the sensor device 10. For example, in step S102b, the control unit 200 generates a control signal of stopping the detection output at the highest frame rate among the detection outputs at the plurality of frame rates output by the sensor unit 120. For example, the sensor unit 120 may implement the restriction of the frame rate of the detection output by controlling the timing control circuit 1233 in accordance with the control signal.

At the same time, in step S102b, the control unit 200 stops the processing that requires the restricted frame rate among the processing executed in the information processing device 20. For example, the control unit 200 instructs the analysis unit 204 to stop the processing.

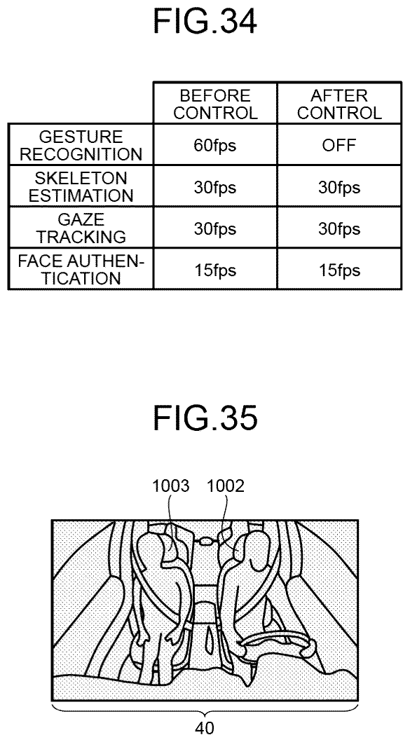

FIG. 34 is a schematic diagram illustrating an example of frame rate restriction applicable to the second embodiment. FIG. 34 illustrate various types of processing executed by the information processing device 20 using the detection result by the sensor device 10, specifically, gesture recognition processing, skeleton estimation processing, gaze tracking processing, and face authentication processing. In the example of FIG. 34, various types of processing including the gesture recognition, skeleton estimation, gaze tracking, and face authentication need frame rates of, for example, 60 fps (frame per second), 30 fps, 30 fps, and 15 fps, respectively.

For example, the sensor unit 120 outputs a distance image, which is a detection output, at a frame rate of 60 fps. For example, the analysis unit 204 of the information processing device 20 may execute the gesture recognition processing using all distance images output from the sensor unit 120 at a frame rate of 60 fps. In addition, the analysis unit 204 may perform each processing of skeleton estimation and gaze tracking at a frame rate of 60 fps by using a distance image output from the sensor unit 120, every two frames. Furthermore, the analysis unit 204 may execute the face recognition processing at a frame rate of 60 fps by using the distance image output from the sensor unit 120, every four frames.

In this example, using the processing in step S102b, the control unit 200 generates a control signal of restricting the fastest frame rate of 60 fps among the various frame rates. Furthermore, the control unit 200 instructs the analysis unit 204 to stop the gesture recognition processing that required the frame rate.

By restricting the frame rate of the detection output by the sensor unit 120, it is possible to suppress the current consumption in the sensor chip 1220, leading to suppress of heat generation. Furthermore, by controlling the sensor device 10 by such a control signal, the detection function by the sensor unit 120 is restricted.

In the second embodiment, even when the restriction of the frame rate and the stop of the predetermined processing in the information processing device 20 have been executed in step S102b, the entire detection area indicated as the region 40 in FIG. 35 is set as the detection output target.

In the next step S103, the control unit 200 transmits the control signal generated in step S102b to the sensor device 10. The sensor device 10 receives the control signal transmitted from the information processing device 20 by the communication I/F 105 and passes the control signal to the module control unit 101. The module control unit 101 controls the light reception operation of the sensor unit 120 in accordance with the transmitted control signal.

In the next step S104, based on the temperature information acquired by the temperature information acquisition unit 202, the determination unit 203 in the information processing device 20 determines whether the component temperature in the camera module 100c exceeds a second threshold (110° C. in this example).

When the determination unit 203 has determined that the component temperature is the second threshold or more (step S104, “Yes”), the control unit 200 stops the operation of the camera module 100c, for example, and ends the series of processing of the flowchart of FIG. 33. In contrast, when the determination unit 203 has determined that the component temperature is less than the second threshold (step S104, “No”), the control unit 200 proceeds to the processing of step S105.

In step S105, the determination unit 203 determines whether the component temperature in the camera module 100c is a third threshold (90° C. in this example) or less based on the temperature information acquired by the temperature information acquisition unit 202.

In step S105, when the determination unit 203 has determined that the component temperature is the third threshold or less (step S105, “Yes”), the control unit 200 proceeds to the processing of step S106b. In step S106b, the control unit 200 returns the frame rate restricted in step S102b to the original frame rate and resumes the function stopped in the information processing device 20.

After the processing of step S106b, the control unit 200 returns to the processing of step S100.

In contrast, when the determination unit 203 has determined that the component temperature exceeds the third threshold (step S105, “No”), the control unit 200 returns to the processing of step S101. In a case where the processing returns from step S105 to step S101 and the determination unit 203 has determined that the component temperature exceeds the first threshold, the control unit 200 may tighten the restriction on the frame rate in stages in the next steps S102b and S103. Along with this, the control unit 200 may stop the processing in the information processing device 20 using the detection output at the restricted frame rate.

For example, referring to FIG. 34 described above, the control unit 200 performs the processing in step S102b after the processing in step S105 to generate a control signal restricting the second fastest frame rate of 30 fps among the various frame rates. Furthermore, the control unit 200 instructs the analysis unit 204 to stop each processing of skeleton estimation and gaze tracking for which the frame rate is required. That is, in this case, among the various processing illustrated in FIG. 34, the processing of the gesture recognition, the skeleton estimation, and the gaze tracking are to be stopped.

With this operation, the current consumption in the sensor unit 120, which has been suppressed by the processing in steps S101 to S103 immediately before the processing is returned from step S105 to step S101, is further suppressed by the processing in and after step S105, leading to further suppression of the heat generation. At the same time, the frame rate restricted in the immediately preceding processing is further restricted, and the processing corresponding to the restricted frame rate in the information processing device 20 is to be stopped.

In this manner, in the second embodiment, the detection function of the sensor device 10 is restricted in accordance with the temperature of the camera module 100. At this time, in the second embodiment, the detection function is restricted by controlling the frame rate of the detection output that is output from the sensor unit 120. This suppresses the current consumption of the sensor unit 120, leading to suppression of heat generation. Therefore, with application of the third example of the first embodiment, it is possible to guarantee the operation of the vehicle 1000 in the temperature range according to the operation guarantee standard without depending on the hardware heat dissipation measures.

### 6. Third Embodiment According to Present Disclosure

Next, a third embodiment according to the present disclosure will be described. The third embodiment is an example of combining each example of the first embodiment or each example of the modification of the first embodiment described above and the second embodiment so as to restrict the detection function in the sensor device 10 to suppress power consumption, and thereby suppressing heat generation in the sensor device 10.

### 6-1. First Example of Third Embodiment

First, a first example of the third embodiment will be described. The first example of the third embodiment is an example of combining the restriction of the frame rate according to the second embodiment and the restriction according to the priority of the detection area according to the first, second, or fourth example of the modification of the first embodiment.

The first example of the third embodiment is applicable to any of the configurations of the camera modules 100a and 100b using the iToF sensor 1200 described with reference to FIGS. 5A and 5B, and the camera modules 100a′ and 100b′ using the RGBIR sensor 1300 described with reference to FIGS. 28A and 28B. The first example of the third embodiment is also applicable to the camera module with one lamp according to the first embodiment and the fourth example of the modification of the first embodiment.

Hereinafter, unless otherwise specified, the camera modules 100a, 100b, 100a′, and 100b′ and the camera module with one lamp according to the first embodiment and the fourth example of the modification of the first embodiment will be described as the camera module 100 as a representative.

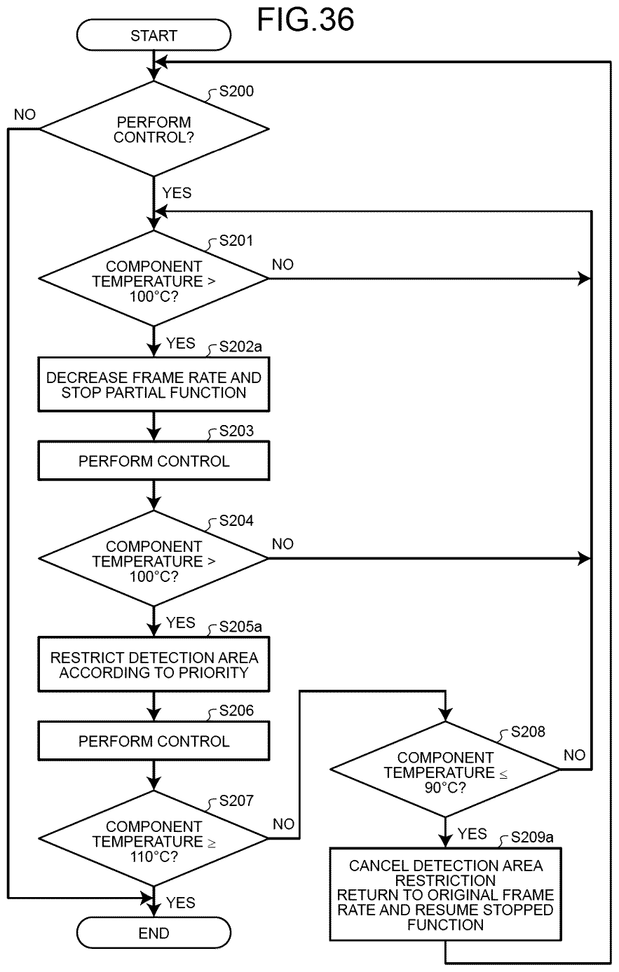

FIG. 36 is a flowchart illustrating an example of processing according to a first example of the third embodiment. The following will appropriately omit detailed description of processing corresponding to the processing of the flowchart of FIG. 15 described above.

As a precondition for the processing of the flowchart of FIG. 36, it is assumed that the sensor unit 120 of the camera module 100 performs the light reception operation in the image area by all the pixels 1222 included in the effective pixel region in the pixel area 1221, and outputs a distance image at the highest frame rate. In addition, it is assumed that the information processing device 20 has executed all of a plurality of types of processing using the detection output from the sensor device 10.

In FIG. 36, the processing in steps S200 to S203 corresponds to the processing in steps S100 to S103 in FIG. 33 described above. That is, in step S200, the control unit 200 in the information processing device 20 determines whether to control the light reception operation. When having determined not to perform the control of the light reception operation (step S200, “No”), the control unit 200 ends a series of processing of the flowchart of FIG. 36. In contrast, when having determined to perform the control of the light reception operation (step S200, “Yes”), the control unit 200 proceeds to the processing of step S201.

In step S201, the determination unit 203 in the information processing device 20 determines whether the component temperature in the camera module 100 exceeds a first threshold (100° C. in this example) based on the temperature information acquired by the temperature information acquisition unit 202.

When the determination unit 203 has determined that the component temperature the first threshold or less (step S201, “No”), the control unit 200 returns to the processing of step S201. In contrast, when the determination unit 203 has determined that the component temperature exceeds the first threshold (step S201, “Yes”), the control unit 200 proceeds to the processing of step S202a.

The processing of step S202a corresponds to the processing of step S102b in the flowchart of FIG. 33, for example. That is, in step S202a, the control unit 200 restricts the frame rate of the detection output from the sensor unit 120 in the light reception operation of the sensor device 10. For example, in step S202a, the control unit 200 generates a control signal of stopping the detection output at the highest frame rate among the detection outputs at the plurality of frame rates output by the sensor unit 120.

At the same time, in step S202a, the control unit 200 stops the processing that requires the restricted frame rate among the processing executed in the information processing device 20. For example, the control unit 200 instructs the analysis unit 204 to stop the processing.

Note that the detection area does not change even when the restriction of the frame rate and the stop of the predetermined processing in the information processing device 20 have been executed in step S202a.

In the next step S203, the control unit 200 transmits the control signal generated in step S202a to the sensor device 10. The sensor device 10 controls the light reception operation of the sensor unit 120 according to the control signal transmitted from the information processing device 20.

After the processing of step S203, the control unit 200 returns to the processing of step S204. The processing of steps S204 to S207 corresponds to the processing of steps S101 to S104 in the flowchart of FIG. 15 described above.

That is, in step S204, the determination unit 203 in the information processing device 20 determines whether the component temperature in the camera module 100 exceeds a first threshold (100° C. in this example) based on the temperature information acquired by the temperature information acquisition unit 202.

When the determination unit 203 has determined that the component temperature is the first threshold or less (step S204, “No”), the control unit 200 returns to the processing of step S201. In contrast, when the determination unit 203 has determined that the component temperature exceeds the first threshold (step S204, “Yes”), the control unit 200 proceeds to the processing of step S205a.

In step S205a, the control unit 200 sets the detection area by the sensor device 10 to be restricted in accordance with the priority set for each area in the detection area. For example, the control unit 200 generates a control signal that restricts a detection function for an area set to have a lower priority. The restriction according to the priority with respect to the detection area in step S205a is similar to the example described with reference to FIG. 16, and thus, the description thereof is omitted here.

In the next step S206, the control unit 200 transmits the control signal generated in step S205 to the sensor device 10. The sensor device 10 receives the control signal transmitted from the information processing device 20 by the communication I/F 105 and passes the control signal to the module control unit 101. The module control unit 101 generates a drive signal according to the transmitted control signal and drives the light emission unit 110.

In next step S207, the determination unit 203 in the information processing device 20 determines whether the component temperature in the camera module 100 exceeds a second threshold (110° C. in this example) based on the temperature information acquired by the temperature information acquisition unit 202.

When the determination unit 203 has determined that the component temperature is the second threshold or more (step S207, “Yes”), the control unit 200 stops the operation of the camera module 100, for example, and ends the series of processing of the flowchart of FIG. 36. In contrast, when the determination unit 203 has determined that the component temperature is less than the second threshold (step S207, “No”), the control unit 200 proceeds to the processing of step S208.

In step S208, the determination unit 203 determines whether the component temperature in the camera module 100c is a third threshold (90° C. in this example) or less based on the temperature information acquired by the temperature information acquisition unit 202.

In step S208, when the determination unit 203 has determined that the component temperature is the third threshold or less (step S208, “Yes”), the control unit 200 proceeds to the processing of step S209a. In step S209a, the control unit 200 returns the frame rate restricted by the processing of step S202a to the original frame rate and resumes the function stopped in the information processing device 20. Furthermore, in step S209a, the control unit 200 cancels the restriction of the detection area restricted by the processing of step S205a.

After the processing of step S209a, the control unit 200 returns to the processing of step S200.

In contrast, when the determination unit 203 has determined that the component temperature exceeds the third threshold (step S208, “No”), the control unit 200 returns to the processing of step S201. In a case where the processing returns from step S208 to step S201 and the determination unit 203 has determined that the component temperature exceeds the first threshold, the control unit 200 may tighten the restriction on the frame rate in stages in the next steps S202b and S203. Along with this, the control unit 200 may stop the processing in the information processing device 20 using the detection output at the restricted frame rate.

Having executed the processing of step S203, which is a step proceeding from step S208, the determination unit 203 determines, in the next step S204, whether the component temperature in the camera module 100 exceeds a first threshold (100° C. in this example) based on the temperature information acquired by the temperature information acquisition unit 202.

When the determination unit 203 has determined that the component temperature is the first threshold or less (step S204, “No”), the control unit 200 returns to the processing of step S201. In contrast, when the determination unit 203 has determined that the component temperature exceeds the first threshold (step S204, “Yes”), the control unit 200 may proceed to the processing of step S205a and generate a control signal instructing restriction according to the priority of the detection area.

### 6-2. Second Example of Third Embodiment

First, a second example of the third embodiment will be described. The second example of the third embodiment is an example of rearranging the order of the processing of restricting the frame rate and stopping some functions of the information processing device 20 and the processing of restricting the detection area according to the priority in the first example of the third embodiment described above.

The second example of the third embodiment is applicable to any of the configurations of the camera modules 100a and 100b using the iToF sensor 1200 described with reference to FIGS. 5A and 5B, and the camera modules 100a′ and 100b′ using the RGBIR sensor 1300 described with reference to FIGS. 28A and 28B. The second example of the third embodiment is also applicable to a camera module with one lamp according to the first embodiment and the fourth example of the modification of the first embodiment.

Hereinafter, unless otherwise specified, the camera modules 100a, 100b, 100a′, and 100b′ and the camera module with one lamp according to the first embodiment and the fourth example of the modification of the first embodiment will be described as the camera module 100 as a representative.

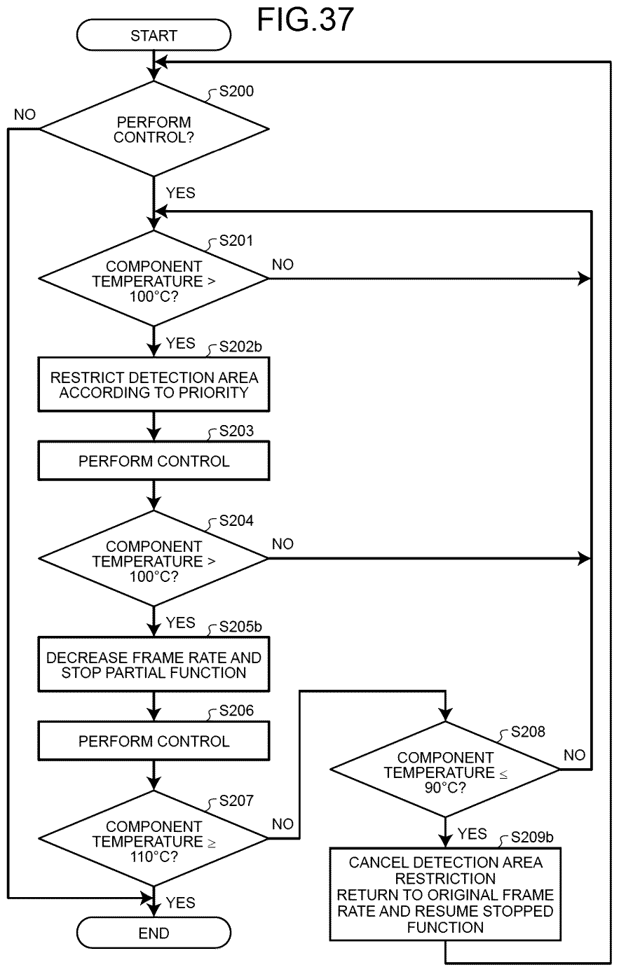

FIG. 37 is a flowchart illustrating an example of processing according to a second example of the third embodiment. The following will appropriately omit detailed description of processing corresponding to the processing of the flowchart of FIG. 36 described above.

In FIG. 37, in step S200, the control unit 200 in the information processing device 20 determines whether to control the light reception operation. When having determined not to perform the control of the light reception operation (step S200, “No”), the control unit 200 ends a series of processing of the flowchart of FIG. 37. In contrast, when having determined to perform the control of the light reception operation (step S200, “Yes”), the control unit 200 proceeds to the processing of step S201.

In step S201, the determination unit 203 in the information processing device 20 determines whether the component temperature in the camera module 100 exceeds a first threshold (100° C. in this example) based on the temperature information acquired by the temperature information acquisition unit 202.

When the determination unit 203 has determined that the component temperature the first threshold or less (step S201, “No”), the control unit 200 returns to the processing of step S201. In contrast, when the determination unit 203 has determined that the component temperature exceeds the first threshold (step S201, “Yes”), the control unit 200 proceeds to the processing of step S202b.

The processing of step S202b corresponds to the processing of step S205a in the flowchart of FIG. 37, for example. That is, step S202b, the control unit 200 sets the detection area by the sensor device 10 to be restricted in accordance with the priority set for each area in the detection area.

In the next step S203, the control unit 200 transmits the control signal generated in step S202b to the sensor device 10. The sensor device 10 controls the light reception operation of the sensor unit 120 according to the control signal transmitted from the information processing device 20.

After the processing of step S203, the control unit 200 returns to the processing of step S204. In step S204, the determination unit 203 in the information processing device 20 determines whether the component temperature in the camera module 100 exceeds a first threshold (100° C. in this example) based on the temperature information acquired by the temperature information acquisition unit 202.

When the determination unit 203 has determined that the component temperature is the first threshold or less (step S204, “No”), the control unit 200 returns to the processing of step S201. In contrast, when the determination unit 203 has determined that the component temperature exceeds the first threshold (step S204, “Yes”), the control unit 200 proceeds to the processing of step S205b.

In step S205b, the control unit 200 restricts the frame rate of the detection output from the sensor unit 120 in the light reception operation of the sensor device 10. At the same time, in step S205b, the control unit 200 stops the processing that requires the restricted frame rate among the processing executed in the information processing device 20. For example, the control unit 200 instructs the analysis unit 204 to stop the processing.

Note that the detection area does not change from the detection area restricted in step S202b even when the restriction of the frame rate and the stop of the predetermined processing in the information processing device 20 have been executed in step S205b.

In the next step S206, the control unit 200 transmits the control signal generated in step S205b to the sensor device 10. The sensor device 10 receives the control signal transmitted from the information processing device 20 by the communication I/F 105 and passes the control signal to the module control unit 101. The module control unit 101 generates a drive signal according to the transmitted control signal and drives the light emission unit 110.

In next step S207, the determination unit 203 in the information processing device 20 determines whether the component temperature in the camera module 100 exceeds a second threshold (110° C. in this example) based on the temperature information acquired by the temperature information acquisition unit 202.

When the determination unit 203 has determined that the component temperature is the second threshold or more (step S207, “Yes”), the control unit 200 stops the operation of the camera module 100, for example, and ends the series of processing of the flowchart of FIG. 36. In contrast, when the determination unit 203 has determined that the component temperature is less than the second threshold (step S207, “No”), the control unit 200 proceeds to the processing of step S208.

In step S208, the determination unit 203 determines whether the component temperature in the camera module 100c is a third threshold (90° C. in this example) or less based on the temperature information acquired by the temperature information acquisition unit 202.

In step S208, when the determination unit 203 has determined that the component temperature is the third threshold or less (step S208, “Yes”), the control unit 200 proceeds to the processing of step S209b. In step S209b, the control unit 200 cancels the restriction of the detection area restricted by the processing of step S202b. Furthermore, in step S209b, the control unit 200 returns the frame rate restricted by the processing of step S205b to the original frame rate and resumes the function stopped in the information processing device 20.

After the processing of step S209b, the control unit 200 returns to the processing of step S200.

In contrast, when the determination unit 203 has determined that the component temperature exceeds the third threshold (step S208, “No”), the control unit 200 returns to the processing of step S201. In a case where the processing returns from step S208 to step S201 and the determination unit 203 has determined that the component temperature exceeds the first threshold, the control unit 200 may tighten the restriction on the detection area according to the priority in stages in the next steps S202b and S203.

Having executed the processing of step S203, which is a step proceeding from step S208, the determination unit 203 determines, in the next step S204, whether the component temperature in the camera module 100 exceeds a first threshold (100° C. in this example) based on the temperature information acquired by the temperature information acquisition unit 202.

When the determination unit 203 has determined that the component temperature is the first threshold or less (step S204, “No”), the control unit 200 returns to the processing of step S201. In contrast, when the determination unit 203 has determined that the component temperature exceeds the first threshold (step S204, “Yes”), the control unit 200 may proceed to the processing of step S205b and generate a control signal instructing further tightening of the restriction on the frame rate. Along with this, the control unit 200 may stop the processing in the information processing device 20 using the detection output at the restricted frame rate.

In this manner, in the first example and the second example of the third embodiment, the detection function of the sensor device 10 is restricted in accordance with the temperature of the camera module 100. At this time, in the first example and the second example of the third embodiment, the detection area is restricted, and the frame rate of the detection output that is output from the sensor unit 120 is restricted, thereby implementing the restriction of the detection function. This suppresses the current consumption of the sensor device 10, leading to suppression of heat generation. Therefore, with application of the first example and the second example of the third embodiment, it is possible to guarantee the operation of the vehicle 1000 in the temperature range according to the operation guarantee standard without depending on the hardware heat dissipation measures.

### 6-3. Third Example of Third Embodiment

Next, a third example of the third embodiment will be described. The third example of the third embodiment is an example of combining the restriction of the frame rate according to the second embodiment and the restriction of the detection area by the sensor unit 120 according to the first embodiment and the third example of the modification of the first embodiment.

The third example of the third embodiment is applicable to any of the configurations of the camera modules 100a, 100b, and 100c using the iToF sensor 1200 described with reference to FIGS. 5A to 5C, and the camera modules 100a′, 100b′, and 100c′ using the RGBIR sensor 1300 described with reference to FIGS. 28A to 28C. The third example of the third embodiment is also applicable to a camera module with one lamp according to the first embodiment and the fourth example of the modification of the first embodiment.

Hereinafter, unless otherwise specified, the camera modules 100a to 100c, 100a′ to 100c′, and the camera module with one lamp according to the first embodiment and the fourth example of the modification of the first embodiment will be described as the camera module 100 as a representative.

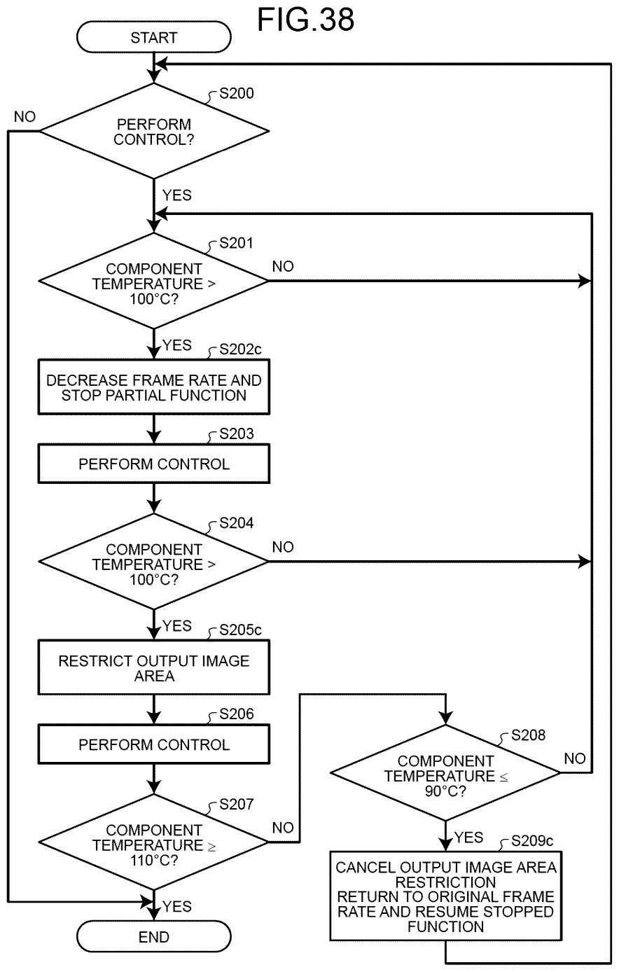

FIG. 38 is a flowchart illustrating an example of processing according to the third example of the third embodiment. The following will appropriately omit detailed description of processing corresponding to the processing of the flowchart of FIG. 36 described above.

As a precondition for the processing of the flowchart of FIG. 38, it is assumed that the sensor unit 120 of the camera module 100 performs the light reception operation in the image area by all the pixels 1222 included in the effective pixel region in the pixel area 1221, and outputs a distance image at the highest frame rate. In addition, it is assumed that the information processing device 20 has executed all of a plurality of types of processing using the detection output from the sensor device 10.

In FIG. 38, the processing in steps S200 to S203 corresponds to the processing in steps S100 to S103 in FIG. 33 described above. That is, in step S200, the control unit 200 in the information processing device 20 determines whether to control the light reception operation. When having determined not to perform the control of the light reception operation (step S200, “No”), the control unit 200 ends a series of processing of the flowchart of FIG. 38. In contrast, when having determined to perform the control of the light reception operation (step S200, “Yes”), the control unit 200 proceeds to the processing of step S201.

In step S201, the determination unit 203 in the information processing device 20 determines whether the component temperature in the camera module 100 exceeds a first threshold (100° C. in this example) based on the temperature information acquired by the temperature information acquisition unit 202.

When the determination unit 203 has determined that the component temperature the first threshold or less (step S201, “No”), the control unit 200 returns to the processing of step S201. In contrast, when the determination unit 203 has determined that the component temperature exceeds the first threshold (step S201, “Yes”), the control unit 200 proceeds to the processing of step S202c.

The processing of step S202c corresponds to the processing of step S102b in the flowchart of FIG. 33, for example. That is, in step S202c, the control unit 200 restricts the frame rate of the detection output from the sensor unit 120 in the light reception operation of the sensor device 10. At the same time, in step S202c, the control unit 200 stops the processing that requires the restricted frame rate among the processing executed in the information processing device 20.

Note that the detection area does not change even when the restriction of the frame rate and the stop of the predetermined processing in the information processing device 20 have been executed in step S202c.

In the next step S203, the control unit 200 transmits the control signal generated in step S202c to the sensor device 10. The sensor device 10 controls the light reception operation of the sensor unit 120 according to the control signal transmitted from the information processing device 20.

After the processing of step S203, the control unit 200 returns to the processing of step S204. In step S204, the determination unit 203 in the information processing device 20 determines whether the component temperature in the camera module 100 exceeds a first threshold (100° C. in this example) based on the temperature information acquired by the temperature information acquisition unit 202.

When the determination unit 203 has determined that the component temperature is the first threshold or less (step S204, “No”), the control unit 200 returns to the processing of step S201. In contrast, when the determination unit 203 has determined that the component temperature exceeds the first threshold (step S204, “Yes”), the control unit 200 proceeds to the processing of step S205c.

The processing of step S205c corresponds to the processing of step S102a in the flowchart of FIG. 23, for example. That is, in step S205c, the control unit 200 restricts the light reception operation of the sensor device 10. For example, in step S205c, the control unit 200 generates a control signal to restrict the light reception operation by setting the output image area in which the sensor unit 120 outputs the image data to be restricted in accordance with the priority set for each area in the image area.

In the next step S206, the control unit 200 transmits the control signal generated in step S205 to the sensor device 10. The sensor device 10 controls the light reception operation of the sensor unit 120 according to the control signal transmitted from the information processing device 20.

In next step S207, the determination unit 203 in the information processing device 20 determines whether the component temperature in the camera module 100 exceeds a second threshold (110° C. in this example) based on the temperature information acquired by the temperature information acquisition unit 202.

When the determination unit 203 has determined that the component temperature is the second threshold or more (step S207, “Yes”), the control unit 200 stops the operation of the camera module 100, for example, and ends the series of processing of the flowchart of FIG. 36. In contrast, when the determination unit 203 has determined that the component temperature is less than the second threshold (step S207, “No”), the control unit 200 proceeds to the processing of step S208.

In step S208, the determination unit 203 determines whether the component temperature in the camera module 100c is a third threshold (90° C. in this example) or less based on the temperature information acquired by the temperature information acquisition unit 202.

In step S208, when the determination unit 203 has determined that the component temperature is the third threshold or less (step S208, “Yes”), the control unit 200 proceeds to the processing of step S209c. In step S209c, the control unit 200 returns the frame rate restricted by the processing of step S202c to the original frame rate and resumes the function stopped in the information processing device 20. In step S209c, the control unit 200 cancels the restriction of the light reception operation set in step S205c, and resumes the light reception operation by the pixels 1222 in the entire image areas in the sensor unit 120.

After the processing of step S209c, the control unit 200 returns to the processing of step S200.

In contrast, when the determination unit 203 has determined that the component temperature exceeds the third threshold (step S208, “No”), the control unit 200 returns to the processing of step S201. In a case where the processing returns from step S208 to step S201 and the determination unit 203 has determined that the component temperature exceeds the first threshold, the control unit 200 may tighten the restriction on the frame rate in stages in the next steps S202c and S203. Along with this, the control unit 200 may stop the processing in the information processing device 20 using the detection output at the restricted frame rate.

Having executed the processing of step S203, which is a step proceeding from step S208, the determination unit 203 determines, in the next step S204, whether the component temperature in the camera module 100 exceeds a first threshold (100° C. in this example) based on the temperature information acquired by the temperature information acquisition unit 202.

When the determination unit 203 has determined that the component temperature is the first threshold or less (step S204, “No”), the control unit 200 returns to the processing of step S201. In contrast, when the determination unit 203 has determined that the component temperature exceeds the first threshold (step S204, “Yes”), the control unit 200 proceeds to the processing of step S205c and generates a control signal instructing further restriction of the output image area.

### 6-4. Fourth Example of Third Embodiment

Next, a fourth example of the third embodiment will be described. The fourth example of the third embodiment is an example of rearranging the order of the processing of restricting the frame rate and stopping some functions of the information processing device 20 and the processing of restricting the output image area according to the priority in the third example of the third embodiment described above.

The fourth example of the third embodiment is applicable to any of the configurations of the camera modules 100a, 100b, and 100c using the iToF sensor 1200 described with reference to FIGS. 5A to 5C, and the camera modules 100a′, 100b′, and 100c′ using the RGBIR sensor 1300 described with reference to FIGS. 28A to 28C. The third example of the third embodiment is also applicable to a camera module with one lamp according to the first embodiment and the fourth example of the modification of the first embodiment.

Hereinafter, unless otherwise specified, the camera modules 100a to 100c, 100a′ to 100c′, and the camera module with one lamp according to the first embodiment and the fourth example of the modification of the first embodiment will be described as the camera module 100 as a representative.

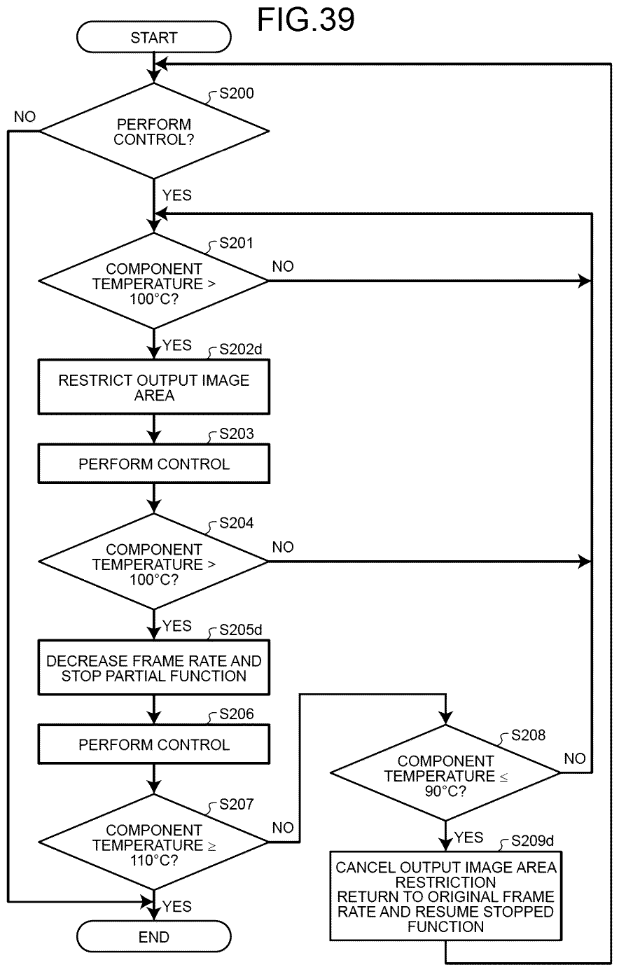

FIG. 39 is a flowchart illustrating an example of processing according to the third example of the third embodiment. The following will appropriately omit detailed description of processing corresponding to the processing of the flowchart of FIG. 38 described above.

As a precondition for the processing of the flowchart of FIG. 39, it is assumed that the sensor unit 120 of the camera module 100 performs the light reception operation in the image area by all the pixels 1222 included in the effective pixel region in the pixel area 1221, and outputs a distance image at the highest frame rate. In addition, it is assumed that the information processing device 20 has executed all of a plurality of types of processing using the detection output from the sensor device 10.

In FIG. 39, the processing in steps S200 to S203 corresponds to the processing in steps S100 to S103 in FIG. 23 described above. That is, in step S200, the control unit 200 in the information processing device 20 determines whether to control the light reception operation. When having determined not to perform the control of the light reception operation (step S200, “No”), the control unit 200 ends a series of processing of the flowchart of FIG. 39. In contrast, when having determined to perform the control of the light reception operation (step S200, “Yes”), the control unit 200 proceeds to the processing of step S201.

In step S201, the determination unit 203 in the information processing device 20 determines whether the component temperature in the camera module 100 exceeds a first threshold (100° C. in this example) based on the temperature information acquired by the temperature information acquisition unit 202.

When the determination unit 203 has determined that the component temperature the first threshold or less (step S201, “No”), the control unit 200 returns to the processing of step S201. In contrast, when the determination unit 203 has determined that the component temperature exceeds the first threshold (step S201, “Yes”), the control unit 200 proceeds to the processing of step S202d.

The processing of step S202d corresponds to the processing of step S205c in the flowchart of FIG. 38, for example. That is, in step S202d, the control unit 200 generates a control signal that restricts the light reception operation by the sensor device 10 and restricts the output image area, being an area to which the sensor unit 120 outputs the image data, in accordance with the priority set for each area in the image area.

Note that the detection area does not change even when the restriction of the frame rate and the stop of the predetermined processing in the information processing device 20 have been executed in step S202d.

In the next step S203, the control unit 200 transmits the control signal generated in step S202d to the sensor device 10. The sensor device 10 controls the light reception operation of the sensor unit 120 according to the control signal transmitted from the information processing device 20.

After the processing of step S203, the control unit 200 returns to the processing of step S204. In step S204, the determination unit 203 in the information processing device 20 determines whether the component temperature in the camera module 100 exceeds a first threshold (100° C. in this example) based on the temperature information acquired by the temperature information acquisition unit 202.

When the determination unit 203 has determined that the component temperature is the first threshold or less (step S204, “No”), the control unit 200 returns to the processing of step S201. In contrast, when the determination unit 203 has determined that the component temperature exceeds the first threshold (step S204, “Yes”), the control unit 200 proceeds to the processing of step S205d.

In step S205d, the control unit 200 restricts the frame rate of the detection output from the sensor unit 120 in the light reception operation of the sensor device 10.

At the same time, in step S205d, the control unit 200 stops the processing that requires the restricted frame rate among the processing executed in the information processing device 20.

In the next step S206, the control unit 200 transmits the control signal generated in step S205 to the sensor device 10. The sensor device 10 controls the light reception operation of the sensor unit 120 according to the control signal transmitted from the information processing device 20.

In next step S207, the determination unit 203 in the information processing device 20 determines whether the component temperature in the camera module 100 exceeds a second threshold (110° C. in this example) based on the temperature information acquired by the temperature information acquisition unit 202.

When the determination unit 203 has determined that the component temperature is the second threshold or more (step S207, “Yes”), the control unit 200 stops the operation of the camera module 100, for example, and ends the series of processing of the flowchart of FIG. 39. In contrast, when the determination unit 203 has determined that the component temperature is less than the second threshold (step S207, “No”), the control unit 200 proceeds to the processing of step S208.

In step S208, the determination unit 203 determines whether the component temperature in the camera module 100c is a third threshold (90° C. in this example) or less based on the temperature information acquired by the temperature information acquisition unit 202.

In step S208, when the determination unit 203 has determined that the component temperature is the third threshold or less (step S208, “Yes”), the control unit 200 proceeds to the processing of step S209d.

In step S209d, the control unit 200 cancels the restriction of the light reception operation set in step S202d, and resumes the light reception operation by the pixels 1222 in the entire image areas in the sensor unit 120. Furthermore, in step S209d, the control unit 200 returns the frame rate restricted by the processing of step S205d to the original frame rate and resumes the function stopped in the information processing device 20.

After the processing of step S209c, the control unit 200 returns to the processing of step S200.

In contrast, when the determination unit 203 has determined that the component temperature exceeds the third threshold (step S208, “No”), the control unit 200 returns to the processing of step S201. In a case where the processing returns from step S208 to step S201 and the determination unit 203 has determined that the component temperature exceeds the first threshold, the control unit 200 may tighten the restriction on the output image area in stages in the next steps S202d and S203.

Having executed the processing of step S203, which is a step proceeding from step S208, the determination unit 203 determines, in the next step S204, whether the component temperature in the camera module 100 exceeds a first threshold (100° C. in this example) based on the temperature information acquired by the temperature information acquisition unit 202.

When the determination unit 203 has determined that the component temperature is the first threshold or less (step S204, “No”), the control unit 200 returns to the processing of step S201. In contrast, when the determination unit 203 has determined that the component temperature exceeds the first threshold (step S204, “Yes”), the control unit 200 may proceed to the processing of step S205d and further tighten the restriction on the frame rate in stages. Along with this, the control unit 200 may stop the processing in the information processing device 20 using the detection output at the restricted frame rate.

In this manner, in the third example and the fourth example of the third embodiment, the detection function of the sensor device 10 is restricted in accordance with the temperature of the camera module 100. At this time, in the third example of the third embodiment, by controlling the frame rate of the detection output that is output from the sensor unit 120 and further restricting the output image area where the sensor unit 120 outputs the image data, restriction of the detection function is implemented. This suppresses the current consumption of the sensor device 10, leading to suppression of heat generation. Therefore, with application of the third example and the fourth example of the third embodiment, it is possible to guarantee the operation of the vehicle 1000 in the temperature range according to the operation guarantee standard without depending on the hardware heat dissipation measures.

The effects described in the present specification are merely examples, and thus, there may be other effects, not limited to the exemplified effects.

Note that the present technology can also have the following configurations.
(1) An information processing device comprising
   a control unit configured to control operation of at least one of a plurality of light sources or an imaging unit, the light sources emitting light into a car cabin, each of the light sources being included in a module, the imaging unit capturing an image of at least a part of a region to which the light is applied to acquire imaging information, wherein
   the control unit,
   when a temperature of the module exceeds a first threshold, controls operation of at least one of the plurality of light sources or the imaging unit to restrict a function of the module.
(2) The information processing device according to the above (1), wherein
   the control unit
   controls operation of at least one of the plurality of light sources or the imaging unit such that, when the temperature of the module exceeds the first threshold, imaging information to be acquired by the imaging unit is to be restricted.
(3) The information processing device according to the above (2), wherein
   the control unit
   controls operation of at least one of the plurality of light sources or the imaging unit such that, when the temperature of the module has exceeded the first threshold and the control unit has restricted the imaging information and then the temperature of the module exceeds the first threshold again, the imaging information is to be restricted more tightly.
(4) The information processing device according to the above (2) or (3), wherein
   the control unit
   restricts the imaging information by controlling operation of the plurality of light sources to restrict projection of the light to a partial irradiation range out of irradiation ranges to which the light is projected by the plurality of light sources.
(5) The information processing device according to the above (4), wherein
   the control unit
   restricts the projection of the light to the partial irradiation range by suppressing drive power of driving a partial light source out of the plurality of light sources.
(6) The information processing device according to the above (4), wherein
   the control unit
   restricts the projection of the light to the partial irradiation range by suppressing projection time of the light from the partial light source out of the plurality of light sources.
(7) The information processing device according to the above (5) or (6), wherein
   the control unit
   restricts the projection of the light to the partial irradiation range by stopping driving of the partial light source.
(8) The information processing device according to any one of the above (4) to (7), wherein
   the control unit
   restricts the projection of the light to an irradiation range wider than the partial irradiation range out of the irradiation ranges when the temperature of the module has exceeded the first threshold and the control unit has restricted the projection of the light and then the temperature of the module exceeds the first threshold again.
(9) The information processing device according to any one of the above (2) to (8), wherein
   the control unit
   restricts the imaging information by controlling an imaging operation in the imaging unit to restrict an imaging range to be imaged by the imaging unit.
(10) The information processing device according to the above (9), wherein
   the control unit
   restricts the imaging range imaged by the imaging unit to an imaging range narrower than the imaging range in which the imaging operation has been restricted when the temperature of the module has exceeded the first threshold and the control unit has restricted the imaging operation in the imaging range and then the temperature of the module exceeds the first threshold again.
(11) The information processing device according to any one of the above (2) to (10), wherein
   the control unit
   restricts the imaging information by controlling an imaging operation in the imaging unit to restrict a frame rate of imaging information to be acquired by the imaging unit.
(12) The information processing device according to the above (11), further comprising
   a signal processing unit configured to execute a plurality of types of processing based on the imaging information captured by the imaging unit, wherein
   the control unit
   controls the signal processing unit to stop processing requiring the imaging information with a highest frame rate among the plurality of types of processing, and
   controls the imaging unit to restrict the frame rate of the imaging information in accordance with processing requiring a frame rate being second highest after the processing.
(13) The information processing device according to the above (12), in which
   the signal processing unit
   executes the plurality of types of processing including gesture recognition processing, skeleton estimation processing, gaze tracking processing, and face authentication processing, and
   the control unit
   stops the gesture recognition processing executed by the signal processing unit.
(14) The information processing device according to any one of the above (2) to (13), wherein
   the control unit
   restricts the imaging information by using a first restriction and a second restriction, the first restriction being a restriction of projection of the light to a part of an irradiation range to which the light is applied by the plurality of light sources, the first restriction being performed by controlling operation of the plurality of light sources, the second restriction being a restriction of a frame rate of imaging information acquired by the imaging unit, the second restriction being performed by controlling imaging operation in the imaging unit.
(15) The information processing device according to the above (14), wherein
   the control unit,
   when the temperature of the module exceeds the first threshold after execution of one of the first restriction and the second restriction, executes the other restriction, and when the temperature of the module falls to a second threshold or less, the second threshold being lower than the first threshold, after execution of the other restriction, cancels the first restriction and the second restriction.
(16) The information processing device according to any one of the above (2) to (13), wherein
   the control unit
   restricts the imaging information by using a third restriction and a fourth restriction, the third restriction being a restriction of an imaging range acquired by the imaging unit, the third restriction being performed by controlling imaging operation in the imaging unit, the fourth restriction being a restriction of a frame rate of imaging information acquired by the imaging unit, the fourth restriction being performed by controlling the imaging operation in the imaging unit.
(17) The information processing device according to the above (16), wherein
   the control unit,
   when the temperature of the module exceeds the first threshold after execution of one of the third restriction and the fourth restriction, executes the other restriction, and when the temperature of the module falls to a second threshold or less, the second threshold being lower than the first threshold, after execution of the other restriction, cancels the third restriction and the fourth restriction.
(18) The information processing device according to any one of the above (1) to (17), wherein
   each of the plurality of light sources is a laser light source that emits laser light.
(19) The information processing device according to the above (18), wherein
   each of the plurality of light sources is each of a plurality of light spots, the light spot being included in one light emitting element, light emission of the light spot being independently controlled in a predetermined unit.
(20) The information processing device according to any of the above (1) to (19), in which
   each of the plurality of light sources is a light emitting element configured to emit the light in at least an infrared wavelength region.
(21) An information processing method to be executed by a processor, the method comprising
   a control step of controlling operation of at least one of a plurality of light sources or an imaging unit, the light sources emitting light into a car cabin, each of the light sources being included in a module, the imaging unit capturing an image of at least a part of a region to which the light is applied to acquire imaging information,
wherein
   the control step,
   when a temperature of the module exceeds a first threshold, controls operation of at least one of the plurality of light sources and the imaging unit to restrict a function of the module.
(22) An in-cabin monitoring device comprising:
   a module including
   a plurality of light sources and an imaging unit, the light sources emitting light into a car cabin, the imaging unit capturing an image of at least a part of a region to which the light is applied to acquire imaging information;
   a temperature detection unit configured to detect a temperature of the module; and
   a control unit configured to control operation of at least one of the plurality of light sources or the imaging unit, wherein
   the control unit,
   when the temperature of the module exceeds a first threshold, controls operation of at least one of the plurality of light sources or the imaging unit to restrict a function of the module.

### REFERENCE SIGNS LIST

1 CONTROL SYSTEM
10 SENSOR DEVICE
20 INFORMATION PROCESSING DEVICE
30 CONTROL TARGET DEVICE
100, 100a, 100a′, 100b, 100b′, 100c, 100c′ CAMERA MODULE
101 MODULE CONTROL UNIT
102 NONVOLATILE MEMORY
102a SETTING INFORMATION
103 SIGNAL PROCESSING UNIT
104 MEMORY
105 COMMUNICATION I/F
110 LIGHT EMISSION UNIT
120, 120a SENSOR UNIT
130 TEMPERATURE SENSOR
200 CONTROL UNIT
201 COMMUNICATION UNIT
202 TEMPERATURE INFORMATION ACQUISITION UNIT
203 DETERMINATION UNIT
204 ANALYSIS UNIT
205 OUTPUT UNIT
231 PHOTODIODE
234, 239 FLOATING DIFFUSION LAYER
510 VCSEL
513 LIGHT EMITTING ELEMENT
520, 1201a, 1201b, 1201c, 1201d LASER DIODE DRIVER
1000 VEHICLE
1002 DRIVER'S SEAT
1003 PASSENGER SEAT
1010 CAR CABIN
1200 iTOF SENSOR
1202a, 1202b, 1202c, 1202d LASER DIODE
1221 PIXEL AREA
1222 PIXEL
1231 VERTICAL DRIVE CIRCUIT
1232 COLUMN SIGNAL PROCESSING UNIT
1233 TIMING CONTROL CIRCUIT
1234 OUTPUT CIRCUIT
1300 RGBIR SENSOR
1411 PIXEL ARRAY UNIT
1419 IMAGING OPERATION CONTROL UNIT

1. An information processing device comprising
a control unit configured to control operation of at least one of a plurality of light sources or an imaging unit, the light sources emitting light into a car cabin, each of the light sources being included in a module, the imaging unit capturing an image of at least a part of a region to which the light is applied to acquire imaging information, wherein
the control unit,
when a temperature of the module exceeds a first threshold, controls operation of at least one of the plurality of light sources or the imaging unit to restrict a function of the module.

2. The information processing device according to claim 1, wherein
the control unit
controls operation of at least one of the plurality of light sources or the imaging unit such that, when the temperature of the module exceeds the first threshold, imaging information to be acquired by the imaging unit is to be restricted.

3. The information processing device according to claim 2, wherein
the control unit
controls operation of at least one of the plurality of light sources or the imaging unit such that, when the temperature of the module has exceeded the first threshold and the control unit has restricted the imaging information and then the temperature of the module exceeds the first threshold again, the imaging information is to be restricted more tightly.

4. The information processing device according to claim 2, wherein
the control unit
restricts the imaging information by controlling operation of the plurality of light sources to restrict projection of the light to a partial irradiation range out of irradiation ranges to which the light is projected by the plurality of light sources.

5. The information processing device according to claim 4, wherein
the control unit
restricts the projection of the light to the partial irradiation range by suppressing drive power of driving a partial light source out of the plurality of light sources.

6. The information processing device according to claim 4, wherein
the control unit
restricts the projection of the light to the partial irradiation range by suppressing projection time of the light from the partial light source out of the plurality of light sources.

7. The information processing device according to claim 5, wherein
the control unit
restricts the projection of the light to the partial irradiation range by stopping driving of the partial light source.

8. The information processing device according to claim 4, wherein
the control unit
restricts the projection of the light to an irradiation range wider than the partial irradiation range out of the irradiation ranges when the temperature of the module has exceeded the first threshold and the control unit has restricted the projection of the light and then the temperature of the module exceeds the first threshold again.

9. The information processing device according to claim 2, wherein
the control unit
restricts the imaging information by controlling an imaging operation in the imaging unit to restrict an imaging range to be imaged by the imaging unit.

10. The information processing device according to claim 9, wherein
the control unit
restricts the imaging range imaged by the imaging unit to an imaging range narrower than the imaging range in which the imaging operation has been restricted when the temperature of the module has exceeded the first threshold and the control unit has restricted the imaging operation in the imaging range and then the temperature of the module exceeds the first threshold again.

11. The information processing device according to claim 2, wherein
the control unit
restricts the imaging information by controlling an imaging operation in the imaging unit to restrict a frame rate of imaging information to be acquired by the imaging unit.

12. The information processing device according to claim 11, further comprising
a signal processing unit configured to execute a plurality of types of processing based on the imaging information captured by the imaging unit, wherein
the control unit
controls the signal processing unit to stop processing requiring the imaging information with a highest frame rate among the plurality of types of processing, and
controls the imaging unit to restrict the frame rate of the imaging information in accordance with processing requiring a frame rate being second highest after the processing.

13. The information processing device according to claim 2, wherein
the control unit
restricts the imaging information by using a first restriction and a second restriction, the first restriction being a restriction of projection of the light to a part of an irradiation range to which the light is applied by the plurality of light sources, the first restriction being performed by controlling operation of the plurality of light sources, the second restriction being a restriction of a frame rate of imaging information acquired by the imaging unit, the second restriction being performed by controlling imaging operation in the imaging unit.

14. The information processing device according to claim 13, wherein
the control unit,
when the temperature of the module exceeds the first threshold after execution of one of the first restriction and the second restriction, executes the other restriction, and when the temperature of the module falls to a second threshold or less, the second threshold being lower than the first threshold, after execution of the other restriction, cancels the first restriction and the second restriction.

15. The information processing device according to claim 2, wherein
the control unit
restricts the imaging information by using a third restriction and a fourth restriction, the third restriction being a restriction of an imaging range acquired by the imaging unit, the third restriction being performed by controlling imaging operation in the imaging unit, the fourth restriction being a restriction of a frame rate of imaging information acquired by the imaging unit, the fourth restriction being performed by controlling the imaging operation in the imaging unit.

16. The information processing device according to claim 15, wherein
the control unit,
when the temperature of the module exceeds the first threshold after execution of one of the third restriction and the fourth restriction, executes the other restriction, and when the temperature of the module falls to a second threshold or less, the second threshold being lower than the first threshold, after execution of the other restriction, cancels the third restriction and the fourth restriction.

17. The information processing device according to claim 1, wherein
each of the plurality of light sources is a laser light source that emits laser light.

18. The information processing device according to claim 17, wherein
each of the plurality of light sources is each of a plurality of light spots, the light spot being included in one light emitting element, light emission of the light spot being independently controlled in a predetermined unit.

19. An information processing method to be executed by a processor, the method comprising
a control step of controlling operation of at least one of a plurality of light sources or an imaging unit, the light sources emitting light into a car cabin, each of the light sources being included in a module, the imaging unit capturing an image of at least a part of a region to which the light is applied to acquire imaging information,
wherein
the control step,
when a temperature of the module exceeds a first threshold, controls operation of at least one of the plurality of light sources and the imaging unit to restrict a function of the module.

20. An in-cabin monitoring device comprising:
a module including
a plurality of light sources and an imaging unit, the light sources emitting light into a car cabin, the imaging unit capturing an image of at least a part of a region to which the light is applied to acquire imaging information;
a temperature detection unit configured to detect a temperature of the module; and
a control unit configured to control operation of at least one of the plurality of light sources or the imaging unit, wherein
the control unit,
when the temperature of the module exceeds a first threshold, controls operation of at least one of the plurality of light sources or the imaging unit to restrict a function of the module.
